(19) United States
(12) Patent Application Publication
(10) Pub. No.: US 2005/0039177 A1
(43) Pub. Date: Feb. 17, 2005

(54) Method and apparatus for programme generation and presentation

(75) Inventor: Trevor John Burke, Wirral (GB)

Correspondence Address: FOLEY & LARDNER, 2029 CENTURY PARK EAST, SUITE 3500, LOS ANGELES, CA, 90067, US

(73) Assignee: Trevor Burke Technology Limited

(21) Appl. No.: 10/884,425

(22) Filed: Jun. 30, 2004

Related U.S. Application Data
(63) Continuation-in-part of application No. PCT/GB04/01699, filed on Apr. 17, 2004.
Application No. PCT/GB04/01699 is a continuation-in-part of application No. 10/435,178, filed on May 9, 2003.
Application No. 10/435,178 is a continuation-in-part of application No. 10/402,097, filed on Mar. 28, 2003, now abandoned.
Application No. 10/402,097 is a continuation-in-part of application No. 09/462,550, filed on Mar. 14, 2000.
(60) Provisional application No. 60/575,112, filed on May 27, 2004.

(30) Foreign Application Priority Data
Jul. 12, 1997 (GB) 9714624.5
Oct. 31, 2002 (GB) 0225339.1
May 22, 2004 (GB) GB0411493.0

(51) Int. Cl. G06F 9/44

(52) U.S. Cl. 717/165

(57) ABSTRACT

A method of presenting at least one programme element to a user. The method comprises receiving user specification of at least one classification code representing programme element content of interest, and receiving from a transmitter plurality of programme elements, each programme element having a respective classification code. Received classification codes are screened to identify programme elements associated with the specified at least one classification code, and identified programme elements are stored together with their respective classification codes. User selection of at least one classification code is received, and at least one programme element associated with the user selected at each one classification code is presented to the user.

### CROSS REFERENCE TO RELATED APPLICATIONS

This application is a continuation in part of PCT/GB2004/001699 filed on 17 Apr. 2004 designating, inter alia, the United States, the contents of which are herein incorporated by reference. PCT/GB2004/001699 is, in respect of the United states, a continuation-in-part of U.S. patent application Ser. No. 10/435,178 filed 9^{th} May 2003, the contents of which are herein incorporated by reference. U.S. Ser. No. 10/435,178 is itself a continuation-in-part of U.S. Ser. No. 10/402,097 filed on 28^{th} Mar. 2003, the contents of which are herein incorporated by reference. U.S. Ser. No. 10/435,178 is also a continuation-in-part of U.S. Ser. No. 09/462,550 which is based upon PCT/GB98/01817 filed on 10^{th} Jul. 1998. Each of these applications is herein incorporated by reference. U.S. Ser. No. 10/435,178 claims priority from GB 9714624.5 filed on 12^{th} Jul. 1997 and GB 0225339.1 filed on 31^{st} October 2002. Each of these applications is also incorporated herein by reference.

### FIELD OF INVENTION

The present invention relates to a method and apparatus for programme generation and presentation.

### BACKGROUND

Before the advent of recording equipment and in particular video recorders, programmes were produced and distributed via the atmosphere or cable and simply reproduced by a recipient's receiver. There was no possibility whatsoever for a recipient to control the received programme over and above turning the receiver on or off.

Video recorders made it possible for a recorded programme to be viewed selectively in that a recording tape could be advanced to a part of the programme of interest which could then be viewed, it not being necessary to view every element of the programme recorded on the tape. Video disc players were then introduced in which individual programme elements were separately indexed such that each programme element could be rapidly accessed as compared with a video tape storage system. There was no fundamental difference however between tape and disc systems in terms of the degree to which a user could interact with the recorded programme in that the user had to know where on the recording medium programme elements of interest were located and thus required knowledge of which programme element was recorded where on the recording medium. Programme elements were recorded on the basis that each programme element was allocated to a particular position on the recording medium, access to any one programme element in essence requiring an index in which programme element identity is related to storage medium position.

Interactive video programmes are now available in which programme elements are stored in the memory of a computer and programmes are produced which in part are dependent upon actions taken by an operator of the computer. (The term “memory” is used herein to include solid state, disc, CD and any other form of data storage capable of storing programme elements). For example a computer game may display images to a user which are read out from the computer memory, the user may then take actions appropriate to the displayed image, and depending upon the actions taken by the user the programme content will change. For example the user may “kill” an adversary depicted on the computer monitor's screen, the actions taken by the user to kill the adversary determining the nature of the sequence of images and associated audio output generated by the computer. Thus there is a limited degree of interaction between the user and the programme in that the order of presentation of stored programme elements is dependent upon actions taken by the user, but essentially the user does no more than determine which route is taken through a complex set of alternative routes defined by the computer so as to produce a series of images corresponding to that route. The user has no way of knowing what the next programme element to be displayed will be, unless the user has played the game a sufficient number of times to learn the response of the computer to a particular control input.

Viewers cannot “edit” programmes with current systems. There are often circumstances in which a viewer of a programme knows the kind of elements of a programme which will be of interest and which will not, and yet a viewer cannot make selections of programme elements of interest even from a recorded programme without a detailed index that describes the nature of each programme element which is recorded at a particular position in a recording medium.

There are circumstances in which it would be highly desirable for a user to be able to edit programme content. In many circumstances, particularly in the case of broadcast sports programmes, potential viewers of those programmes are really interested in only relatively small sections of a broadcast sporting event. For example, with live broadcasts, sections of high interest value, for example the scoring of a goal, are often repeated at the expense of not broadcasting passages of play which are relatively uninteresting, for example the period leading up to the game being re-started after the scoring of a goal. The perceived value of a broadcast programme is considerably enhanced by such “action replays” but it is frustrating for a viewer not to be able to decide which sections of a game to replay and to be forced simply to accept what is broadcast by the programme producer.

The traditional approach to enable a user to access programmes of interest has been the publication of schedules which are essentially lists of the programmes that are made available over a preset period on preset channels. Initially such schedules were published in for example newspapers and magazines. Many proposals have been made however to broadcast schedule information as well as the programmes described in the schedule. Schedule information can be for example broadcast on dedicated channels or teletext. Essentially these known systems do no more that simulate the traditional printed schedules made available in newspapers. As the number of channels made available has increased, the volume of information contained in the conventional schedules has grown and as a result the schedules have become unwieldy and difficult to use.

European patent specification EP 0705036 (Sony) describes an enhanced broadcast scheduling system in which individual programmes are identified by title, channel and time of broadcast as in conventional “hard copy” schedules and also by further information classifying programmes in terms of programme type or category, for example news, drama, music, the identity of contributing artists and the like. Individual distributed programmes in some cases are sub-classified into programme elements. For example a music programme may be sub-classified into programme elements each of which represents the contribution of a different artist, or each of which represents a contribution of a particular type, for example a particular style of music. There is thus a two-tier hierarchy in the schedule with individual programmes being at an upper level in the hierarchy and elements within a programme being at a lower level in the hierarchy. A user is able to search through a schedule for a particular programme or programme element of interest by selecting categories of interest, the system then locating programmes or programme elements of interest within the schedule. Programmes or programme elements so identified can then be viewed or recorded for later viewing. Recording is on a time basis, although some provision is made for detecting when a programme or programme element identified as being of interest within the schedule has been broadcast at a later time than that predicted by the schedule.

Thus the Sony specification provides what is essentially an on-line schedule with a greater level of detail than in a conventional schedule and with the ability to search through the schedule information for programmes or programme elements considered to be of interest. The user can therefore efficiently identify scheduled programmes or programme elements of interest but the Sony system does not enable a user to manage the receipt, recording and replay of programme material in a way tailored to a particular users requirements. By way of analogy, Sony can be considered as having provided a sophisticated cataloguing system for material edited by suppliers of that material. Sony does not enable management of the supplied material to suit the requirements of particular users.

### SUMMARY OF THE INVENTION

It is an object of the present invention to provide improved methods and apparatus for classifying and presenting video data.

To assist in an understanding of the invention, this document will use the terms “distributed programme”, “assembled programme”, “programme element” and “event” in the sense defined by the following paragraphs.

A “distributed programme” is a video or audio clip which is made available to a user, for example by broadcasting or on a data carrier such as a video tape or DVD and which is described in a schedule (in the case of broadcast material) or on packaging (in the case of a data carrier) to enable a user to access the clip. In the case for example of the scheduling system described in Sony patent specification EP 0705036, a programme element as that term is used in the Sony document would itself be a “distributed programme” in the sense of the term as it is used in this document as each such “programme element” as the term is used in the Sony document is separately identified in the schedule which is distributed to users.

An “assembled programme” is a set of video or audio clips that is assembled from distributed programme material, the assembled clips being presented to a user. Thus an assembled programme is the final output of an editing process which selectively combines a set of clips in accordance with the wishes of the user controlling the editing process. The assembled programme could be assembled from pre-recorded clips or made up from both locally stored clips and “live” broadcast clips which are not locally stored.

A “programme element” as that term is used in this document is a video or audio clip which forms all or part of a distributed programme and which can form part of a set of clips assembled to form an “assembled programme”. A programme element can be classified on the basis of any criteria of interest to the user, such as type (for example sport, highlights from a particular sporting contest, drama, or a particular type of scene in a drama) or value (for example a level of excitement in a sporting contest or a level of violence in a drama). One programme element can be part of a higher level programme element and may itself be made up of a series of lower level programme elements. Each programme element may itself be made up from for example a series of data packets which are broadcast and assembled in accordance with conventional transmission protocols.

An “event” is anything which can be represented by a single video or audio clip in the form of a “programme element”. An event can be part of a higher level event and may itself be made up from a series of lower level events. For example, a tennis match could be an event at one level, with individual games in that match being events at a lower level, and actions contributing to individual games being events at a still lower level. Thus each video or audio clip which represents an event is a “programme element”.

According to the present invention, there is provided, a method and apparatus for presenting at least one programme element to a user. The method comprises receiving user specification of at least one classification code representing programme element content of interest, receiving from a transmitter a plurality of programme elements, each programme element having a respective classification code, screening received classification codes to identify programme elements associated with the specified at least one classification code, and storing identified programme elements together with their respective classification codes. User selection of at least one classification code is received, and at least one stored programme element associated with the user selected at least one classification code is presented.

Thus, the present invention provides a method in which a user may establish a profile specifying at least one classification code representing programme element content of interest, and this profile may then be used to ensure that programme elements having classification codes which are specified within that profile are stored. Having stored a plurality of programme elements in this way, a user may input a particular classification code or codes to cause display of programme elements associated with that code or those codes. The invention therefore provides a convenient way of ensuring that all programme elements of interest to a user are stored and also provides an effective mechanism for retrieving particular ones of those stored programme elements in dependence upon their particular classification code.

The classification code used to classify a particular programme element may represent a particular event to which the element relates, and in such embodiments of the invention the user profile may include classification codes associated with the particular type of programme element. For example, all programme elements relating to sport may be so classified and a user profile may specify that all sports programme elements are to be stored.

Alternatively or additionally, each programme element may be classified by reference to a subjective assessment of the value of the element. This subjective assessment is preferably measured on a scale extending between a low value and a high value, and in such embodiments of the invention a user may specify that only programme elements classified as having a value above a predetermined threshold value are stored.

User preferences encapsulated within a user profile may be applied at a user's home receiver, or alternatively transmitted to a remote transmitter for application prior to transmission of the programme elements.

Having generated a set of stored programme elements, a contiguous programme comprising the plurality of programme elements may be created for display to the user.

In some embodiments of the present invention, each received programme element is stored in a buffer, and identified programme elements are transferred from the buffer to a storage device. Thus, in embodiments of the invention in which classification data is transmitted later than video data representing a particular programme element (described in further detail below) a user's profile may still be used to ensure that all programme elements of interest are stored for future viewing.

A user profile may specify a plurality of classification codes in an order of preference by specifying a priority for each of the plurality of classification codes. Using this mechanism, a method is provided in which more preferred programme content is stored in preference to less preferred programme content. For example, in some embodiments of the present invention, if a particular programme element is being stored, and only one programme element may be stored at any one time, a further received programme element is stored instead of that currently being stored if but only if the further received programme element is specified as having a high priority. Similarly, a further programme element may be stored in preference to a programme element currently being stored if but only if an associated subjective value of the further programme element is higher than that of the programme element currently being stored.

The present invention also provides a method and apparatus for presenting a programme to a user. The method comprises receiving user specification of at least one classification code representing programme element content of interest, presenting first programme data to a user, receiving second programme data comprising a plurality of second programme elements, each second programme element having an associated classification code, screening received classification codes to identify second programme elements associated with the specified at least one classification code, and alerting the user to receipt of the or each identified second programme element.

Thus, the invention is advantageous given that it allows a user to watch the first programme data but to receive an alert if a programme element having a classification code matching a classification code specified in the user's profile is received. Thus a user can use, for example, a programme guide to select a particular programme to be viewed at a particular time in the knowledge that if another programme contains programme elements of interest, he or she will be alerted to such programme elements.

Alerting the user to receipt of the or each identified second programme element may comprise displaying the programme element or alternatively may comprise displaying a message indicating receipt of the programme element. In response to receipt of the message a user can select either to view the identified programme element, to store the identified programme element or to take no action. Programme elements may be classified using classification codes of the type described above, and a user may allocate priorities to particular classification codes in the manner described above.

According to a further aspect of the present invention, there is provided a method for alerting a user to receipt of programme element content of interest. The method comprises receiving user specification of at least one classification code representing programme element content of interest. Programme data comprising a plurality of programme elements is received, and each programme element has an associated classification code. Received classification codes are screened to identify programme elements associated with the specified at least one classification code, and the user is alerted to receipt of the or each identified programme element.

This aspect of the present invention allows a user to be alerted to receipt of programme element content of interest even where no other programme is being displayed. For example, the method may comprise initialising a user's display device from a stand by mode. The alert may additionally or alternatively comprise producing an audio signal, and/or displaying an identified programme element.

A further aspect of the present invention provides a method of presenting emergency information to a user. The method comprises receiving a plurality of programme elements, each programme element being received together with an associated classification code. Screening each receiving classification code to determine whether the associated programme element represents emergency information, if the associated programme element represents emergency information, presenting the programme element to the user.

Thus, the present invention provides a convenient mechanism for ensuring reliable and rapid dissemination of emergency information to users. In such circumstances each user's home receiver may be initialised from a stand-by mode and an audio signal may be generated to draw the user's attention to their display device. This aspect of the present invention has particular applicability in informing user's of events such as natural disasters and terrorist attacks.

### BRIEF DESCRIPTION OF DRAWINGS

Embodiments of the present invention, will now be described, by way of example, with reference to the accompanying drawings, in which:

FIG. 1 is a schematic representation of the overall structure of a first system in accordance with the present invention;

FIG. 2 is a schematic representation of equipment provided at each receiver of the system of FIG. 1;

FIGS. 3 and 4 schematically represent the generation of programme elements and associated classification codes and the storage of received programme elements and associated codes at a receiver;

FIG. 5 is a schematic representation of the addition of classification codes to television signals produced at a programme source;

FIG. 6 is a schematic representation of the storage and use of programme elements and associated classification codes at a receiver;

FIG. 7 is a view of a display screen showing FIG. 6 to a larger scale;

FIG. 8 is a schematic representation of symbols displayed on the screen of FIG. 7 to represent the progress of a sporting event;

FIG. 9 is a schematic representation of a display screen in a form suitable for the generation of an assembled programme including simultaneously reproduced programme elements;

FIG. 10 is a schematic illustration of a top-level view of a second system in accordance with the present invention;

FIG. 11 is a tree diagram showing an upper part of a hierarchy which is used to classify broadcast television in the system of FIG. 10;

FIGS. 12A and 12B are tree diagrams showing part of the hierarchy of FIG. 11 in further detail;

FIG. 13A is a screenshot of a graphical user interface (GUI) provided in the classifier illustrated in FIG. 10, and FIG. 13B is an illustration of a file selector dialog used in the GUI of FIG. 13A;

FIGS. 14A to 14F are screen shots of the interface of FIG. 13 as a classification sequence is carried out;

FIG. 15 is a tree diagram showing the hierarchical relationships between Java classes which are instantiated by the classifier illustrated in FIGS. 14A to 14F;

FIGS. 16A to 16F show schematic representations of objects created and updated by the classifier during the classification sequence shown in FIGS. 14A to 14F;

FIGS. 17A to 17F show schematic representations of data packets transmitted from a broadcaster to a receiver to represent the classification sequence shown in FIGS. 14A to 14F;

FIG. 18 shows the temporal relationship between events represented in FIG. 14F;

FIG. 18a is a schematic illustration of event processing in a home receiver;

FIG. 19 is a schematic illustration of events contained within a scheduled distributed programme relating to news;

FIG. 20 is a tree diagram showing the hierarchical relationships between the events shown in FIG. 19;

FIG. 21 is a tree diagram showing an event hierarchy suitable for use in classifying a soccer match;

FIG. 22 shows the interface of FIG. 14F further displaying a dialog which may be used to specify, inspect and change programme element properties;

FIG. 23 is a schematic illustration of the architecture of the system of FIG. 10;

FIG. 24 is a schematic illustration of a broadcast server used to transmit data to home receivers in the system of FIG. 10;

FIG. 25 is an illustration of a GUI for a profile specification application used in the system of FIG. 10;

FIGS. 26 is an illustration of a GUI used in the system of FIG. 10, which allows a user to select material to be viewed in terms of recorded scheduled distributed programmes;

FIGS. 27 is an illustration of a GUI used in the system of FIG. 10 which allows a user to select material to be viewed in terms of recorded events;

FIG. 28 is an illustration of a GUI used in the system of FIG. 10 for a player application used in the present invention;

FIG. 29 is an illustration of a series of icons which may appear in an area of the GUI of FIG. 28;

FIGS. 30A to 30D illustrate a dynamic palette for use in the system of FIG. 10;

FIG. 31 is a schematic illustration of a top level view of a third system in accordance with the present invention;

FIG. 32 is a schematic illustration of combination of video data and event data at a user terminal in a system in accordance with the present invention of the type illustrated in FIG. 31;

FIGS. 33 to 35 are schematic illustrations of embodiments of the present invention in which a plurality of sets of classification data are applied to video data;

FIG. 36 is an illustration of a graphical user interface which can be used in some embodiments of the present invention;

FIG. 37 is a flow chart of embodiments of the present invention using the graphical user interface of FIG. 36;

FIG. 38 is a flow chart illustrating how programme element classification codes can be used to trigger presentation of message programme elements;

FIG. 39 is a schematic illustration of a message programme element used in the method of FIG. 38;

FIG. 40 is an illustration of a control function programme element, as presented to a user in some embodiments of the present invention;

FIG. 41 is a schematic illustration of the control function programme element of FIG. 40;

FIG. 42 is a flow chart illustrating how the control function programme element of FIGS. 40 and 41 can be used to control access to a programme element;

FIG. 43 is a schematic illustration of a GUI for configuring the use of a control function programme element;

FIG. 44 is a tree diagram of classes shown in the GUI of FIG. 43;

FIG. 45 is a flow chart showing how a control function programme element can be used to affect generation of an assembled programme; and

FIG. 46 is a schematic illustration of an alternative control function programme element to that illustrated in FIG. 41, being suitable for use in the process of FIG. 45.

### DESCRIPTION OF PREFERRED EMBODIMENTS

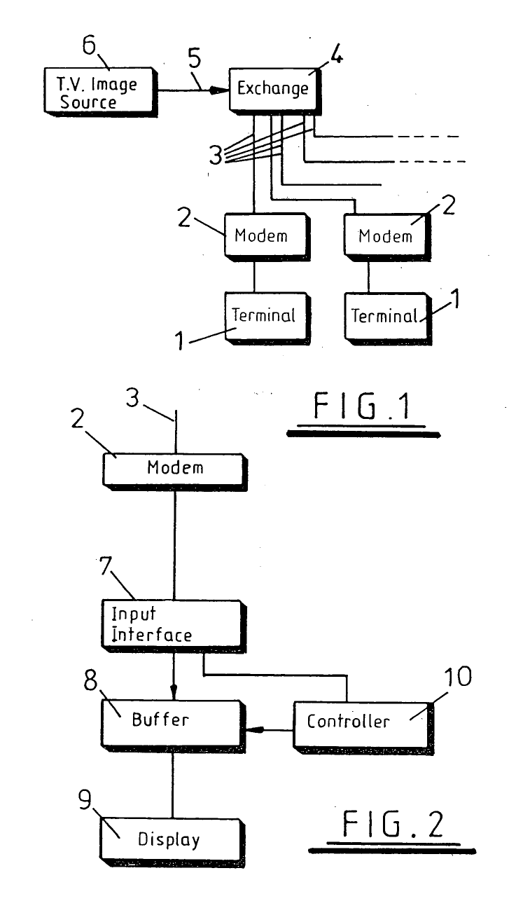

Referring to FIG. 1, terminals 1 which may be conventional PC's (Personal Computers) are connected via conventional modems 2 and telephone lines 3 to a conventional telephone exchange 4. The telephone exchange receives either via existing telephone links or via a direct connection 5 programme element data and programme generation control data from a distributed programme source 6. Conventional data compression techniques may be used such that the transmitted programme element data includes for example only the data necessary to represent the changes between successive frames of a programme element. Each programme element may include a predetermined number of successive frames, although a programme element could be made up of only a single frame. For example, a single frame could be transmitted as part of a data packet including voice data describing that single frame.

Referring to FIG. 2, each terminal comprises an input interface 7, a buffer 8 and a conventional display device 9. Programme elements are stored in the buffer 8 and read out under the control of a controller 10 which receives the programme generation control data via input interface 7 and modem 2 from the telephone line 3.

Each terminal 1 receives a stream of data which is delivered to the input interface 7 from the modem 2, the stream of data incorporating a series of programme elements, from each of which one or a series of video images and associated audio output can be generated, and control signals which are subsequently used to control the display of programme elements stored in the buffer. For example, the buffer may be capable of storing programme elements representing two minutes of a continuous real-time programme. If that data was to be read out to the display at a rate corresponding to the normal frame rate of a conventional television system, all of the image data stored in the buffer would be read out in two minutes. Assuming a data rate on the telephone line 3 which is only one sixth of that required for continuous real-time reproduction, only two minutes in every twelve minutes of a real-time event could be reproduced as data would be read out of the buffer faster than it could be updated in the buffer. In accordance with an aspect of the present invention, programme element data is stored in the buffer for subsequent reproduction in dependence upon control signals from the controller 10, the selection of programme element data to be stored and reproduced being such as to enhance the perceived quality of the programme appearing on the display 9.

For example, if the programme element data received represents a sporting event, image data representing only one sixth of the image data generated at the sporting event would be transmitted to the buffer. The received image data would however be replayed in a manner which effectively conceals the fact that image data representing periods of the sporting event which are of little visual interest has been discarded. Thus for example a ten second sequence leading up to the scoring of a goal would be transmitted once but might be reproduced several times. It will be appreciated that even with conventional real-time live television broadcasts, highlights are often repeated a number of times, thereby discarding some of the images generated at the event. During a relatively dull period of a match, programme element data related to a relatively more interesting part of the event would be transmitted to the terminal. During a relatively dull period of an event, programme element data might not be transmitted to the terminal or, in the absence of any relatively more interesting passages of play, data could be transmitted which represents programme elements which would be allocated a relatively low priority. A subsequently occurring passage of relatively greater interest could be subsequently transmitted and displayed as soon as it is resident in the buffer. Accordingly by allocating different priorities to different sequences of images a controller of the system can control the images displayed to the end user so as to maximise the perceived value of the programme that the images constitute.

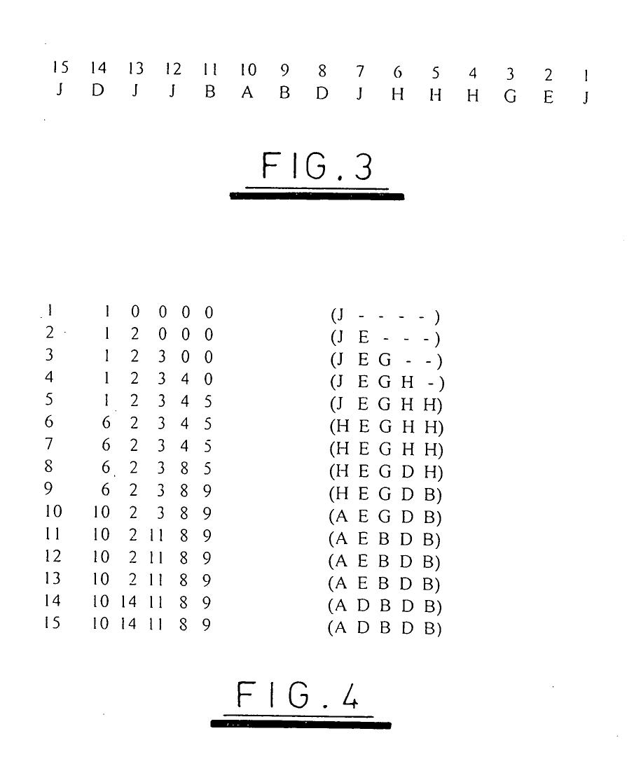

FIGS. 3 and 4 seek to illustrate one possible embodiment of the invention as described with reference to FIGS. 1 and 2. FIG. 3 represents fifteen successive events each of which is represented by a programme element identified by numbers 1 to 15. The system operator allocates “value” to each of the programme elements in the form of a priority code, those codes being represented by letters A to J, with the letters being allocated in order such that the programme elements of maximum interest are allocated to a class identified by letter A and programme elements of minimum interest are allocated to a class identified by letter J. For the purposes of this example, it will be assumed that each programme element lasts exactly one minute but requires two minutes to be transmitted to the terminal. The terminal buffer is capable of storing five one minute programme elements at a time. FIG. 4 illustrates which programme elements are stored at the terminal during each of the fifteen periods represented by the programme elements illustrated in FIG. 3. The left hand column in FIG. 4 represents the number of each of the fifteen programme elements, the second to sixth columns in FIG. 4 represent the contents of five memory locations in the terminal, showing which programme element is stored at the end of each period, and the letters in the seventh to eleventh columns represent the value allocated to the stored programme elements.

It will be seen that in the first period programme element 1 is generated, transmitted to the terminal and stored. Likewise in the second, third, fourth and fifth periods, the second to fifth programme elements are generated, transmitted and stored. At this time in the process ten minutes will have elapsed. During that ten minutes period the user will have been presented with a series of images made up from the information as stored. For example during the fifth period, programme elements 1 and 2 may be presented sequentially during the time that the fifth element is being delivered. The sixth programme element has a higher priority than the first programme element and therefore it is transmitted and stored in the first memory location. The seventh element has a lower priority than any of the stored programme elements and therefore is not transmitted. The eighth element has a higher priority than the oldest of the H value programme element (programme element 4) and therefore is transmitted and replaces that element in the store. The ninth element then replaces the fifth programme element, the tenth element replaces the sixth element, the eleventh element replaces the third element, the twelfth element is not transmitted as it has a lower value than any of the stored values, the thirteenth element is not transmitted as it has a lower value than any of the stored values, the fourteenth element is transmitted as it has a higher value than programme element 2, but the fifteenth element is not transmitted as it has a lower value than any of the stored values.

Clearly if the simple routine according to FIG. 4 was followed without fail, in the end all of the memory locations would be filled with high value programme elements which might, depending on the application, become “stale”, in which case one could have a routine for example to reduce the priority of stored programme elements over time so that the stored programme elements are “refreshed”. For example the priority level of any stored programme element could be reduced by one step every two cycles of the routine.

FIGS. 3 and 4 explain how programme elements are delivered to a terminal but do not explain the manner in which those programme elements are used to generate an assembled programme. Many alternative control schemes could be envisaged. For example, the terminal could automatically generate an assembled programme from the stored elements, cycling through the stored elements in a predetermined manner. For example all A priority programme elements could be repeated say three times, all B priority programme elements could be repeated once, and so on. Programme elements could be of varied duration so as to enable the allocated priorities to represent programme elements which begin and end with natural break intervals, for example to coincide with interruptions in play. As an alternative to automatic programme generation control however, it would be possible for the user of the terminal to have total control of the images presented, for example by presenting the user with an image representing the priority value allocated to the locally stored programme elements for direct selection of programme elements of interest by the terminal user.

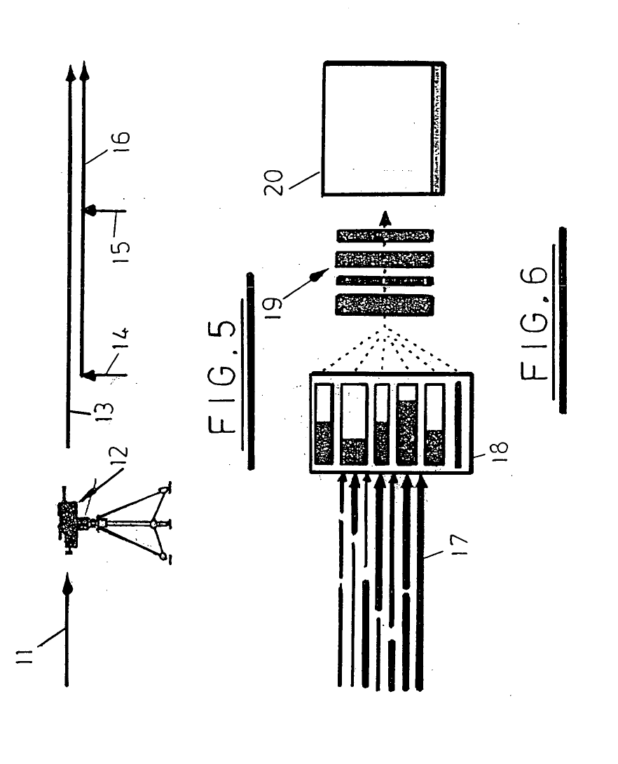

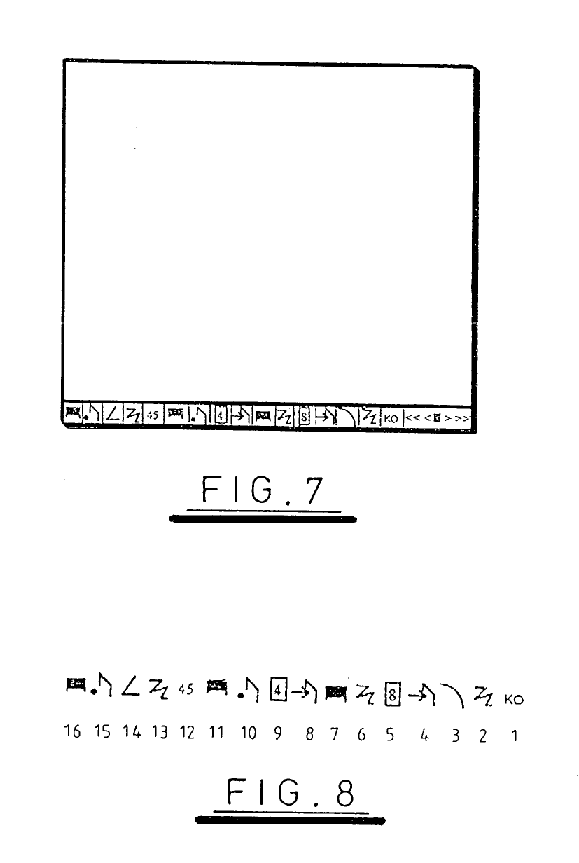

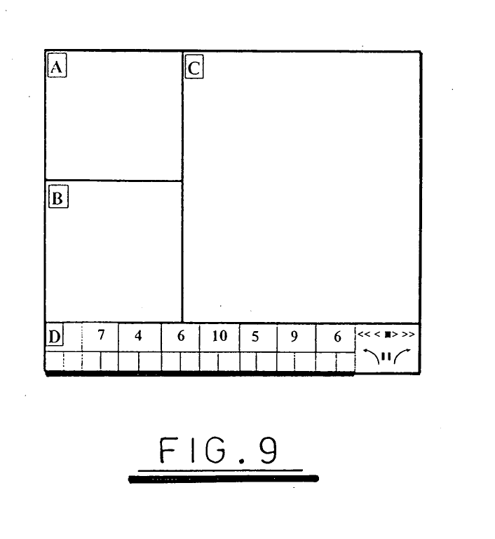

FIG. 5 is a graphical representation of a process which can be used to generate a data stream the content of which enables the user of a terminal receiving that data stream to “edit” a set of received programme elements to produce a programme uniquely adapted to the user's wishes. FIG. 6 represents the handling of the data stream at the user terminal, FIG. 7 the appearance of a screen represented to a smaller scale in FIG. 6, and FIG. 9 a series of symbols or ‘icons’ displayed on the screen of FIG. 7 with a series of sequence numbers to assist in understanding the description of the significance of those icons set out below.

Referring to FIG. 5, data represented by arrow 11 is captured by a TV camera 12 to produce a stream of digital data represented by arrow 13, that digital data defining the video and audio content of the events taking place in front of the camera 12. As the data is generated, a system operator allocates classification data to the video and audio content of a series of programme elements represented by the data stream 13, the classifications being a subjective indication of the content of the associated programme elements. The value classification data is represented in FIG. 5 by the arrow 14. Further control data may be added as represented by arrow 15 to further classify the subjective value data 14, for example the identity of a team responsible for a particular event. The combined data 14 and 15 is output as represented by arrow 16 in the form of control data.

The two data streams represented by arrows 13 and 16 are delivered to a transmitter, transmitted to a terminal and stored in a terminal buffer as represented in FIG. 6. The combined data stream is represented by lines 17 and the buffer by rectangle 18. In the buffer, each class of data is stored according to its class type in its own area of the buffer, the class type corresponding to the subjective value allocated to the associated programme elements. Data is read out from that buffer as represented by lines 19 in accordance with commands delivered to the buffer 18 by the user on the basis of information displayed on the terminal display screen 20.

Referring to FIG. 7, this is a larger reproduction of the screen 20 of FIG. 6. The blank area which occupies most of FIG. 7 corresponds to an area of the display screen on which programme elements will be displayed, and the symbols appearing at the bottom of the screen correspond to displayed icons which represent the content of a series of programme elements stored in the buffer 18.

Referring to FIG. 8, the icons appearing at the foot of the screen shown in FIG. 7 are reproduced next to numbers 1 to 16. Assuming that programme element data is being delivered at a rate such that a real-time reproduction of a live event can be produced, the display screen will show the live action. Programme elements of particular interest are however stored for later reproduction, each stored programme element being classified and represented by an associated icon. The first icon corresponds to “kick off”, that is the first passage of the game. The second icon indicates a high quality passing sequence, the third a high quality long pass, the fourth a shot on goal, the fifth a yellow card warning to player number 8, the sixth a further high quality passing sequence, the seventh a goal, the eighth a further shot on goal, the ninth a further yellow card warning to player number 4, the tenth a penalty, the eleventh another goal, the twelfth half time (45 minutes), the thirteenth another high quality passing sequence, the fourteenth a corner, the fifteenth a penalty, and the sixteenth another goal. Home team icons may be highlighted for example in red and away team icons in black.

The icons appear from the bottom left of the screen and continue moving to the right as the game progresses. This means that the oldest recorded events are on the right. Further programme elements will cause the oldest programme elements to be displaced.

The programme elements represented in FIG. 8 are generated by storing only data representing events which are of interest to the terminal user as defined by a minimum priority set by that user. For example none of the recorded programme elements corresponds to boring periods of play. The user can simply review the icons and switch between different icons using a keyboard or remote control device in a conventional manner, for example by moving a cursor on the simulated control panel at the bottom right hand corner of FIG. 7. It is easy for the user to see in the example represented in FIG. 8 that there were ten highlights exceeding the user's threshold setting before half time. The colour of the icons will indicate which team if any dominated play. It can be seen that there was a good passing movement, a good long forward pass before an identified player received a yellow card. The first half included two goals for teams identified by the colour of the associated icon. The current score can be determined by looking at the colour of the three icons representing the scoring of a goal. The terminal user has the choice of either seeing the whole broadcast programme, seeing all the highlights, or jumping through the sequence of highlights in any desired order.

Thus a terminal user can either watch a distributed programme in a conventional manner, or skip through parts of a distributed programme looking at only those sections of real interest, or periodically review the displayed icons to see if anything of sufficient interest has happened to merit further attention. The user can thus use the system to identify programme elements of interest without it being necessary for the user to do more than glance occasionally at the screen. The user can make a decision to record all or only highlights of a broadcast distributed programme, interact with the programme by actively selecting programme elements to be displayed, or allow the system to make a selection of programme elements to be stored in accordance with a predetermined value selection keyed into the terminal at an earlier time by the user, or allow the generation of a continuous programme by allowing the classification data transmitted with the programme elements to control programme generation in accordance with a default set of value selections determined by the system provider.

The system can be used in circumstances where the data delivery communications channel can carry data at a rate sufficient to accommodate all of the real-time programme transmission, or at a rate higher than a conventional transmission (to allow the generation of for example high definition images), or at a rate lower than a normal transmission (in which case a “full” programme can be achieved by repeating previously stored programme elements as necessary).

In terms of the significance to the user of the capabilities of the system, the terminal gives great flexibility so that the terminal operator can choose to experience a broadcast distributed programme in any of a large number of ways, for example by:
1. Setting a threshold value to select only highlights of a transmission.
2. Setting a threshold value which could be transmitted to the programme source and used at that programme source to select “above threshold” passages of play from for example more than one sporting event.
3. Displaying by means of icons a “storyboard” of a sequence of events to allow rapid access to events of particular significance.
4. Choosing to permanently record any set or subset of highlights.
5. Recalling and replaying any stored item at will substantially instantaneously.
6. Storing programme elements and associated icons for review at the icon level or as a full programme at a later time.
7. Storing automatically only the highlights of an event for later review, thereby reducing storage requirements.
8. Arranging for the system to take out programme elements of a broadcast distributed programme of little interest to the viewer.
9. Watching a distributed programme live and automatically storing highlights for later replay.
10. Using the system to “watch” a distributed programme so as to alert the user when something interesting is happening.

In reduced bandwidth systems in which the available bandwidth does not allow the delivery to the user's terminal of all of the real-time broadcast signal, it is necessary to “expand” the time occupied on the screen by transmitted programme elements so as to “fill in” periods of time during which programme elements are being transmitted. This can be achieved by simply repeating programme elements, assuming that each viewed programme element corresponds to the simple reproduction of a real-time series of events, or by using still images and associated audio signals. There are many occasions, particularly during lapses in action, where a still picture and well recorded sound is better than poor video in terms of enhancing the entertainment value. Such an application of the present invention is described with reference to FIG. 9.

FIG. 9 represents a screen which has been split into four sections A to D. These different sections can be used for any specific purpose, can vary in size, and their usage may be changed according to the dynamics of the broadcast material. For the purposes of illustration section A of FIG. 9 may be used to display a moving video picture, section B diagrams or graphs, and section C a high quality still picture. An associated audio programme is also produced. For example, the system illustrated schematically in FIG. 9 can be used in association with the broadcast of a programme describing a golf tournament. A golfer may be shown standing on the fairway of a particular hole at a famous golf course in section A of the screen. The golfer can be describing the beauty of the course and how he would play that hole. Section C of the screen can be used to present a very high quality image of the golfer's current location. Section B may contain a plan of the hole showing where the golfer's first drive finished, with distance markers, ranges and the like.

The golfer can work to a script which directs the user's attention to selected parts of the screen. For example the golfer may draw the attention of the terminal user to the way the ground falls away to the left, the dangers of over-pitching straight into a bunker guarding the green, and the beauty of the course and various geographical features. All the time that the golfer is delivering this message, there is no motion at all on the screen. If the golfer talks for 20 seconds about the still picture image on the screen, this gives 20 seconds for the next video section to build up in the system buffer. That next video section can then be replayed at a higher speed than that at which it was recorded in the buffer so as to improve the perceived quality.

Further pre-recorded data packets may be used to make up the final programme. For example an illustration of the golfer's technique of relevance to the particular hole may be taken from a library of information held on a CD in the PC CD drive, that information being displayed in section A of the screen whilst a sponsors message appears in place of the course plan in section B.

Section D of the screen shows icons, in the illustrated case numbers, which are either subjective ratings by the programme producer of the significance of associated programme elements, or identify particular events in a manner similar to the football example illustrated in FIGS. 5 to 7a. This makes it possible for the user to jump between sections of the programme, repeating sections of interest at will, thereby once again obtain control over the programme as a whole.

It will be appreciated that programme elements can be reproduced serially, that is a programme could be made up of programme elements presented one at a time with no overlap between successive elements, or in parallel, that is a programme may be made up of programme elements some of which will be presented simultaneously. The simultaneous presentation of programme elements could enhance a user's appreciation in various circumstances. For example, if a programme to be presented to a user is intended to represent the progress of a car race, most of a display screen could be occupied by an image showing the two leading cars in the race, with the remaining area of the screen showing an image representing the approach to the finish line of that race. Such combinations of images can enhance the appreciation of a programme by linking together two events where a first one of the events (the relative position of the two leading cars) and a second event (their approach to the finishing line) is of significance to an overall appreciation of the subject of the programme.

It will also be appreciated that combinations of images can be presented either serially or in parallel so as to enhance the impact of advertisements by linking the presentation of particular advertisements to the occurrence of particular events. For example, programme elements representing the progress of a motor race may be combined with a programme element representing advertising images the presentation of which can be linked to the progress of the race. One possibility would be to put on the screen advertising material relevant to the sponsor of a race car or the supplier of tyres to a race car at the time that race car successfully crosses the finishing line. A sponsor's message could thus be superimposed on or otherwise combined with images of the winning race car and driver.

The embodiments of the invention described above assume that programme element classification is controlled by the source of the programme elements. It is possible however for a user of the system to determine the programme element classifications, either to replace classifications set by the programme element source, or to establish a set of programme elements and associated classifications from an unclassified broadcast programme. For example, a user could receive a broadcast distributed programme representing an event, store the entire broadcast, divide the stored programme into programme elements of interest, and set classifications for each programme element of interest. Thus a user could classify programme elements related to a sporting event on a basis ideally suited to the interests of that user, thereby enabling a subsequent reproduction of the programme elements in a manner controlled by reference to the user's own classification system. A user would not then be forced to rely upon the classification system considered appropriate by the programme element source but could set up classifications matching the particular user's interests however idiosyncratic those interests might be.

Programme element classification can be used in a variety of ways, for example to “time stamp” the beginning of one programme element in an assembled programme made up from a series of sequentially presented programme elements. Thus a user wishing to suspend a programme for a period of time so as to enable for example a telephone call to be answered could in effect apply a “time stamp” classification to the programme element being watched at the time the decision to suspend is made, the applied classification being a flag identifying the point in the assembled programme to which the viewer will wish to return after viewing restarts. The time stamp classification would in effect modify the manner in which stored programme elements are presented by causing the system to bypass all earlier programme elements in the series of programme elements making up the assembled programme to be viewed.

In embodiments of the invention described with reference to FIGS. 3 and 4, programme elements are classified by reference to a “value” assessment of individual elements. In the embodiment of the invention described with reference to FIGS. 7 and 7a, classification is by reference to the nature of the event. It will be appreciated that various graphical representations of the classifications associated with individual programme elements could be presented to users. For example, in a classification system based on programme element “values” on a scale of 1 to 10, the values of a series of programme elements representing successive events in a real-time broadcast programme may be presented in the form of a bar chart, each bar of the chart having a length corresponding to the value in the range 1 to 10 allocated to a respective programme element. Such a presentation of the classifications of individual programme elements would enable a user to rapidly access any series of programme elements which on the basis of the allocated value classifications is likely to be of significant interest.

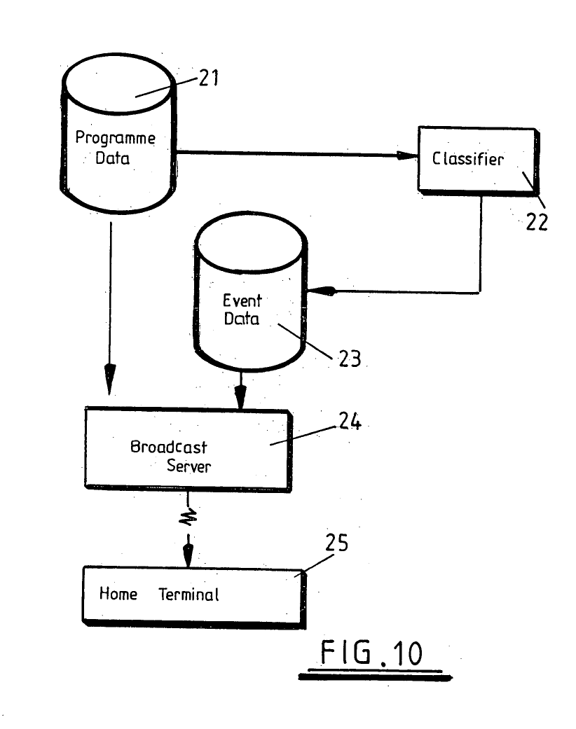

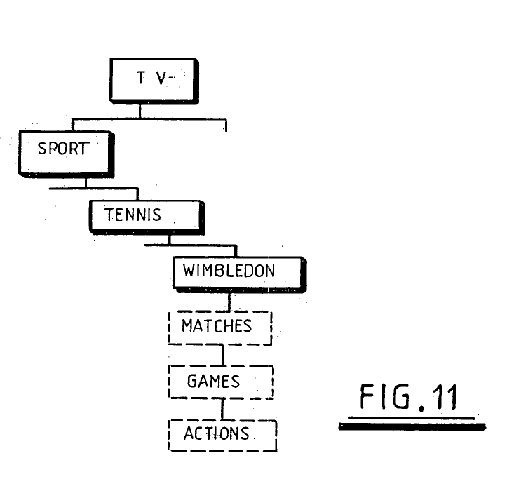

An overview of an embodiment of a system operating in accordance with the present invention will now be described with reference to FIG. 10. Scheduled programme data comprising conventional televisual images and sound making up programmes to be distributed is stored in a scheduled programme data file 21. A distributed programme is input to a classifier 22 which an operator may use to classify the programme into a number of constituent programme elements each representing an event. Classification codes appropriate to the events are written to a data file 23. These classification codes will be referred to below as “event data”. The distributed programme and event data files are then broadcast by a broadcast server 24 to a home terminal 25 which a user may operate to view the classified programme data in the manner described above, and as further described below. In essence, the event data file allows a user greater control over what is viewed, and allows easy direct access to specific parts of the programme data, in particular using icons similar to those illustrated in FIG. 8.

To aid understanding of one embodiment of the present invention, a detailed specific example will now be presented, referring to classification, broadcast, home recording and playback of a distributed programme which represents the Wimbledon Tennis Final. This programme is hereinafter called the Wimbledon programme. In accordance with the present invention, the images and sound making up the Wimbledon programme are transmitted from a broadcaster to a receiver using conventional means which may comprise digital satellite, digital terrestrial, analog terrestrial, cable or other conventional televisual transmission. The Wimbledon programme is considered to be one of a number of events which have hierarchical relationships and which itself comprises a number of events.

Referring to FIG. 11, there is illustrated an upper part of a classification hierarchy suitable for classifying distributed programmes. Each node of the tree structure corresponds to an event or a group of events at a common level in the hierarchy. The root node of the tree is the “TV” event which generically represents all television. The “TV” node has a number of child nodes such as “Sport”, “news” etc, although only the “SPORT” event node is shown in FIG. 11. Similarly, the “SPORT” node has a number of child nodes, although only the “TENNIS” node is illustrated in FIG. 11. The “TENNIS” node in turn has a number of child nodes, which in the current example relate to tennis championships. In this case only the “WIMBLEDON” node is displayed. The “WIMBLEDON” node has a number of child events relating to matches within the Wimbledon championship. These nodes are collectively denoted by a node “MATCHES” which is illustrated with broken lines to show that it does, in fact, comprise a number of different match nodes at the same level in the hierarchy. Similarly, the next level down from “MATCHES” is “GAMES” which again comprises a number of different game events and is illustrated using broken lines. Within a single game, actions taken by the players can be classified as one of a number of different events. These events are collectively denoted by an “ACTIONS” node which is again illustrated using broken lines to indicate that each game comprises a series of actions represented by events at the same level in the hierarchy.

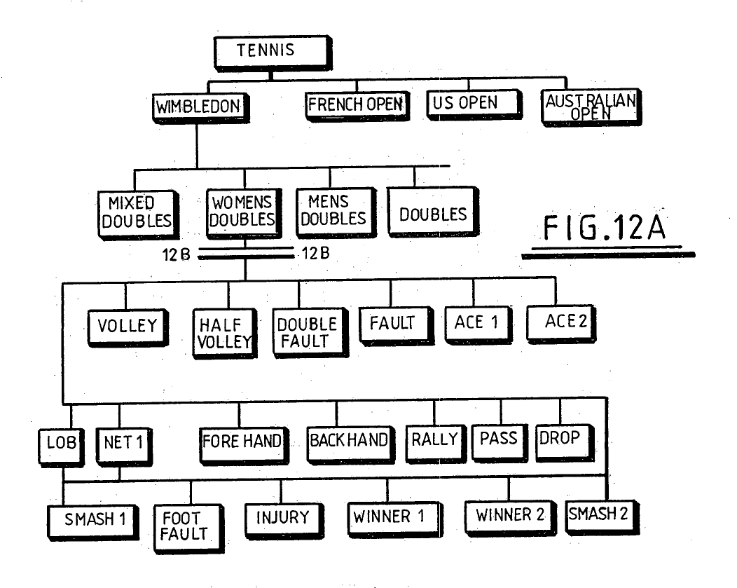

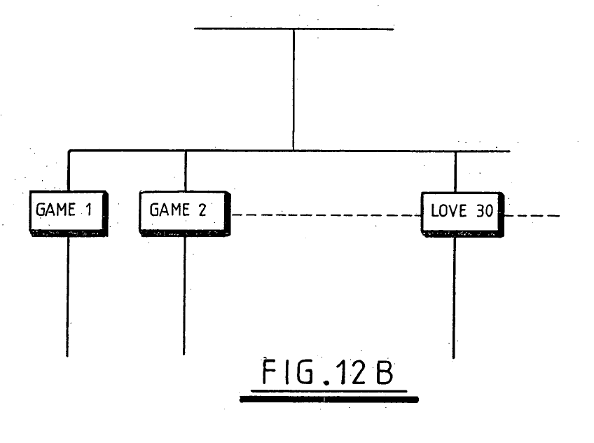

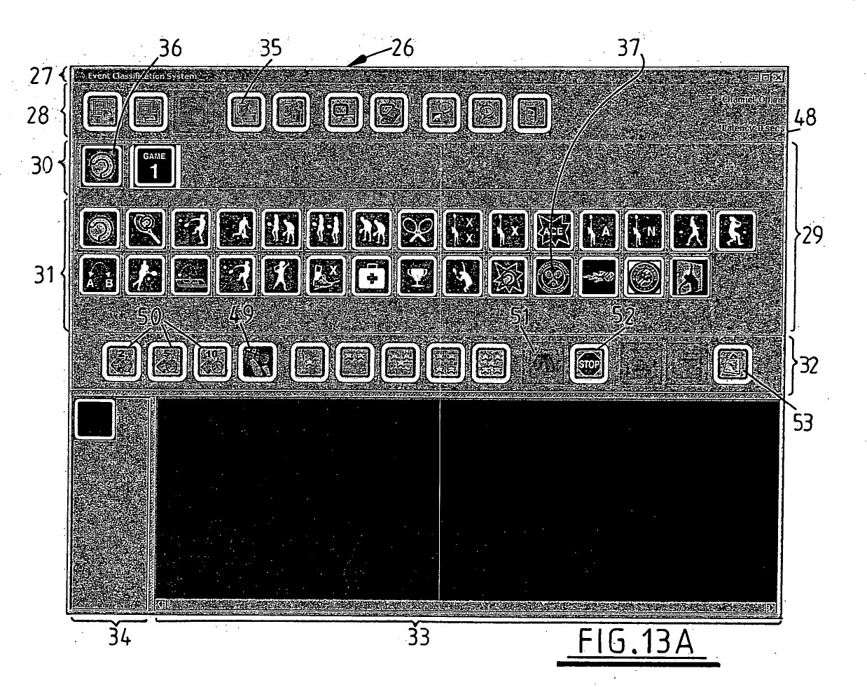

FIGS. 12A and 12B illustrate a hierarchy suitable for classifying the Wimbledon programme. The top level of the hierarchy shown in FIG. 12A is a “TENNIS” node, and corresponds to the “TENNIS” node of FIG. 11. This hierarchy is used by the classifier during a classification sequence. The hierarchy of FIG. 12A is supplemented by that of FIG. 12B, which provides an additional layer of classification at the point 12B-12B of FIG. 12A.

The hierarchy of FIG. 12A has “TENNIS” as its root node. The “TENNIS” node has four children which represent different tennis championships viz “WIMBLEDON”, “FRENCH OPEN”, “US OPEN”, and “AUSTRALIAN OPEN”. The next level of the hierarchy comprises matches which are children of the “WIMBLEDON” node. It will be appreciated that the other championship nodes will have similar children which are omitted from FIG. 12A for reasons of clarity. The match nodes which are children of the “WIMBLEDON” node are “MIXED DOUBLES”, “WOMEN'S DOUBLES”, “MEN'S DOUBLES” and a generic node “DOUBLES”. Each of these nodes in turn has nodes to represent games within a match, and these are illustrated in FIG. 12B. Nodes illustrated in FIG. 12B include “GAME 1” and GAME 2” to represent different games. A “LOVE 30” node is also shown as an example of a node which can be used to indicate a score during a match.

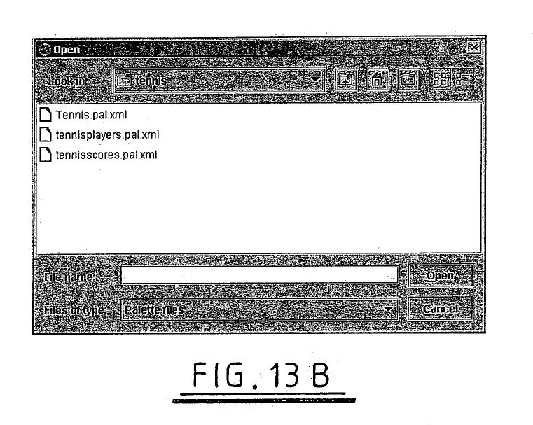

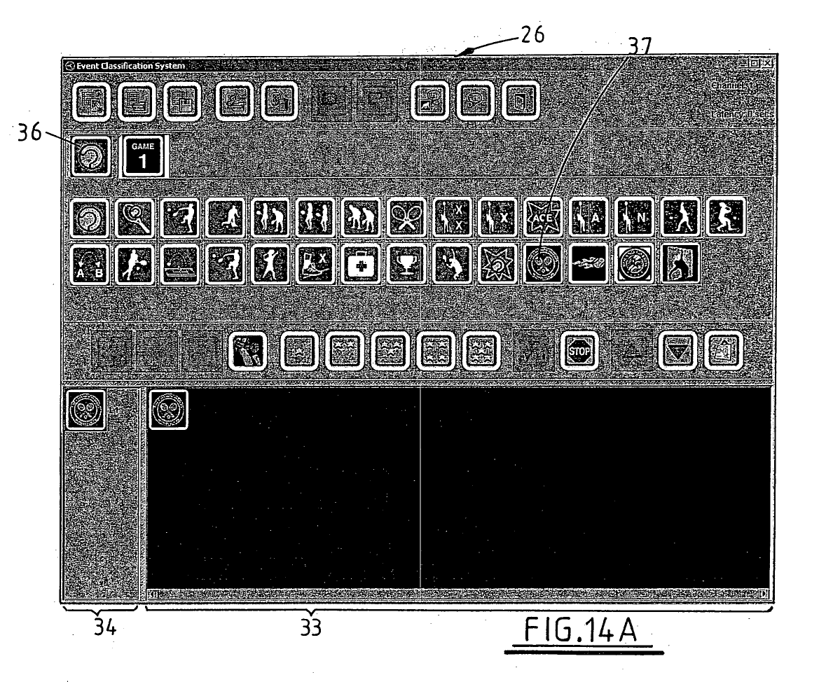

Referring back to FIG. 12A, each of the lower nodes of FIG. 12B has children representing actions within a game exemplified by nineteen leaf nodes shown on the lower three levels of FIG. 12A. The leaf nodes representing actions are distributed over three levels, although they all have the same level within the hierarchal classification system. Each of the nodes of FIGS. 13A and 12B represents an “event”, and thus events may be defined which are themselves made up from a series of lower level events and may form part of a higher level event.

A suitable classifier will now be described. In a preferred embodiment of the present invention the classifier is provided by means of a computer program which executes on a suitable device such as a personal computer to provide a user interface which allows a classification operator to perform classification of scheduled programmes.

The classification operator logs on to the software application which is executed to provide the classifier. This log on process will identify an operator profile for the operator, indicating which programmes may be classified by that operator. This is achieved by using a conventional log-on procedure where an operator inputs a name and associated password. These log-on criteria allow a profile for that operator to be located in a central database. Each profile stores permission information determining programme types which may be classified by that operator. The permissions will allow different operators to be considered as experts in different fields, and to perform classification only in their specialised fields. For example, an operator may be allowed to classify distributed programmes relating to sport, but not scheduled programmes related to science or vice versa. More specifically, an operator may be allowed to classify distributed programmes related to soccer, but not allowed to classify programmes related to tennis. A classification operator can be given permissions such that they can classify more than one type of scheduled programme.

The permissions allocated to a particular operator determine the programmes to which the operator has access, and accordingly the content which the operator is able to classify. When performing classification, the classifier software uses data files hereinafter referred to as palette files which define buttons which the operator may use to generate a classification sequence of events. In order to provide flexibility, a preferred embodiment uses the Extensible Markup Language (XML) to define palette files. A general knowledge of XML commands and concepts is assumed here, but a more detailed description can be found in Petrycki L and Posner J: “XML in a Nutshell”, O'Reilly & Associates Inc, January 2001, the contents of which are herein incorporated by reference.

Appendix 1 of this specification illustrates a suitable format for an XML document type definition (DTD) for a palette file. Referring to the code of appendix 1, the first line of the XML file states that a palette (which is defined by a file in accordance with this DTD) contains one or more panels. Line 2 indicates that each panel includes zero or more buttons.

Lines 3 to 8 of the XML file define the attributes of a panel. Each panel has:

name—a textual description of the palette of buttons. This will appear on the tab if there is no image, or will be used as a tool tip if an image icon is supplied. If no name is supplied, a default value of “unknown” is used.

iconfile—an image file that may be used in place of text. This is an optional attribute.

mnemonic—a hotkey shortcut for this panel. Again, this is an optional attribute.

type—either static or dynamic. Dynamic is the default. The specific example relating to the Wimbledon programme uses a static palette, although operation of a dynamic palette will be described later.

Lines 9 to 13 of the DTD file define a tab element. Tab elements have no children, and a single compulsory attribute url which is used to provide an icon for the tab. The tab feature allows buttons within a panel to display further collections of buttons. Again, the significance of this is discussed later.

Line 14 of the XML file defines the structure of an icon button. Each Button may contain zero or more child buttons, zero or more tabs, and zero or more arbitrary attributes.

Lines 15 to 19 of the XML file indicate that each button has the following attributes:

name—the name of the event, this name will be associated with the event and transmitted to end users. A default value of “unknown event” is used if no name is provided in the XML file.

iconfile—the image associated with this event. This icon should be available to the end user. This is a required attribute.

classname—this is the java class used to maintain information about this event. At least one class for each genre must be defined (e.g. Sport, news etc.). More specific classes should be defined for lower level events. This is an optional attribute. The class hierarchy used to classify events is described later.

category—if the event is not of a special class, then it's hierarchical definition is placed into the category attribute. This is again an optional attribute

mnemonic—this will be used to define a key that will start this event. The character (modified by the system meta key—ALT on Windows) will invoke this event when the panel containing the event button is in focus. This is an optional attribute.

defaultlevel—this is the default hierarchical level associated with the event. For example, the “TV” event would have a level of zero, as the event will only ever appear as a level zero event.

Lines 22 to 24 of the XML DTD define an attribute which can be child of a button as described above. It can be seen from line 24 that the attribute element contains a single XML attribute which is an attribute name.

Appendix 2 lists an XML file in accordance with the DTD of Appendix 1, which defines a palette of buttons suitable for classifying the Wimbledon programme of the present example. The buttons defined in the XML file are those shown in the hierarchy of FIG. 12B. Further details of these buttons will be described later. Referring to FIG. 13A, there is illustrated a user interface provided by the classification software to allow classification of the Wimbledon programme. The classification software shown is programmed using the Java programming language, and the graphical user interface is provided using components of the Swing toolkit.

A main classification window 26 comprises a conventional title bar 27 which contains an indication of the window's purpose. The main window 26 further comprises an area 28 defining a row of buttons which can be used to read and write data from files and perform other housekeeping functions, and a palette panel 29 containing an upper area 30 displaying two buttons, selection of one of which results in the display of an associated set of buttons in an area 31. The buttons in area 31 allow classification of a distributed programme. Each button in area 30 provides a different set of buttons in area 31, thereby allowing different programmes or different events within a particular programme to be classified in an appropriate manner. The main window 26 further comprises an area 32 containing a number of buttons providing control functions, an area 33, referred to as a history panel, to show a currently operative classification (this area is empty in FIG. 13 because no classification has taken place), and a hierarchical parent panel 34, the function of which is described further below.

An operator logs on to the classification software as described above. The operator can then use any one of the standard buttons in area 28 to initiate the classification process. The buttons in area 28 are always displayed regardless of the operator profile. At this initial stage, areas 30 and 31 are blank. If a button 35 is selected one or more palette files may be opened. The files which can be opened in this way are determined by the operator's profile. Selection of the button 35 causes a conventional file selector dialog as shown in FIG. 13B to be displayed, allowing the operator to select a file to be opened from a list set out in the dialog. Files opened in this way are parsed using a parser which checks the file for conformity with both the XML DTD of Appendix 1 and the standard XML definition. It should be noted that parsing XML files can be a costly operation in terms of time, however this overhead is considered acceptable here because files are parsed only at the beginning of a classification process. Each file opened using the button 35 causes a button to be added to the area 30, each button so added corresponding to a tab related to a number of buttons which are displayed in the area 31.

When the operator has opened all files which are considered relevant for classification of the programme or programmes to be classified, classification can begin. It can be seen in the example of FIG. 13A that two palette files suitable for the classification of tennis have been loaded. The button 36 (which is denoted by a tennis ball icon) is associated with the set of buttons shown in area 31. These buttons are appropriate to classify the Wimbledon programme of the present example. The purpose of the further button (labelled Game 1) in area 30 is described below.

Classification of the Wimbledon programme in real time during broadcast of the programme is now described. The operator logs on and opens the relevant palettes as described above. A display screen of the classifier then resembles the view of FIG. 13A. Prior to broadcast of the Wimbledon programme, and prior to classification beginning, the operator may transmit a packet of data to home viewers indicating that the Wimbledon programme is about to begin. This is known as a Programme Event Notification Packet. The significance of this packet will be described later.

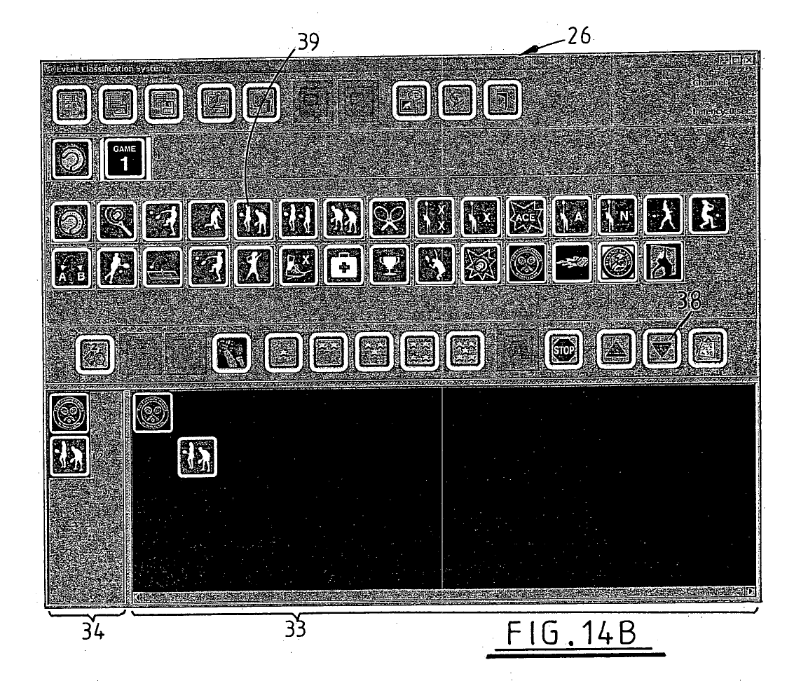

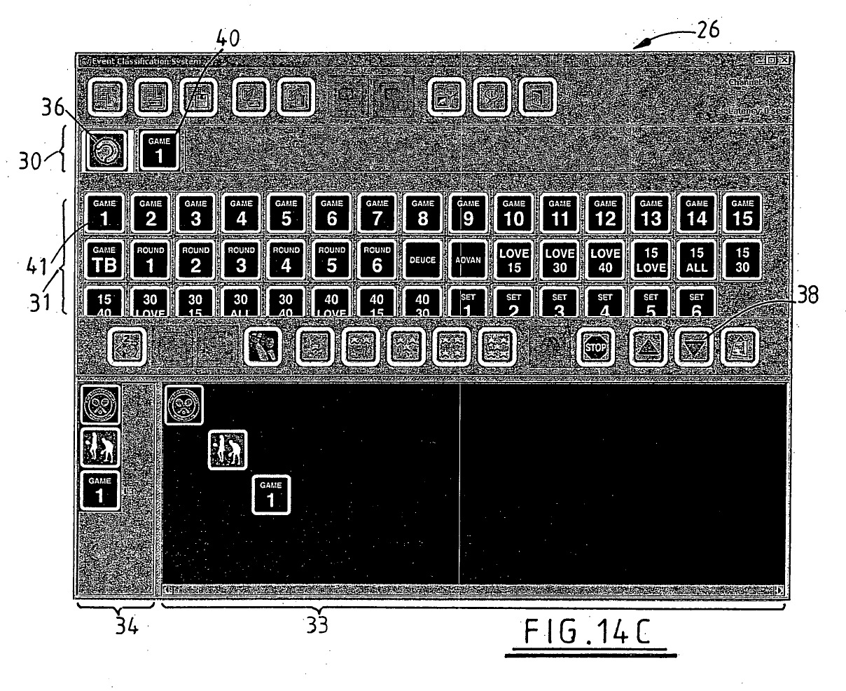

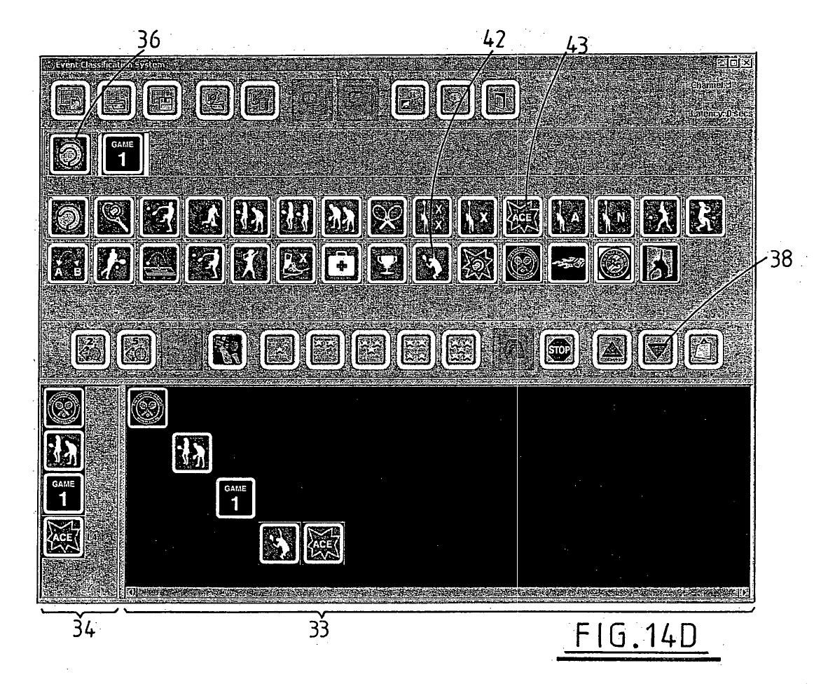

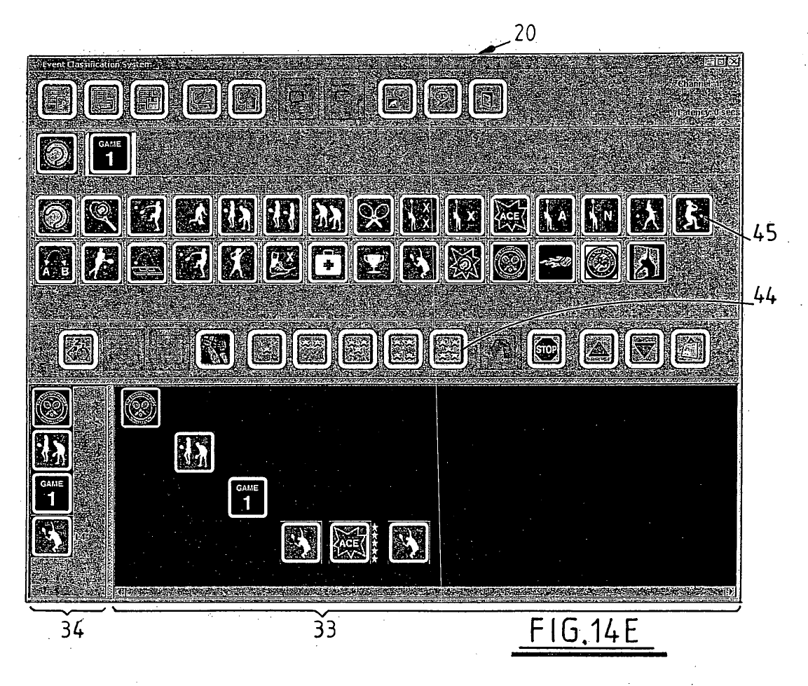

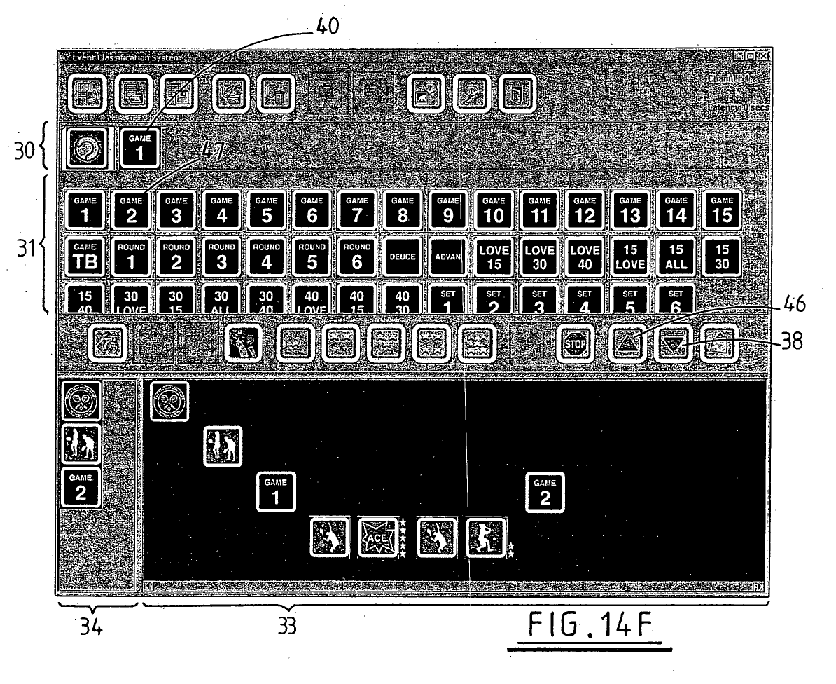

The classification operator will be aware that a tennis match at Wimbledon is to be classified and will accordingly select a button 37 from the palette panel when the scheduled programme begins. This button 37 corresponds to an event which represents a distributed programme as broadcast, and such an event is hereinafter referred to as a programme event. It will be appreciated that a number of Wimbledon programme events each of which is classified as a hierarchical event may be broadcast over the two week period of the Wimbledon Championships. Selection of the button 37 will result in a copy of the button's icon being copied to the history panel 33. A representation will also be copied to the parent panel 34, the function of which will be described later. FIG. 14A shows the window 26 after the selection of the Wimbledon event.

Selection of the button 37 representing a Wimbledon programme event results in the creation of a representation of the event within the classifier software. The representation of events is object-orientated and uses the Java programming language. Standard features of the Java programming language are assumed here. More detailed information can be found in one of the large number of widely available Java textbooks such as “Java in a Nutshell” published by O'Reilley and Associates Inc. The description of the creation of Java objects corresponding to events is discussed later, after a consideration of the selection and display of events in the interface provided to the user.

Referring to FIG. 14B, the classification operator subsequently selects a button 38 to indicate that an event is to be added which is at a lower hierarchical level. This button selection is recorded by the classifier and the current classification level is recorded as level 2, as opposed to the previous top level (level 1). The classification operator then adds an event at this lower level by pressing a button 39 which represents a Mixed Doubles match. The icon of button 39 is added to the history panel 33 of FIG. 14B. It can also be seen that the parent panel 34 includes a copy of each of the icons shown in the history panel 33. The parent panel 34 is configured to show the currently active event at each hierarchical level, as will be shown further below.

Having created the mixed doubles event, the classification operator again selects the button 38 to move to a still lower level of the hierarchy (level 3). The next event to be classified is the first game within the mixed doubles match. A suitable button 40 is provided on area 30 (FIG. 14C). Selection of button 40 displays the set of buttons shown in FIG. 14C in area 31. The operator then selects a “Game 1” button 41 to perform the classification. This button selection again results in the icon of button 41 appearing in the areas 33 and 34.

The next classification relates to events occurring within the first game. The classification operator again uses the button 38 to move down in the hierarchy. The operator selects the button 36 so as to display in area 31 buttons which are appropriate for classification of actions within a game. This is shown in FIG. 14D. A button 42 to create a “Serve” event is selected resulting in the icon of button 42 being placed in the history panel 33. Immediately thereafter an “Ace” event occurs and is classified by the classification operator selecting a suitable button 43 which results in the “Ace” icon of button 43 being placed in the history panel 33. This is shown in FIG. 14D. The parent panel is updated for each event, such that after the “Ace” event, the parent panel comprises the top level “Wimbledon” event followed by the second level “Mixed Doubles” event, followed by the third level “Game Event” and the fourth level “Ace” event. As the parent panel shows currently open events, the “Serve” event represented in the history panel 33 is not shown in the parent panel 34. The “Serve” event ended upon creation of the “Ace event” because the two events are both at the fourth level of the event hierarchy, and no hierarchical level can have more than one event open at any given time.

At this stage in the classification process, the classification operator decides that the previously classified “Ace” event which is currently active is of great entertainment value. For this reason the operator presses a five star button 44 (FIG. 14E) which results in five stars being placed alongside the “Ace” icon in the history panel 33. This action updates the rating variable of the “Ace” event. The next event is a further serve which is again created using the button 42, and this results in a further “Serve” icon being placed in the history panel 33. The parent panel is also updated to show that the currently active event at level 4 is the latest serve event.

In FIG. 14F, it can be seen that following the latest “Serve” event, a return event occurs which is denoted by selecting button 45 (FIG. 14E). The associated icon is added to the parent panel 33. This event is subsequently rated as a two-star return denoted by two stars to the right hand side of the icon. Following the return event, “Game 1” finishes (it will be appreciated that in a real tennis game further actions may occur within a single game). The operator at this point presses a button 46 to move to a higher hierarchical level and then selects a button 47 from the buttons in area 31 associated with the button 40 in area 30 to indicate the start of the second game. Selection of the “Game 2” button 47 will result in the return event and the “Game 1” event being considered finished at the same time. This is because the “Game 2” event closes the “Game 1” event at the same hierarchical level and also closes any of its children, of which the “Return” event is one. The “Game 2” event is denoted in the history panel 33 by the icon of button 47. The parent panel 34 is also updated to show that the Game 2 event is currently open at level 3 of the hierarchy, while no event is open at level 4.

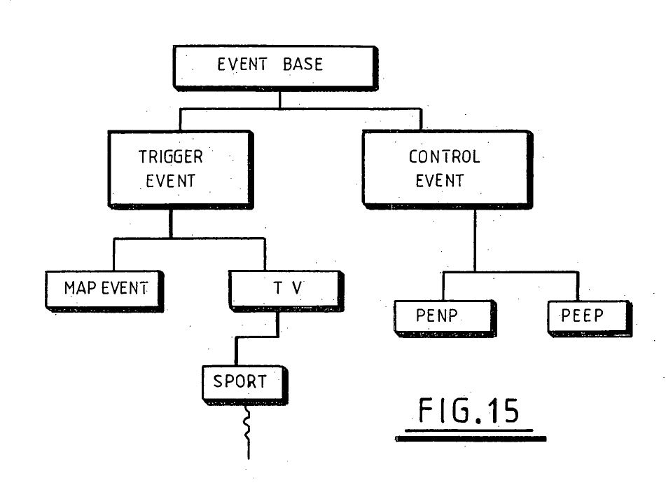

FIG. 15 shows a Java class hierarchy of objects which are instantiated by event creation using the classifier. The top level class of the hierarchy is the EventBase class, the features of which are discussed later. The subsequent level of the hierarchy provides TriggerEvent and ControlEvent classes. ControlEvents are related to system data and are discussed later. All event data created by the classifier is represented by sub-classes of TriggerEvent. More specifically, all objects created in the current example are instances of the MapEvent class. Instantiation of other classes will be described later.

The MapEvent class has the following instance variables which are used to denote attributes of an event represented by the class:

Category—This defines the location of the object within a hierarchy used for classification. This will correspond with the category attribute specified for the appropriate button within the XML palette file of Appendix 2.

Sequence No—This is a unique identifier which is allocated by the classifier. This ensures that each event can be referenced uniquely.

StartTime—This identifies the time at which the event represented by the object begins. It is measured in seconds from a predefined start point. Thus all times allocated by the classifier are consistent.

EndTime—This identifies the time at which the event represented by the object ends and is measured in the same way as the start time.

Duration—This indicates the duration of the event. This provides an alternative to EndTime or allows some redundancy within the object representation.

Channel—This indicates the broadcast channel (e.g. CNN) on which the event is occurring. In the present example channel is represented by an integer, and a simple mapping operation will allow channel names to be derived from these numbers.

Programme ID—This indicates a distributed programme which corresponds to the event or within which the event is occurring. It is used only for distributed programme events, and is undefined for all other events.

Name—A text string providing a user with a meaningful name for the event.

Parent—An identifier allowing an event's parent event to be linked. This will be described in further detail below. Top-level events, such as the Wimbledon event shown in FIG. 14A, have no parent, and this is denoted by a parent identifier of −1 in the MapEvent object

Iconfile—This is an identifier of a file containing an icon which is used to represent the event of the object.

Rating—It has been described above that an operator can add a subjective rating to an event to indicate its interest or entertainment level. This is stored in the rating variable.

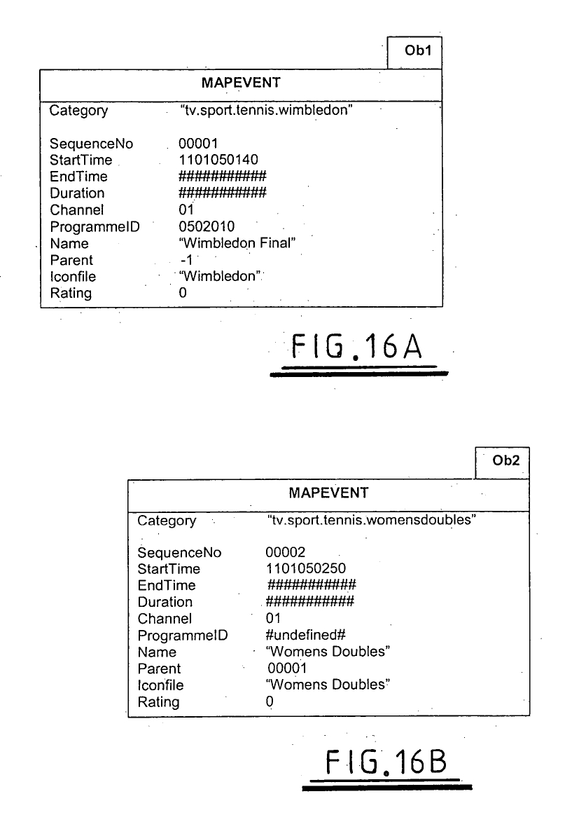

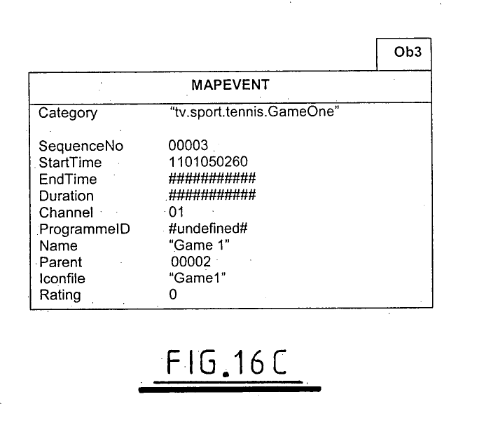

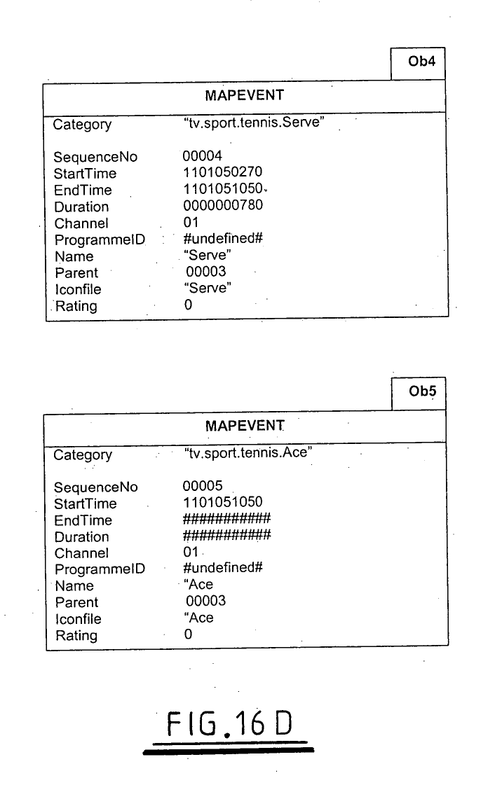

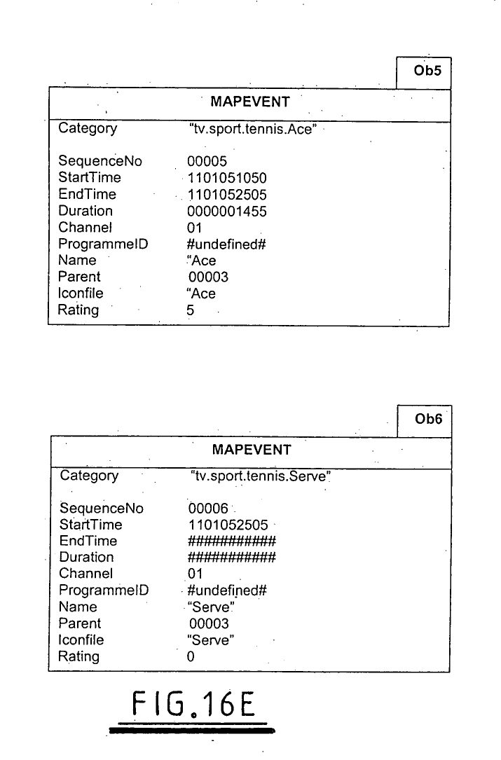

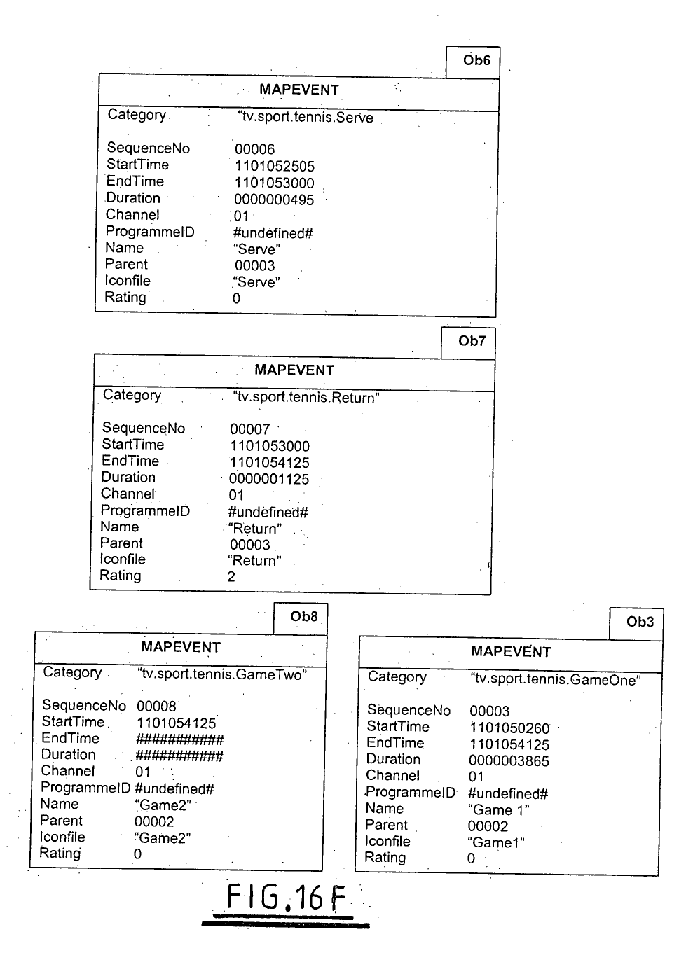

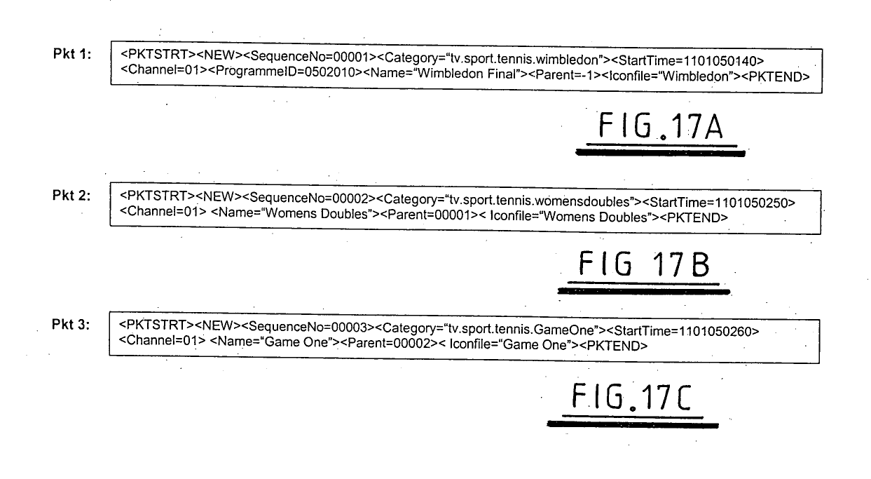

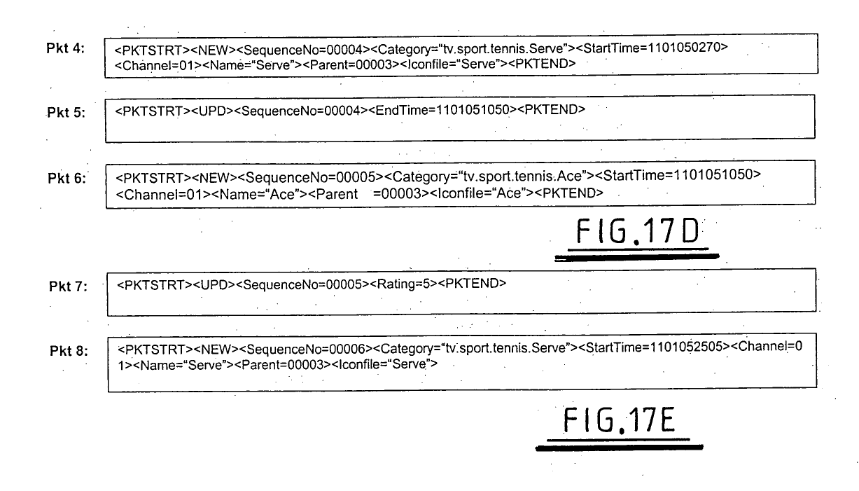

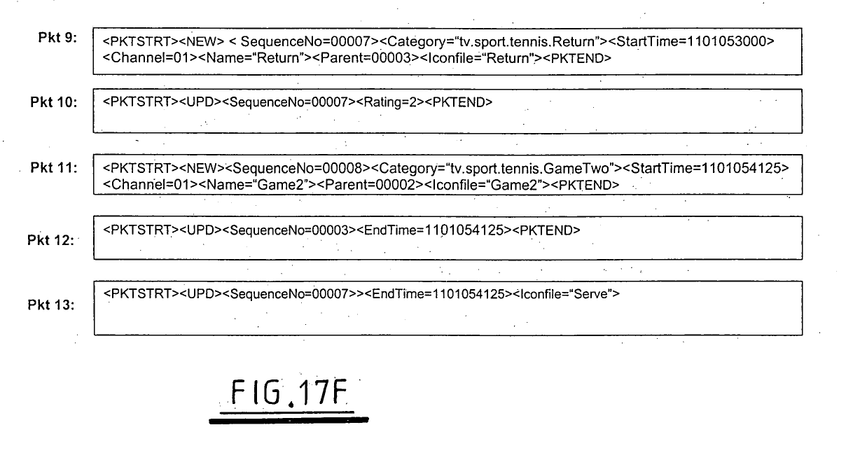

FIGS. 16A to 16F shows instances of the MapEvent class which are created to represent the events shown in FIGS. 14A to 14F. Each object creation, and each update to an object's variables, will result in the generation of a suitable data packet for transmission to the home receiver, and these data packets are shown in FIGS. 17A to 17F. FIGS. 17A to 17F respectively represent the data packets created by the object creation and object updates shown in FIGS. 16A to 16F. Similarly, FIGS. 16A and 16F represent objects created in response to event classification shown in FIGS. 14A to 14F respectively. FIGS. 16A to 16F and FIGS. 17A to 17F are described in parallel here.

Creation of the Wimbledon event as shown in FIG. 14A will result in an object Ob1 being created, as illustrated in FIG. 16A. It can be seen that the category of Ob1 is “tv.sport.tennis.wimbledon” which is a logical category for an event relating to the Wimbledon Programme. The sequence number of the event is 00001 as this is the first event generated by the classifier and the start time variable is also set. A string of “#” characters is used throughout this example to indicate an unknown value. This is appropriate in FIG. 16A as it will be appreciated that the EndTime and Duration of the Wimbledon programme event are not known when the object is created. As no subjective rating has been allocated to the event, this is set to a default value of 0. The parent variable is set to −1 to indicate that the Wimbledon programme event is a top level event. The other variables are initialised to values appropriate to the Wimbledon event.

Creation of the Wimbledon event and the associated object Ob1 will result in a data packet Pkt1 being created for transmission to home viewers with the associated programme data. The format of this data packet is schematically illustrated in FIG. 17A. It can be seen that all instance variables for which values are defined are included. Undefined attributes are not included thereby reducing bandwidth requirements. Packet start (<PKTSTRT>) and end (<PKTEND>) tags are also included in the packet format. Following the <PKTSTRT> tag there is a tag <NEW> indicating that this is the first data packet associated with the sequence number quoted therein. In the case of second and subsequent packets relating to a particular object, the <NEW> tag is replaced by an <UPD> tag to denote that the packet contains update information. Packets using the <UPD> tag are shown in subsequent figures. The actual transmission of these packets is described later.

Referring to FIG. 16B, a MapEvent object Ob2 representing the mixed doubles match of FIG. 14B is shown. It can be seen that the category variable is appropriately set. It should be noted that although the Wimbledon programme event and the mixed double event may have started simultaneously, there is a slight difference in start time which is due to the reaction time of the classification operator. Other variables can be seen to be set appropriately for the Mixed Doubles event. In particular, it can be seen that the programme ID variable is undefined, because this variable is set only for top level programme events. Other events are linked to a programme by means of the parent ID variable which in this case is correctly set to 0001 which is the sequence number of the Wimbledon Event.

Creation of the object Ob2 shown in FIG. 16B results in a data packet Pkt2 shown in FIG. 17B being created for broadcast to home viewers. The data packet shown in FIG. 17B corresponds to the variables of FIG. 16B in the same way that the data packet of FIG. 17A corresponds to the object of FIG. 16A.

Creation of the Game 1 event of FIG. 14C results in the creation of object Ob3 which is illustrated in FIG. 16C. It can be seen that all variables are appropriately set for the Game 1 event, and in particular the parent variable is set to indicate that the Game 1 event is a child of the Mixed Doubles event represented by Ob2. A corresponding data packet Pkt3 is generated which is illustrated in FIG. 17C.

Referring to FIG. 16D in combination with FIG. 14D, the objects created in relation to the events shown in FIG. 14D will be described. Selection of the Serve event using button 42 creates a suitable MapEvent Object Ob4. At the time of this object's creation, it is not known when the event will end, and thus the EndTime field is undefined, however, creation of the “Ace” event using the button 43 of FIG. 14D results in the creation of the MapEvent Object Ob5 and also causes the EndTime field of the “Serve” object Ob4 to be completed. FIG. 16D shows the state of the objects Ob4 and Ob5 at the end of the sequence of events represented in FIG. 14D and accordingly object Ob4 includes an EndTime value. It can be seen from FIG. 16D that each of the objects has a parent of 0003 denoting that the objects are both children of the “GameOne” event, as is schematically illustrated in the history panel 33 of the interface shown in FIG. 14D.

The creation of the Serve event results in the transmission of a data packet Pkt4 of FIG. 17D which is of a similar format to the packets shown in FIGS. 17A, 17B and 17C. Creation of the “Ace” event results in the transmission of Pkt 5 which includes an EndTime and duration for the Serve event which are now known. This packet includes an <UPD> tag as described above to indicated that the packet contains information relating to a previously transmitted object. Pkt6 is created to represent creation of the “Ace” event. Pkt5 and Pkt6 are sent at substantially the same time.

The next classification action as illustrated in FIG. 14E is the rating of the “Ace” event as a five-star event. This action updates the rating variable of the “Ace” event. This is shown by an update to the rating variable of Ob5 as illustrated in FIG. 16E. This rating also results in a suitable data packet Pkt7 shown in FIG. 17E being transmitted to home viewers. The purpose of the data packet Pkt7 is to update the information stored by the receiver to indicate that the “Ace” event is of high entertainment value. Again, the packet Pkt 7 corresponds to an update to a previously created object and therefore contains an <UPD> tag.

The next event created in FIG. 14E is a serve event which is again created using the button 42. The creation of this “Serve” event causes the creation of a suitable MapEvent object Obj6 shown in FIG. 16E and the creation of a suitable data packet Pkt8 shown in FIG. 17E.

FIG. 16F shows the objects created and updated as a consequence of the classification shown in FIG. 14F. Creation and rating of the return event results in the creation of a suitable map event object Ob7, the end time being inserted when the “Game 2” event is created”. The “Game 2” event is represented by Ob8. Furthermore, the creation of the “Game 2” event object Ob8 results in an update to the object Ob 3 representing the “Game 1” event. This is shown as an update to Ob3 in FIG. 16F. It can be seen from FIG. 16F that both the return object Ob7 and the “Game 1” object Ob3 have the same end time, as the EndTime of each of these events is determined by the start of the Game 2 event represented by Ob 8.

FIG. 17F shows the data packets transmitted in relation to the events of FIG. 14F. Creation of the return event represented by Ob 7 results in the creation of a data packet Pkt9, Pkt10 is transmitted to indicate the rating applied by the classification operator to the return event represented by the object Ob7, Pkt11 it transmitted to indicate the creation of an object Ob8 representing the “Game 2” event, Pkt12 is transmitted to indicate the end of the “Game 1” event and Pkt 13 is sent to indicate the end of the “Return” event.

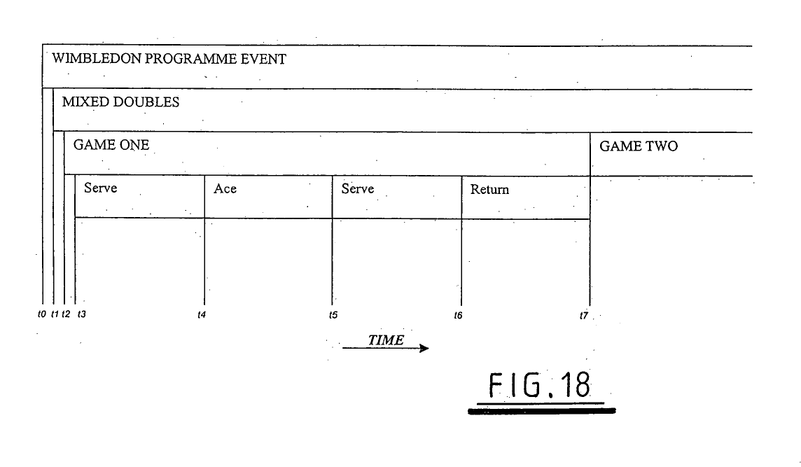

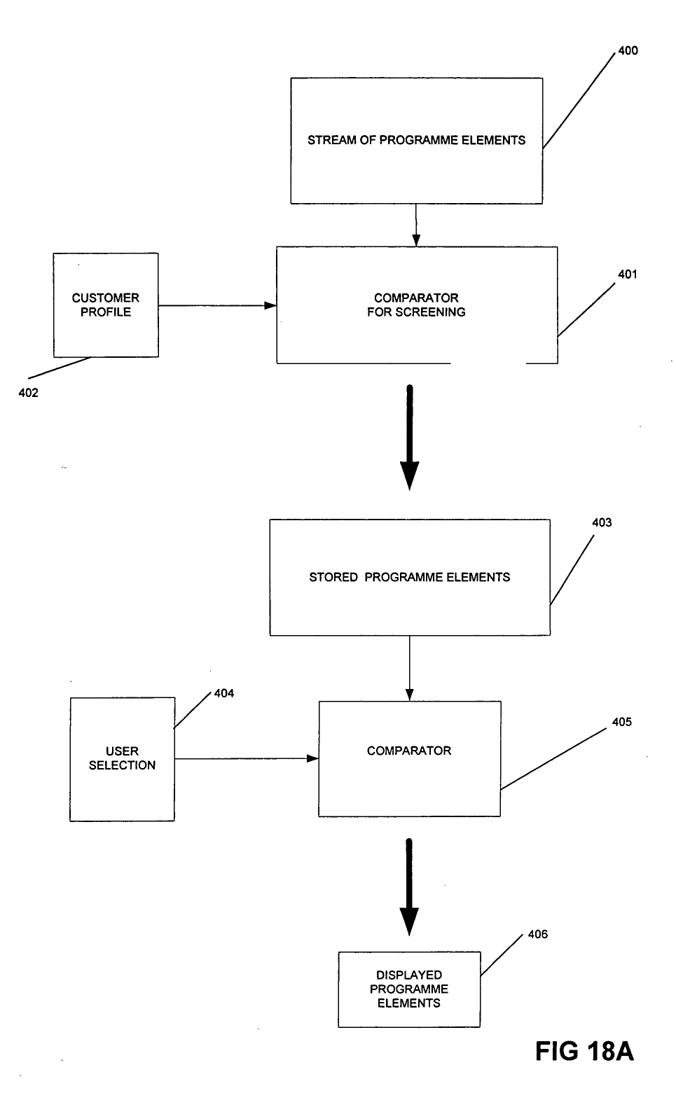

The temporal sequence of events is shown in FIG. 18. Time is indicated on the horizontal axis, with events appearing in hierarchical order, with higher level events appearing towards the top of the figure. At time t0 the object Ob1 is created and the data packet Pkt 1 is transmitted. At time t1, the object Ob2 is created and the data packet Pkt 2 is transmitted. At time t2 the object Ob3 is created and the data packet Pkt 3 is transmitted. At time t3 the object Ob4 is created and the associated data packet Pkt 4 is transmitted. It should be appreciated that the creation of the objects set out thus far and the transmission of the associated data packets will occur in a very short time period, and thus the elapsed time between t0 and t3 is small.

At time t4 the object Ob 5 is created and two data packets, Pkt 5 and Pkt 6 are transmitted. Pkt 5 provides an end time for the “Serve” event represented by Ob 4 and Pkt 6 represents the creation of the “Ace” event object Ob 5.

At time t5 the rating of the “Ace” event represented by object Ob 5 is entered in Ob 5, the rating data being transmitted by means of data packet Pkt 7. The second “Serve” event creates an object Ob 6 and this object creation is reported by the transmission of the data packet Pkt 8.

The creation of the “Return” event at time t6 results in the creation of Ob 7 and the transmission of the data packet Pkt 9. The subsequent rating of this event at some time between t6 and t7 results in the transmission of the data packet Pkt 10. Creation of the “Game 2” event marks the end of the “Game 1” event and the “Return” event as described above. Creation of the “Game 2” event results in the generation of the object Ob8 at time t7 and the transmission (at the same time) of the data packet Pkt 11 to indicate this object's creation. At substantially the same time two data packets Pkt 12 and Pkt 13 are transmitted to indicate that the “Game 1” event and the “Return” event have finished.

Referring back to FIG. 10, the process of classification using the classifier 22 to generate a file of event data 23 has been described. Furthermore, the transmission of event data in data packets, alongside programme data from the programme data file 21 by means of the broadcast server 24, has also been described. Packets transmitted by the broadcast server 24 are received by a home terminal 25. The subsequent process at the home terminal 25 will now be described.

Data packets as illustrated in FIGS. 17A to 17F are received by a home terminal and processed by computer program code to re-generate EventBase objects of the type used by the classifier. Given that this embodiment of the invention relies on object oriented programming techniques, the computer program executed by the receiver can be conveniently implemented using the Java programming language. Packets are received and processed to determine what action should be taken. If a data packet contains a <NEW> tag following the <PKTSTRT> tag, as in Pkt 1 of FIG. 17A for example, the computer program will create an EventBase object, and instantiate the variables provided in the data packet with the values provided in the data packet. If a data packet contains an <UPD> tag following the <PKTSTRT> tag, as in Pkt 5 of FIG. 17D, the program code will use the information contained in the data packet to assign values to the various variables in the previously created object having that sequence number.

The home receiver is provided with means to store a user's event preferences, such that the home receiver can act differently in response to different types of objects being created or updated. Typically the actions which may be taken by the home receiver will involve recording incoming programme content, stopping to record incoming programme content, or informing a user that particular programme content is being received. A profile for a user is stored within the home receiver and this profile is compared with the category field of each created EventBase object (or MapEvent which is a child of EventBase in the hierarchy of FIG. 15)

The home receiver is provided with software which allows a user to specify event types of interest. This can conveniently be a hierarchical display, with selection of a higher level event automatically selecting all lower level events. For example, if a user indicates that they are interested in all sport, all MapEvent objects having a category beginning with “tv.sport” will activate the receiver to take some action. Alternatively, if the user is only interested in aces in a particular tennis match, it can be specified that only events having a category of “tv.sport.tennis.ace” should activate the receiver. The interface also provides functionality such that the user can specify a rating above which the receiver should be activated, such that only events of a certain category with, for example a four or five star rating activate the home receiver.

FIG. 18a is a schematic overview of processing carried out by the home receiver. A stream of programme elements 400 is input to a comparator 401 into which is also input a customer profile 402. The comparator 401 is configured to compare classification codes of the stream of programme elements 400 with classification codes specified in the customer profile 402 to identify programme elements having associated classification codes matching classification codes specified in the customer profile 402. The comparator 401 outputs a stream of identified programme elements which form a set of stored programme elements 403.

Having generated the set of stored programme elements 403, a user selection 404 is received by a further comparator 405. The comparator 405 is configured to identify programme elements of the stored programme elements 403 which match the user selection 404. Programme elements within the stored programme elements 403 identified as matching the user selection are then displayed to a user, schematically denoted 406.

The overview illustrated in FIG. 18a is of a system in which a user profile 402 is used to screen received programme elements to generate a set of stored programme elements and these stored programme elements 403 are then queried by a user to identify content of interest. Thus, for example the customer profile 402 may indicate that a particular user is interested in all sports broadcasts, thus resulting in the stored programme elements 403 containing all received programme elements relating to sport. The user selection 404 may more specifically indicate that a user wishes, at a particular time, to view football programmes. The comparator 405 will then retrieve football programme elements from the stored programme elements 403 for display schematically depicted 406.

It will be appreciated, that as indicated above and as described in further detail below the comparator 401 may be configured to carry out various other functions. For example on encountering the classification code indicating that a particular programme element represents content of interest to a user the user may be alerted to the programme element by, for example interrupting the currently displayed programme element and displaying the received programme element in its place. Alternatively a message may be provided to the user indicating receipt of that programme element. Indeed the user may be alerted to receipt of the programme element having a classification code matching that specified in the customer profile by any appropriate means. As described below, a user may specify a particular threshold level of interest which is required for a particular classification code to activate the comparator. Additionally or alternatively the user may specify programme classification codes in an order of preference such that a more preferred programme element is always selected in preference to a less preferred programme element. It will be readily appreciated that the comparator 401, as is described below, can be adapted to carry out these various functions.

The profile built up by a user using the interface described above can conveniently be stored as a series of triples (i.e. ordered sets having three elements) of the form:
(Category, action required, rating)
   where Category defines a category, action required is a flag indicating the action which is to be taken by the home receiver upon encountering an object having that category, and rating is a minimum rating required to activate the receiver.

The home receiver creates and updates objects as described above. The home receiver also constantly buffers all received programme content. If an object is created or updated which matches the category field, and the action required is “record”, buffered content is copied to the recorded programme data and recording continues. More details of the implementation of the home receiver will be described later.

To add further functionality, the broadcaster may transmit attribute data packets alongside the information set out above. For example, in the example of the Wimbledon programme set out above, a “Game” event may have two textual attributes representing the names of the players. Such attributes can be transmitted to the home receiver and can be specified using the profile definition features set out above, allowing a user to indicate a particular interest in particular players for example. If attributes are to be used in this way the objects of FIGS. 16 will require a further attribute variable which can conveniently be providing using a dynamic array of strings, thereby allowing any number of attributes to be specified. Similarly, the tuples defining the profile stored at the home receiver will become quartuples (i.e. ordered sets having four elements) of the form:
(Category, action required, rating. attribute[ ])
   where attribute[ ] is an array of attributes.

The example presented above relates to the classification, broadcast and reception of the Wimbledon programme. It should be realised that the present invention can be applied to a wide range of broadcast content, and is not in any way limited to tennis or sports programmes.

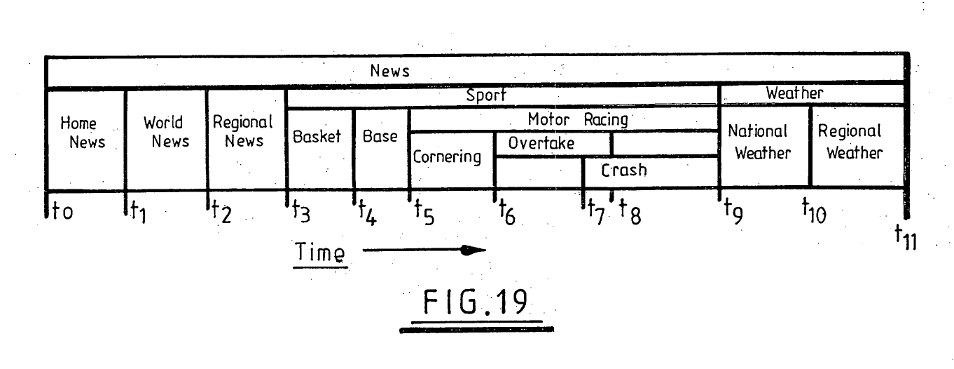

For example, FIG. 19 shows a news programme split up into a number of events. The horizontal axis of the figure represents time, and time advances from left to right. The news programme occurs between time t₀ and time t₁₁. The horizontal axis is not drawn to scale.

The entire programme is a news programme event, and any event data representation for that programme must record that a news event begins at time t₀ and ends at time t₁₁. The news event comprises five sub-events. A first event relates to home news and occurs between times t₀ and t_{1,} a second event relates to world news and occurs between times t₁ and t₂, a third event relates to regional news and occurs between times t₂ and t_{3,} a fourth event relates to sports news and occurs between times t₃ and t₉, and a fifth event is a weather forecast which occurs between times t₉ and t₁₁.

The five events identified thus far are all constituents of the news events, and occur at the next hierarchical level to the news programme event itself. Furthermore, each of these events are sequential, with one event beginning as the previous event ends. As will now be described it is not always the case that events at one level in the hierarchy are always sequential.

For example, the sports news event comprises three sub events. A first sub-event relates to basketball and occurs between times t₃ and t₄, a second sub-event relates to baseball and occurs between times t₄ and t_{5,} and a third sub-event relates to motor sport and occurs between times t₅ and t₉. The motor sport item in turn contains three sub-events. A first sub event represents a cornering sequence, a second sub-event represents an overtaking sequence and a third sub-event represents a crash. It can be seen from FIG. 19, that the overtaking event occurs between times t₆ and t₈ and the crash event occurs between times t₇ and t₉, where t₈ occurs after t₇. Thus, the overtaking and crash events overlap. This can be seen to be useful, as a user wishing to skip directly to the crash event is likely to desire some footage showing the cause of the crash, which in this case is the overtaking event. Thus, in a system in accordance with the present invention events can overlap, and one event need not necessarily end when another begins. This feature can conveniently be provided by presenting the classification operator with a button which acts to start a further event at the same hierarchical level, before closing the previous event. It can also be seen from FIG. 19 that the weather event contains two sub events, one relating to national weather and one relating to regional weather.

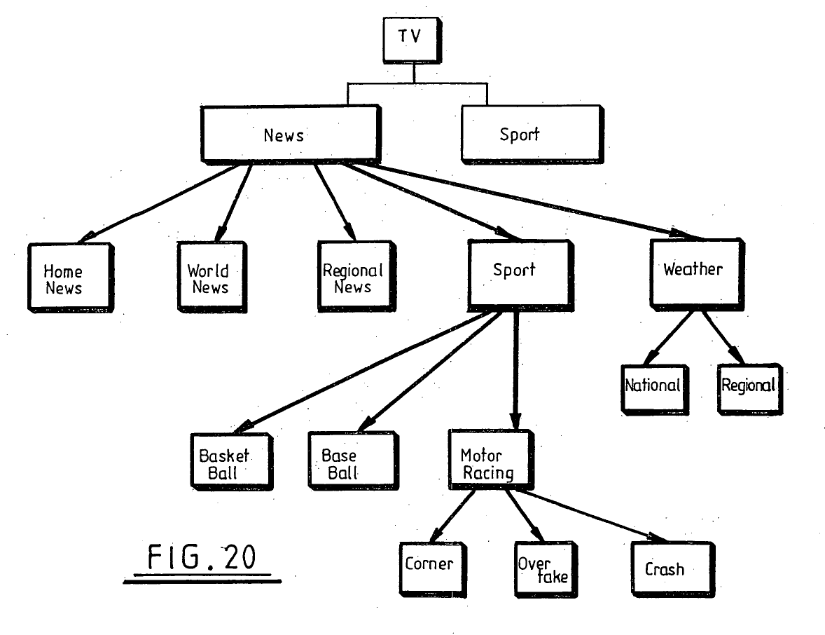

The description of programmes made up of events as set out above leads to a hierarchical event structure. Referring to FIG. 20, there is illustrated a tree structure showing the same event data as that illustrated in FIG. 19. The top level TV node and the sport node referred to in the Wimbledon programme example are also shown. The news node represents the news event, and this node has five children representing the sub-events identified above. The sub-events relating to home news, world news and regional news are leaves within the tree structure, as they have no sub-events. In contrast, the node representing the weather event has two child nodes to represent the national and regional weather sub-events, and the node representing the sport event has three sub-nodes representing its sub-events. Two of the child nodes of the sport event node are leaves having no sub-events, while the node representing the motor-racing event has three child nodes representing sub-events. Each of these child nodes are leaves in the tree structure.

Classification of the news programme as discussed with reference to FIGS. 19 and 20 will result in objects being created and data packets being transmitted in a similar way to that described with reference of FIGS. 16 and 17 illustrating the Wimbledon programme.

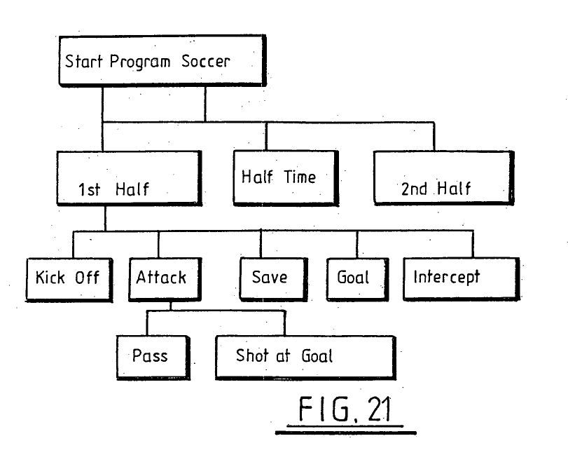

As a final example of event classification, reference is made to FIG. 21, which illustrates events suitable to classify a soccer match. It will be appreciated that this hierarchy can be encapsulated in an XML file of the form of appendix 2 and can be used to classify soccer matches as described previously with reference to FIGS. 7 and 8.

The examples set out above describe a situation where classification is performed in real time as the programme is being transmitted. It will be appreciated that the invention is also applicable in situations where a classification sequence is performed offline in advance of a broadcast and stored in a suitable file. Such event data is then broadcast alongside the programme data as described above. In this case, the objects created by the classification can suitably be stored in an XML file such that each object has a MapEvent entry having attributes appropriate to the particular object.

When performing classification as described previously, it will be appreciated that there may be a noticeable gap between the start of an event and an operator recording that event classification. Two latency compensation methods are provided to mitigate this effect. First, each event is subject to a default offset, whereby an event is considered to have begun a predetermined number of seconds before the classification is performed. Furthermore, a set of buttons are provided whereby an operator can increase the default offset. This is particularly useful in any case where an operator is aware of a delay, and can manually insert a greater latency. These features ensure that a classification will be timed so as to ensure that an event is not truncated at its start. Using these latency compensation techniques will result in amendments being made to the instance variables of the object representing the event, and will also create data packets suitable for transmission to home receivers to indicate these changes.

Referring back to FIG. 13A the interface shows the current default latency as “0 secs” (see reference 48). This default latency can be amended by using a button 49 which displays a suitable dialog box. Three buttons 50 allow the operator to use a greater latency if he is aware that there has been a particular delay. The buttons 50 simply subtract 2, 5 or 10 seconds respectively from the start time of the current event, and make appropriate changes to the Java object representing the event. A suitable data packet is also generated for transmission to the home receiver.

Still referring to FIG. 13A, a button 51 is provided to perform an “undo” function. Selecting this button will delete the currently selected event and reopen the previous event by deleting its finish time.

A button 52 is used to stop the currently active event without creating another event. Repeated use of the button 52 will close events at higher hierarchical levels until all events are closed. This button is intended for use at the end of a classification sequence.

When an event begins, it will not always be clear what its outcome will be. For example, in a tennis game when a ball is struck it may be an “Ace” event or a “Fault” event, although it will not be known which until after the ball has been struck. It is desirable that the event is considered to have started shortly before the ball is struck. Accordingly, a tag button 53 is provided. This tag button is pressed when an event begins and it is not clear how the event should be classified. When the classification becomes clear an appropriate button is selected from the palette panel, and this classification is timed to have begun at the point at which the tag button 53 was pressed (subject to any latency compensation as described above).

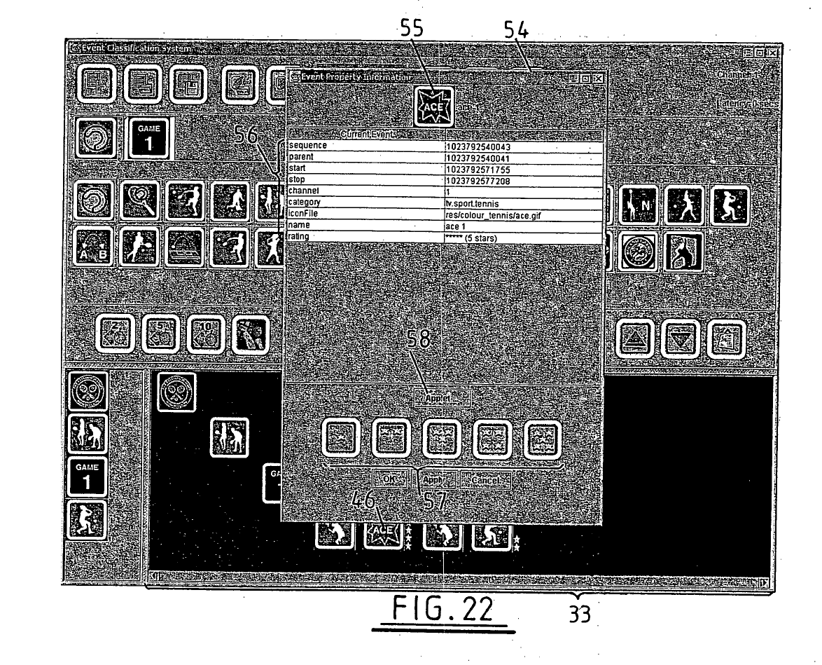

When performing an offline classification it may be desirable to retrospectively amend properties of events. Referring now to FIG. 22, there is illustrated the screen of FIG. 14F with an overlaid properties dialog 54 which can be used to inspect and amend event properties. The dialog shown relates to the “Ace” event indicated by the icon 46 in the history panel 33. An icon 55 is provided within the dialog to indicate the type of event to which the dialog relates. An area 56 includes nine lines of text relating to the event. A first line represents sequence number, a second line the sequence number of the parent event, a third line indicates the start time, and a fourth line indicates the stop time. A fifth line contains a channel identifier, a sixth line contains a category indication, a seventh line indicates the file name of the icon which should be used to denote the event and the eighth line indicates a user readable form of the event's name. A ninth line indicates the rating applied to the event. It can be seen that these attributes correspond closely to those provided by the MapEvent objects illustrated in FIGS. 16. The attribute values shown in the dialog and identified above are locked such that they can only be inspected, not changed by a user so as to prevent the risk of malfunction. In some cases this dialog will also contain attributes which may be set and amended by a user so as to provide the attribute application and matching functions identified above. The rating applied to an event may be changed using the buttons 57. It can be seen that the attribute values shown in area 56 of FIG. 22 differ from those shown in the object Ob5 of FIG. 16E. For example, the sequence number of Ob5 is different to the sequence number shown in FIG. 22. It will be appreciated that in an operational system, the attribute values shown in FIGS. 16E and 22 will be consistent.

The final component of the property dialog is a button 58 which is used to define an applet which is applied to an event. The term applet is hereinafter used to mean a Java application which can be executed by a home receiver. Clicking the Applet button 58 results in the display of a dialog allowing a file name to be specified for an applet which should be sent to a receiver alongside the data packets relating to that event. The dialog also allows the operator to set one or more parameters which may be used to customise operation of the Applet at the home receiver.

The Applet feature of an event is potentially very powerful. Possible applications include applications capable of displaying a dialog on a home user's screen allowing the user to take part in an on-line vote using a remote handset associated with the home receiver. Furthermore, applets may be launched which display an icon which can be selected to direct a home user to an appropriate website. For example, during advertising an icon may appear in the top right hand corner of the screen, the user may then select this icon using a button on the remote handset whereupon all or part of a display screen associated with the home receiver displays a website related to the current advertisement. Alternatively an icon may be displayed which is selectable to display a window allowing direct purchase of items related to the advertisement. This may again be achieved using an associated website. Other applets may be launched to link a user to associated programme content, for example if a programme has been recorded and a currently broadcasting programme makes a reference back to that recorded programme an applet can be executed to cause that recorded programme to be displayed. The applet property of an event is realised by transmitting Java classes to the home receiver which may be executed to provide the applet. It will be appreciated that this applet concept is widely applicable and any application which can be written in a suitable programming language can be transmitted to the home terminal for execution alongside the television transmission. It is likely to be particularly applicable when applied to television content relating to advertising. The applet feature is particularly useful because further applications can be added as time progresses giving the system expandability for the future.

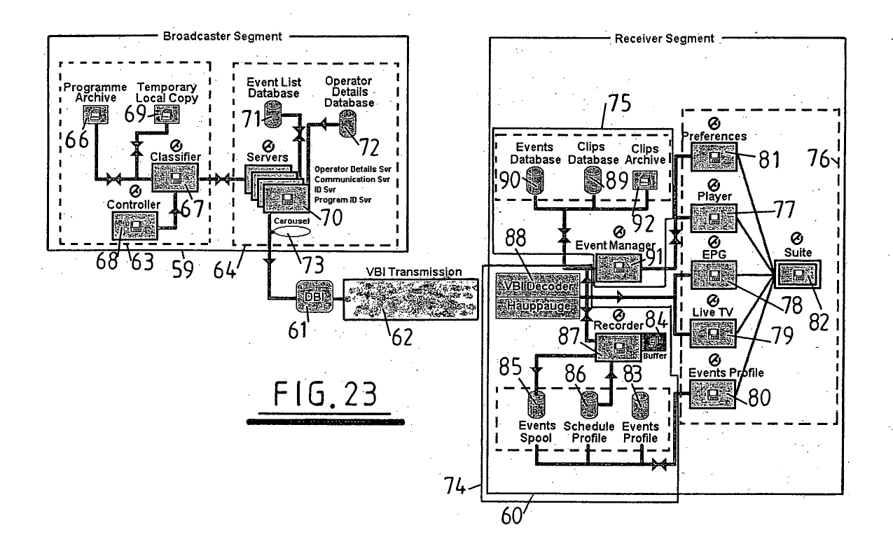

A detailed architecture for the implementation of the present invention will now be described with reference to FIG. 23. The system can be considered to comprise a broadcaster segment 59 and a home receiver segment 60. Programme and event data generated by the broadcaster segment passes to a broadcast interface encoder 61 for broadcast to the receiver segment. This broadcast is schematically represented by a box 62. The broadcast of programme data is conveniently carried out using any conventional transmission technology, while event data can be broadcast using either the vertical blanking interval of a conventional television broadcast or using an alternative communications channel such as the Internet, or a telephone network.

The broadcaster segment 59 corresponds to the TV image source 6 and the exchange 4 shown in FIG. 1, or the programme data source 21, classifier 22, event data file 23 and broadcast server 24 of FIG. 10.

The broadcaster segment comprises a classification section 63 and a server section 64. The classification section equates to the classifier 22 of FIG. 10 and the server section corresponds to the programme data 21, the event data 22 and the broadcast server 24 of FIG. 10. The classification section 63 and the server section 64 are connected by a connection 65 which is conveniently provided using Remote Method Invocation provided by the Java programming language.

Operation of the classification section will now be described, where the classification occurs off line, and is stored in a file for later transmission. The classification section 63 is responsible for the classification and controlling of programme events. The created sequence of events relating to a broadcast is hereinafter referred to as an event list. An operator is able to select a programme stored in a programme archive 66 and classify the programme into constituent events using a classification module 67 as an off-line process. A programme is selected by choosing the programme's unique identifier using the classifier software. This creates a lock between the programme and the operator. This ensures that conflicts cannot occur as a result of two operators classifying the same programme concurrently. If an event list already exists for that programme (and is stored in the programme archive 66) the existing event list is copied to a temporary local store 69, and displayed in the classifier software. The operator is then able to classify the programme into its constituent events. The classification section 63 acts as a standalone module and programme event information is written to the programme archive 66 for storage without being broadcast at that time. During creation, the event list is stored in the temporary local store 69, and is subsequently copied to the programme archive 66. When the operator chooses to save the created event list, the events are copied from the temporary local store to the event database in the server section 64 of the broadcaster segment (described below). When classification is complete, the lock between the programme and the operator is removed such that other suitably authorised users may edit the created event list.

The programme archive 66 may store programmes either in a digital format or on tape. Each programme in the programme archive 66 has associated with it a unique identifier allocated by the administrator which is used to create a lock between an operator and the programme as described above.

It will be appreciated that if classification is occurring in real time, there will be no need to select a programme from the programme archive 66, but instead it will be necessary to select the broadcast channel to which classification is to be applied.

The classification section 63 also provides broadcast event control. Controller software 68 allows an operator to control broadcast of an event list in synchronisation with programme data. This software accurately sets start and stop times for events in relation to broadcast so as to ensure that the event list and programme are synchronised.

The controller manages all aspects of event broadcast control. In particular when a programme that has been classified off line is broadcast, commercial breaks will be inserted into the programme whilst such commercials will not have been included in the version which formed the basis of classification. This means that event timings will be offset. Furthermore, it is desirable that a home user need not rely on a scheduled broadcast start time shown in television listing guides.

The controller component handles these two difficulties. A classification operator, whose profile permits access to the controller software 68, is able to use the controller software 68, to perform the following steps.

Prior to broadcast of a programme beginning, the controller component sends a Programme Event Notification Packet (PENP) to the server section 64 as briefly mentioned above. The server section 64 broadcasts this PENP to viewers at home by means of the broadcast interface 61. Receipt of this packet by home viewers allows recording devices to check whether they are programmed to record the programme, and if so to begin the recorder process and start buffering. The functionality of the home terminal is described later.

When broadcast begins, the operator presses a start button within the user interface of the controller to send a Programme Event Start Packet (PESP) to the server section, and in turn to the home viewers. The events are then transmitted from the event database to the home viewers as they occur in synchronisation with the broadcast. Event transmission is described in further detail below.

When the operator observes the beginning of a commercial break, he selects a pause button within the interface of the controller software 68. This causes a message to be sent to the server suspending transmission of the event list, and beginning transmission of the advertisements. The operator is then able to classify advertisements in real time as broadcast occurs using the classifier component interface described above. When advertisements finish the operator again selects the pause button and transmission of the event list associated with the programme is resumed. In a preferred embodiment of the present invention, all advertisements are considered to be events positioned at the next lowest level of the event hierarchy. That is, advertisements have a relative not absolute hierarchical position.

At the end of the broadcast the operator again selects the start button within the controller interface. The controller component sends a Programme Event End Packet (PEEP) to the server. On receipt of this packet the server broadcasts an appropriate packet to home viewers to denote the end of the programme, and broadcast of the event list is terminated.

It will be appreciated that the controller and classifier components may in practice share a common user interface having shared buttons. For example, the classification software illustrated in FIGS. 13A and 14A to 14F may be amended to include buttons allowing performance of the controller features as described.

The classification section 63 can be operated on a single personal computer having access to the programme archive 66. It is preferred that the operator be provided with a traditional keyboard, as well as a touch sensitive screen to operate the interface of the classifier which is illustrated in FIGS. 13A and 14A to 14F. The touch sensitive screen will allow the operator to quickly select events and other buttons within the interface, and can be considered to be a plurality of mouse-clicks from the point of view of the implemented program code. The keyboard will be used to input more detailed information such as event attributes. The software may be written in the Java programming language and Remote Method Invocation provided by Java may be used to enable communication between the classifier component and other components of the broadcast server.

The second section of the broadcaster segment 59 is the server section 64. The server section 64 will now be described in general terms.

The server section 64 acts as a server for the broadcast section, stores event lists and programme identifiers, and broadcasts event packets. The server section comprises four individual servers 70 each of which is treated as a separate component. The four servers are an operator details server, a communications server, an identifier server and a programme identifier server. Each of these will be further described below.

The programme identifier and identifier servers are responsible for assigning unique identification tags to programmes and data carriers. The identifiers (IDs) are used to identify each physical data carrier such as a tape or a digital versatile disc (DVD), whilst the programme identifiers (PIDs) are assigned to individual programmes as and when they are classified and become associated with an event list. These two servers will communicate with an event list database 71 to manage the IDs and PIDs. The use of PIDs allows an operator to lock a programme whilst classification is taking place as described above.

The operator details server maintains a permissions containing profile for each operator. It provides an association between a particular operator's ID and the programme types which they are permitted to classify. This information is stored in a database 72 which may be configured by a system administrator. When an operator logs on to either the controller or classifier components, as described above, the operator details server validates this log on and provides controlled access to the various parts of the system by accessing the operator details database 72. This ensures that a programme is only classified by an operator having appropriate expertise.

The communication server communicates with the broadcast interface 61 to broadcast event packets. Events are created using the classifier component and stored in the event list database 71. Control of event broadcast is managed by the controller 68. The communications channel between the communication server and the broadcast interface includes a carousel 73. The carousel allows periodic retransmission of event packets. When an event is broadcast it is placed in a carousel for convenient retransmission if requested. This technique is used in case event packets do not correctly reach their destination. Incorrect transmission may be detected by a receiver using a Cyclic Redundancy Check (CRC) calculation, and may result in a receiver subsequently requesting retransmission of a particular packet from the carousel. Storage of transmitted packets in the carousel 73 prevents packets having to be regenerated by the classifier or controller.

When a programme is about to be broadcast, the server fetches an appropriate event list from the event list database 71 and prepares to broadcast its constituent events in synchronisation with the programme. This transfer is controlled by a PENP packet sent from the controller component as described above. Similarly, the communications server acts to pause, resume and stop event list broadcast in response to receipt of appropriate commands from the controller component.

In summary, the broadcaster segment 59 incorporates means to classify programmes, store event data, and control transmission of event data to home terminals.

Details of a suitable format for the transmission of event data as denoted by box 62 will now be described. The data packets are created by the classification software as described above and as illustrated in FIGS. 17. However, it will be appreciated that various protocol wrappers must be added to these data packets to enable transmission to home receivers. It should be appreciated that the likely nature of the underlying transmission medium (low bandwidth, and no return path) means that industry standard formats such as XML IIOP are not appropriate.

The data transmission relies upon primitive data types provided by the Java language. These types have architecture independent size, and big endian byte ordering is used throughout. These types are set out in table 1 below.

TABLE 1
Primitive data types

| Type | Size | Description | ID |
|---|---|---|---|
| Boolean | 1 byte | 0 = false | −1 |
| | | 1 = true | |
| byte | 8 bit signed two's | −128 to 127 | −2 |
| | complement | | |
| char | 16 bit unsigned integer | Unicode code | −3 |
| short | 16 bit signed two's | −32768 to | −4 |
| | complement integer | 32767 | |
| int | 32 bit signed two's | −2147483648 | −5 |
| | complement integer | to | |
| | | 2147473647 | |
| long | 64 bit signed two's | Large range | −6 |
| | complement integer | | |
| float | 32 bit IEEE 754 standard | About 7 | −7 |
| | single precision | decimal places | |
| | | accuracy | |
| double | 64 bit IEEE 754 standard | About 15 | −8 |
| | double precision | places | |
| | | accuracy | |

Data packets transmitted from the broadcast server to a home receiver are considered to make up a stream of records. Each record has a structure as illustrated in Table 2 below:

TABLE 2
Record Structure

| Element Name | Type |
|---|---|
| IDH | byte |
| ID | Any |
| LNH | byte |
| LN (optional) | Any |
| DATA | Any. |

All records contain a header comprising the IDH, ID, and LNH fields, and optionally the LN field, shown above. The ID field defines the type of the record. The LN field defines the length of all data contained within the record. IDH acts as a header for the ID and LNH acts as a header for the length field.

IDH is a single byte and defines either the data type of the ID if it is negative (according to the ID column of table 1) or the number of bytes contained within the header if it is positive. This allows an ID to contain a string of up to 128 bytes, or alternatively simply a numeric value. The most common and efficient value for the IDH byte is −2 indicating that ID is a single byte.

The ID itself is application specific and will typically take the form of a unique identifier for the data packet. Uniqueness of identifiers is preferred as this simplifies parser logic.

The length header, LNH, defines the size of the record element containing data defining the length of the record. The LNH element is a single byte. A positive LNH value denotes that that the DATA part of the record is a primitive type. The primitive type is generated by negating the LNH value (e.g. if LNH is “2”, the Data is of type “−2” which is a byte). If LNH is positive in this way, there will be no LN element.

If LNH contains a negative value, the primitive type denoted by that value is the type of the succeeding LN element.

Data packets transmitted in the form of records as described above are received by home receivers and are converted first into packets of the form illustrated in FIG. 17 and subsequently into objects as described above. The home receiver will now be described with reference to FIG. 23, where the receiver segment 60 is illustrated.

The receiver segment comprises a recorder section 74, an event manager section 75 and a home viewer suite section 76.

Operation of the home viewer suite section 76 will now be described in further detail. This section is responsible for all interfacing between a user viewing broadcasts at home and the system of the present invention. A number of features are provided to the user.

Each user may have their own profile within the home viewer suite, so that the receiver can be configured to respond to particular event types as described above. As described above, a user may rate their preferences such that a particular rating is required to activate the receiver. Additionally, a user may allocate priorities to particular events such that events having a higher priority are recorded in preference to those having a lower priority. Recording can occur as a background operation while a user continues to watch a broadcast television programme. That is, while broadcast continues, recording may start and stop in accordance with a user's profile without input from the user. The system additionally provides an electronic programme guide providing details of scheduled distributed programmes.

When playing back recorded material, a user may group a number of recorded programmes such that only events matching predetermined criteria are shown. This facility allows only highlights of recorded programmes to be shown. A user can delete predetermined events from a recorded programme, and collect similar events into a group. The system therefore allows complete management of recorded programmes in terms of their constituent events.

When one or more events recorded by the home receiver have been viewed, if the user does not explicitly save the events, their ID is added to a holder Bin. Each item in the holder bin has a countdown time (which may typically run for several days or weeks). When the countdown timer reaches zero, events are deleted so as to preserve space on a disc on which events are stored.

The home viewer suite section 76 comprises five components: a player 77, an electronic programme guide (EPG) component 78, a live TV component 79, an event configuration or events profile component 80 and a preferences component 81. These components cooperate to form a suite 82. The suite 82 is the interface between a home user and the entire system. Accordingly, the suite 82 is provided with an easy to use interface such as a graphical user interface (GUI). The operation of each of these components will now be described.

The player 77 allows a user to view previously recorded events. The player includes a menu comprising a number of options which are displayed to the user. The user can select a Replay button to begin playback and is presented with further opportunity to select whether all recordings or only unviewed recordings should be played back.

Furthermore the user can use the menu to display a list of scheduled programmes or events that have been recorded. Making a selection from this list will load a stored scheduled programme or sequence of events into an internal player memory. If a programme is selected, its constituent events are loaded into the memory in the order in which they occur in the programme. If an event type is selected, events matching that type are loaded into the internal memory as a sequence of events.

The user can then view the events loaded into the internal memory. The player component provides software which allows the user to skip to particular events, move to the next event and playback in various ways. It will be appreciated that standard functionality as provided by a video cassette recorder may be conveniently incorporated into the player software.

The user has the option of deleting events from a sequence or of saving a sequence of events as stored in the internal player memory. IDs of programmes or events which have been viewed are automatically added to a holder bin as described above. Any programmes or events which are specifically selected for saving are not added to the holder bin.

The EPG component 78 can be selected using a user interface provided by the home viewer suite 82. This component displays a window showing an electronic programme guide which may be viewed and navigated by the user.

Selecting the Live TV component 79 from the user interface of the suite 82 displays a live broadcast which may be used to view live television.

The event configuration or profile component 80 allows a user to configure their profile. This component allows users to specify event types which they wish to record. This information is then stored in an event profile database 83 which form part of the recorder section 74. Data is read from this database 83 and compared with broadcast programme and event types. Information about priority and rating levels is also configured using the event configuration component 80.

The preferences component 81 enables a viewer to configure various system parameters. For example holder bin time out, and specification of an order in which programmes should be deleted from the programme data store.

The recorder section 74 is responsible for recording programmes and events in accordance with a user profile. The section allows auto selection of what to record, utilising priority and ratings information, together with event type information to ensure that recorded programmes and events best match a user's profile.

The recorder section includes a buffer 84, and an events spool file 85 to enable buffering of incoming objects as described above. Additionally, in some embodiments of the present invention a user may specify specific distributed programme types which are of interest and these are stored in a schedule profile 86. It should be noted that in the example described above, the schedule profile and event profile will be a common entity, given that distributed programmes are in themselves relatively high level events.

The recorder component is controlled by a recorder module 87 which is coupled to a decoder 88 for receiving broadcast signals. The decoder 88 may conveniently be supplied by Happauge™ software.

The recorder module 87 monitors all incoming broadcasts received by the decoder 88. The decoder 88 reconstructs data packets of the form shown in FIG. 17 from the received data, and these packets are used to create objects which are written to the events spool file 85. The recorder module 87 reads and processes objects from the event spool file 85 as described above.

In addition to event based recording as described above, the user's profile may contain a start time for a programme that is to be recorded. In this case, the recorder commences recording at that time irrespective of the packets received. Thus a system in accordance with the present invention may also incorporate conventional recording technology.

The final section of the receiver segment is the event manager section 75. This comprises a clips database 89 and an events database 90 together with an event manager component 91 and a clips archive 92. The event manager section 75 is responsible for maintaining clips (i.e. televisual images related to events) and event objects.

The event manager maintains associations between clips and their events. Any component wishing to access clip or event data sends a request to the event manager component 91 whereupon this component interrogates the databases 89, 90 to obtain the necessary information.

The auto deletion performed by a holder bin as described above is also managed by this section. A timer associated with every item in the holder bin is monitored by the event manager component 91. When an event's countdown clock reaches zero the event is deleted from the archive together with any associated entries in the clips database 89 or the events database 90.

The event manager component 91 monitors storage space and if it is calculated that available space is not sufficient to maintain recording quality, recording quality is reduced so as to ensure that the programme can be recorded in the available space. If this method does not result in obtaining sufficient space for recording of the necessary events, stored events having low priority are deleted. This process begins with the event of lowest priority and continues until sufficient space is found. The number of events that can be deleted in this way is configurable by the user. If there is still insufficient space, recording with not take place and a message to this effect is displayed to the user. The user may then manually delete stored clips and events so as to obtain enough free space.

It has been described above, that the home receiver can identify received programme element which are of interest to a user, by comparing received classification codes with classification codes specified in a user profile. The present invention also has applications in the distribution of emergency information. In such applications, emergency information is contained within a programme element having a special classification code indicating that the programme element relates to emergency information. The home receiver is configured such that programme elements classified using this classification code are always immediately displayed to a user so as to inform the user of the emergency information. Thus, the classification code used to classify emergency information can be considered as being included in every user's profile by default and as having the highest priority within every user's profile. Upon receipt of the programme element representing emergency information this programme element is immediately displayed to the user. It may be, for example, that when a programme element representing emergency information is received the home receiver is in a stand by mode in which the display device is not active. In preferred embodiments of the present invention the home receiver is configured to initialise the display device upon receipt of emergency information so as to enable it to be displayed immediately to the user. Display of the emergency information is preferably accompanied by a further indication such as an audio signal to draw the user's attention to the home receiver.

It will be appreciated that the applications of the present invention in distributing emergency information are highly valuable, and can be used to inform large groups of people quickly of, for example a natural disaster, or a terrorist attack

The broadcast segment described above contains a broadcast server which is central to the system. Implementation of the broadcast server in terms of its constituent classes, and its communications interfaces will now be described. The broadcast server is an application software service providing an interface of functions to the classification system described above, whereby transmission of events may be effected. The broadcast server can either be operated on the same physical server as the classification process or is preferably housed on a separate server box linked by a computer network. This allows a number of classification workstations to access a shared broadcast server.

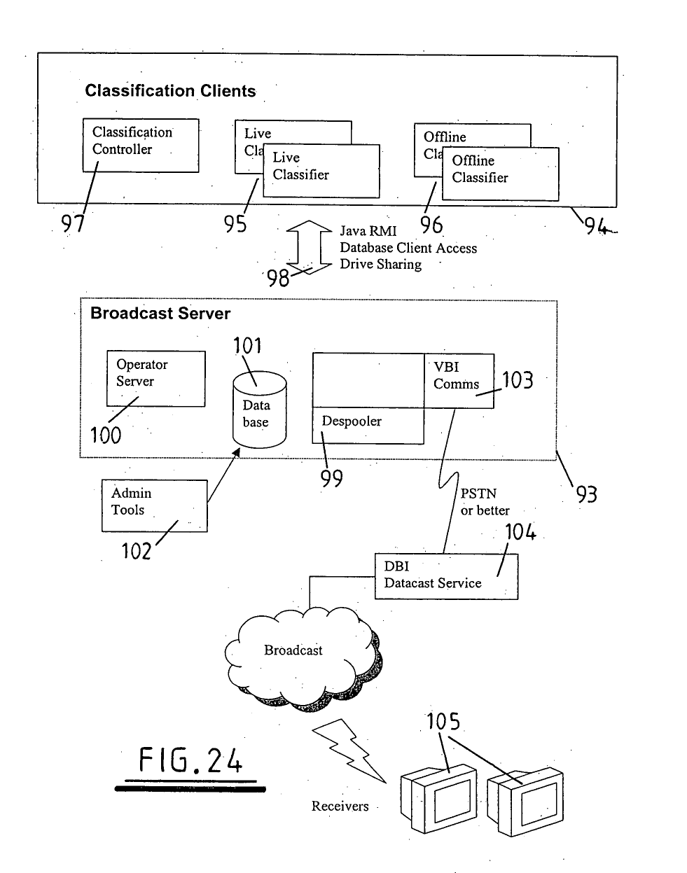

Referring to FIG. 24, a broadcast server 93 is shown in communication with a number of classification clients 94. Each of these classification clients executes program code to implement a software application as described above. These classification clients collectively form the classifier 67 described above. A number of online (or live) classifiers 95 and a number of offline classifiers 96 are all controlled by a classification controller 97. These clients use an interface 98 provided by the broadcast server 98 using Remote Method Invocation (RMI), which allows comprehensive communication between the classification clients 99 and the broadcast server 98 which broadcasts events. The interface 98 is provided by one or more Java classes. Communication between the classification clients 94 and the broadcast server 93 uses EventBase objects, and other objects derived from the EventBase class. EventBase objects representing events are created by the classifiers as described above. These objects are passed to the broadcast server 93 by means of the interface 98. Each time an object is updated, a partial EventBase object is passed to the broadcast server by means of the interface 98 containing the sequence number of the object, and the updated data. When an object is received by the broadcast server action is taken to create and broadcast suitable data packets of the form illustrated in FIGS. 17. All data supplied in the object passed to the broadcast server 98 is copied to an appropriate data packet and broadcast to home receivers.

The Java classes provided by the broadcast server to form the interface 98 expose the following methods:
SendEvent(EventBase); (1)

This method passes a single EventBase object to the broadcast server. On receiving an event, the broadcast server passes the objects to its communications modules for creation and broadcast of suitable data packets.
SendEvents(EventBase[ ]); (2)

This method passes an array of EventBase objects to the broadcast server. Passing a plurality of EventBase objects is particularly important where a new event signals the end of one or more earlier events. Each event passed in this way will generate a data packet suitable for broadcast to home receivers.
GetNextSequence( ); (3)

This method returns the next available event sequence number. All classification clients use this method to obtain unique identifiers for their events. Each identifier is only ever issued once. If a particular identifier is lost or not used by a classification client for any reason there will be a gap in the sequence of identifiers. This ensures that each identifier is unique.

Each offline classification client 96 writes event lists to a file in Extensible Markup Language (XML) format. This file will contain event timings relative to a start time of the programme being classified. Broadcasting complete event files including relative timings creates excessive complication for receivers, as commercial breaks and transmission delays must be taken into account. Therefore, an event list with relative timings is stored by the broadcast server 93 and transmitted live in time with the programme. Conversion from relative to absolute time is performed by the broadcast server.

The classification controller 97 oversees all event broadcasts. An operator of the classification controller is responsible for transmission of pre-recorded event information This process is also known as “despoiling”. The operator may additionally have control over live event transmission. The despooling process is controlled by the classification controller using a despooler 99 provided by the broadcast server 93. The classification controller 97 and despooler 99 communicate using methods exposed by the despooler by means of RMI. The actions performed include selection of a programme to be broadcast from a database and indication of when various packets indicating programme start are to be broadcast. The classification controller operator also controls pause and resume of the event list, typically for commercial breaks.

The despooler 99 reads events from an XML file containing EventBase objects. The despooler is provided as a software service and more than one instance of the despooler class may exist at one time to allow multiple programmes to be broadcast concurrently. The despooler reads relative timed events from the XML file and converts these times into absolute start and stop times. Events having absolute timings are then passed to the communications module. Events passed to the communications module in this way resemble events generated in real time thus offline and online classification can be handled in the same way thereafter. Therefore, receivers always receive events with absolute times.

The first event in the XML file will have a relative start time of 0. This may not be the start of the video clip, and a clip start offset field provides a convenient way of replaying events in synchronisation with the video clip for editing purposes. This feature is required as preamble present in the clip (e.g. technical information) will not be transmitted to receivers. The clip start offset field is not used by the despooler. The despooler will begin reading and transmitting events at the start of the programme. It should be noted that the programme start event is sent directly from the classifier and does not pass through the despooler.

The despooler exposes a number of methods to allow the interaction with the classification controller 97 as described above. This is presented by means of a Java interface which a class within the despooler implements to provide functionality.

public interface DeSpooler
{

| | |
|---|---|
| static DeSpooler createDeSpooler(EventList L); | |
| play( ); | |
| pause( ); | (4) |
| resume( ); | |
| destroy( ); | |

}

The methods provided by the interface shown above have the following functionality:
createDeSpooler( ) is a constructor function. It takes a pointer L which points to a file containing EventBase objects, and creates a despooler for that file.
play( ) synchronises the EventList offset to the current time and starts despooler's processing of the EventList.
pause( ) pauses the despooler.
resume( ) resumes despooling of an EventList file. This function adjusts the time offset by the time elapsed between calls to pause( ) and resume( ) to ensure that the event list and broadcast remain in synchronisation.
destroy( ) unloads the event list and terminates the despooler. When the end of an EventList file is reached the despooling stops automatically, without a call to destroy( ) being necessary.

The classification client therefore constructs a DeSpooler instance and uses methods provided therein to control the created object. The DeSpooler instance and its methods therefore implement the controller as described above.

The broadcast server 93 includes an operator server 100. This communicates with a database 101. The database 101 may be accessed by the classification clients 94 using the operator server 100 to allow operators to log into the system. Operators will log into a classification client. An administrator may use the operator server to allocate permissions to suitably qualified people so as to allow classification of various programmes.

The database 101 of the operator server 100 is a standard relational database. It contains programme and content information; event lists; operator details and schedule information.

All programme content will have entries in the programme or content tables of the operator database. Using these tables an classification client may obtain a Programme Identifier needed for ProgrammeStart Event transmission.

Administrative tools 102 are provided for maintenance of the operator server 100 and associated database 101. EventLists created for pre-recorded content are referenced from content tables. Schedule information stored in the operator server may be imported from an external source if appropriate.

Events transmitted to the broadcast server 93 using Java RMI in the form of EventBase objects must be broadcast to home users. This communication is managed by a VBI communication module 103. The VBI communication module is in communication with a datacast service 104 which transmits event data to home users having receivers 105.

Various information is transmitted to home receivers in addition to the event information described above. For example, icons to represent various events and schedule information is also transmitted from the broadcast serve to home receivers. Conveniently, this can be achieved by sending data at times of low usage, such as in the early hours of the morning.

Having described the architecture of a system suitable for the implementation of the present invention, an interface suitable for the home receiver is now described.

A first part of the user interface allows a user to define events which are of interest from a number of search/browse screens. Only programmes in the current EPG will be accessible, and selections made from these screens will have no direct impact on a profile defined for Event recording. This mechanism is similar to that found on conventional Personal Video Recorders (PVRs). However, broadcast Event data will be used to trigger recording of the programme. This means precise start and stop times will be used—even if a programme overruns or is re-scheduled, in contrast to the mechanisms provided by many conventional PVRs. An EPG will be broadcast regularly, according to bandwidth availability. The programme database will contain schedule information, and programme descriptions, taken from these EPG broadcasts, for at least two weeks.

A main menu presented to a user will provide an option titled “*Schedule Recordings*”. This will allow access to the scheduled programme set-up. From here the user will be able to search for specific programmes by genre, name, scheduled date/time or channel.

The user filters or searches for programmes and is presented with a listing. This will contain summary details of the programme (title, time, and a selected flag). This listing further includes UP and DOWN buttons to allow the user to navigate this list. A RIGHT button selects a particular entry and a detail screen is then displayed for the selected item. This detail screen will contain all EPG information for this programme, (and may include links to other programmes). From this screen the user may choose to “Record this programme”, or “Record all episodes of this programme”. The user may modify the priority of a schedule entry. A default priority for all scheduled programmes will be 5. This high value cannot be overridden by an Event profile entry. However, the user may choose to lower this value so that Event recordings may be triggered in the event of a programme clash.

The user may choose to modify the recording quality of this programme. The default value will be set as part of the “system set-up”. However, the user may choose to override this default value.

An ENTER button will toggle the “selected flag” for a selected programme, determining whether a programme is scheduled for recording.

A user may choose to filter (or sort) any programme listing by category. If the EPG format allows, these categories are linked to high-level Event categories used for profile programming. When a category filter is displayed for the first time it will default to including all categories a user has in their Event Profile. Subsequently, values set by the user will be used.

A user may also find a programme with a specific name. A text input control will allow the user to input part of a programme title and the resulting matches will be displayed in a pick list as described above.

Furthermore, a user may obtain a listing of programmes on a certain day. A category selection screen will be displayed as described above. The current day's schedule will be displayed. The user may change days using PGUP/PGDN, this will simply show a pick list described above for that day.

A further conventional recording mechanism is provided whereby a user may choose to schedule a recording manually. The User Interface will require entry of time, date, and channel (with suitable defaults). Additionally, a repeat option will be supported for daily, weekly, or days of week (e.g. Monday, Wednesday and Thursday).

The above description relates to the recording of complete programmes based upon broadcast distributed programme information. In addition however, the present invention enables the recording of individual events, in accordance with a user's preferences. This procedure will now be described.

The user is able to define a profile of Event categories that are of interest from a hierarchy of available categories. This will allow the specification of events down to a very fine level if required, although it is likely that initial use will be of very broad classifications. This can conveniently be provided by allowing a user to traverse a hierarchy of categories which corresponds to that used by the classifier.

An updateable classification hierarchy is held in each receiver. This must match that held on the Classification server, although it need not be precisely the same structure. Implementation is such that the event hierarchy may be changed in response to market demands.

Additionally, the profile set up interface may provide a “wizard” style interface such that a user can specify for example “I want to watch all tennis matches featuring Tim Henman”. Program code executed by the home receiver can take this statement and create a number of tuples as described above to determine which events should be recorded or viewed by the user.

The interface will also cater for more complex enquiries such as “I want to see only news items about tea plantations in India or coffee in Colombia”, by generating a suitable set of tuples which specify a more restricted set of event types.

A Subject Profile provides a simplified mechanism for expressing an interest in one or more Event classes using only a minimum of keystrokes. A subject profile selection screen will typically contain only part of a classification hierarchy, together with program code capable of mapping the profile to the hierarchy used by the classifier. The use of wildcards (e.g. “sport.soccer.*”) will improve profile size Here the “*” character is used to represent any value such that anything having a parent soccer and a grandparent sport will be found. Profiles are downloadable from a remote server. For example, a user may download a “Soccer lover's” profile and make any amendments necessary. This can significantly simplify and speed up the profile set up procedure.

In all of the circumstances described above, the profile is preferably specified using a hierarchical system, such that selections can be made at different levels of a hierarchy. For example a user may click “sport”, (using the “ENTER” button) and all sub-categories of sport will automatically be selected—this will result in a “bold” tick against the “sport” category. However, the user may then choose to descend the sport category (using the “RIGHT” button), and de-select individual sub-categories. If one or more items in a sub category are selected, then the parent category will show a “faint tick”. If all items in a sub category are selected, the parent category will show a “bold tick” When a user descends a level, as many of the parent levels as possible will still be displayed to provide context. Parent categories will always be distinguishable from sub categories. The user interface as described in similar to that used in many installation programmes for Windows® applications (such as Microsoft™ Office).

A beginners screen provides rapid access to “common” profiles. This both aids the user, and allows “market driven” profiles to be emphasised. This screen is driven entirely by a downloadable XML file which specifies the menu hierarchy. This screen will normally only contain one or two levels, so as to ensure that simplicity is not compromised.

Each menu item may link directly to a subject profile, or contain child menu items. The placing and relationships of these items is completely arbitrary, being specified by the XML file. This allows this screen to be driven by market, genre or any other relationship.

The beginners screen will allow the user only to select/deselect subject profiles. He may also set a priority level for each profile as illustrated in table 3 below:

TABLE 3
Options presented on “beginners screen”

| My Preferences | Priority | Selected |
|---|---|---|
| Arsenal Soccer Matches | 4 | √ |
| Other Soccer | 3 | √ |
| National News | | |
| Eastenders | 2 | √ |
| Other soaps | | |

It can be seen from the “selected” column of table 3 that the user has an interest in Soccer Matches involving the team Arsenal, Other Soccer and a soap opera entitled “Eastenders” (Eastenders is a proprietary trademark of the British Broadcasting Corporation). Furthermore, the priority column shows that Arsenal Matches are of highest priority with Other Soccer and Eastenders having lower priorities

Selecting the “other soccer” entry in the beginners screen allows specification at a lower lever, as illustrated in table 4:

TABLE 4
Options presented by descending “Other Soccer” in Table 3.

| Other Soccer | Priority | Selected |
|---|---|---|
| Chelsea Soccer Matches | 3 | √ |
| All Premier League Soccer Matches | | |
| Best goals and saves | 2 | √ |

Here it can be seen that the user has no interest in “All premier League” but does have an interest in “Chelsea Soccer Matches” (soccer matches involving the team Chelsea) which has higher priority than “Best goals and Saves”.

It has been mentioned above that the beginners screen is provided by an Extensible Markup Language (XML) file. An extract from an XML file equating to part of the example of tables 3 and 4 is shown in appendix 3.

Two <item> tags exist at the top level, defining the items Arsenal Soccer Matches and Other Soccer. The item Arsenal simply defines the category of the item as sports.soccer.*, and sets the parameter “team” to a value of “Arsenal”. The item is ended with a </item> tag. The Item “Other Soccer” contains three sub items (indented in a conventional way in the above code fragment). Each of these items comprises attributes having similar forms to those described for Arsenal Soccer Matches. It will be apparent to those skilled in the art that the attributes specified for each item may be varied in accordance with flexibility provided by the XML format.

The category attributes of the XML file of appendix 3 provide a link between the hierarchy used by the classifier to perform classification, and the higher level description of the beginners screen. The home receiver is able to generate a profile containing categories which equate to the selections made in the beginners screen.

An advanced screen allows the user to navigate the entire category hierarchy, and allows more control over selection of individual classes, priorities, ratings and attributes.

The user is provided with the same navigation methods as described above. However, he may provide additional filters to fine tune the profile, and has access to many more Event classes.

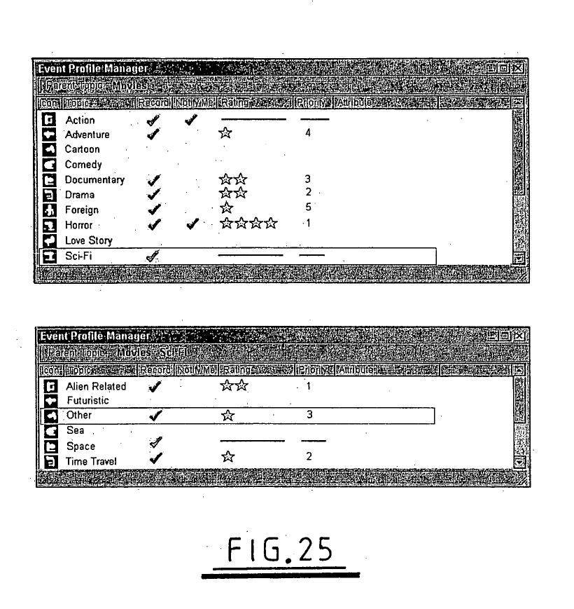

Referring now to FIG. 25, there is illustrated a graphical user interface for the advanced selection window. The top window of FIG. 25 shows a top level event classifications for movies comprising categories (shown as topics) such as action, adventure, cartoon, comedy and sci-fi. Each topic has an icon which is used throughout the receiver system to allow easy identification of the various topics. The window further comprises “record”, “notify me”, “rating”, “priority” and “attribute”. A “tick” in the “record” column, orders the system to capture the Event to disk, whilst a tick in the “Notify” column merely warns the user the Event is starting. The rating column contains a value comprising a number of stars. Each broadcast event has a rating, and only events having a rating equal to or greater than that in the rating column will be notified or recorded. The priority column defines the action when Events clash. Those with the highest priority will always be recorded in preference to lower priorities. In the case of two events with the same priority then the first to be broadcast is recorded. The Attribute column allows the user to define various “search filters”.

The lower window of FIG. 25 shows the sub-categories of the “Sci-Fi” topic. This window has the same structure as that defined above. It should be noted the rating values for topics within “Sci-fi” differ from 0-star to 2-star. Accordingly, the rating column for the sci-fi entry in the upper window contains a continuous line to indicate that sub topics have different rating values.

A summary of the current recording schedule may be viewed, and this is available from the main menu of the receiver system. This summary will display scheduled programmes, and should indicate what will be recorded automatically. This will be achieved by simply comparing the user's profile with the categories of scheduled events to determine what will be recorded. This mechanism will also indicate definite clashes (i.e. more than one scheduled programme at the same time), and also indicate possible clashes.

Having described the mechanism and interface by which a recording profile may be created, the recording process will now be described.

The use of buffering techniques to minimize the effect of event transmission latency has been described above. Features of this buffer, are now described in further detail. There are several causes of latency of event data ranging from classification operator reaction time, to temporary communications faults (e.g. electrical interference causing VBI packet loss). Any live broadcast will suffer from some lag (an event packet cannot be broadcast until the event has occurred—which is too late for recording to begin at the start of the event).

A local buffer will ensure that the start of events are rarely missed, by time shifting the recording by a few seconds. Events may therefore appear to a viewer a short time after they occur, but the contents of the buffer will ensure that any lead in to the event, and the event itself, is not missed.

Buffering will begin under a number of conditions:
1. Receipt of a PENP as described above.
1. EPG indication that a programme that is relevant to the user's profile.
2. An EventBase Object that may be relevant to the user's profile has been delivered.

If the system is already recording (or buffering) then no action is taken. Buffering is stopped when an event on the channel being buffered is received that indicates the chances of a future event match is low (e.g. a Programme event end packet).

The classification server will send out PENPs before the start of programmes. This will be based on a schedule and/or operator intervention. The PENP event will contain as much information about the upcoming event (usually a ProgrammeEvent) as possible. The recorder will pass the PENP through Event Matching logic (described below). If this logic indicates a match then the recorder will tune to the channel indicated and start capturing to a temporary storage area. This will be the usual method for commencing buffering.

Buffering can also be initiated by the EPG. Here, the recorder will scan the upcoming scheduled programmes. If any of these are in categories contained in the user profile then buffering of the relevant channel is started.

EventBase object initiated buffering provides a safety net for recording difficult to predict events. For example, the recorder may detect a sports event within a news programme, and decide to buffer if the user's profile contains any events in a sports category.

A user's profile is matched against incoming objects and detection of record or view requests is made. Even if capture has been requested, this does not guarantee recording of the event. If there is currently no capture in progress then the request is granted. If capture is ongoing and on the same channel as requested then the matcher should simply return “granted” as the stream is already being captured. This caters for the common case of nested events. However, if an ongoing event is being recorded on another channel then the system must check the relative priority levels for the event being recorded, and the level for the event that requested capture. If the level of the ongoing event is greater than or equal to the event requesting capture then capture is denied. Otherwise capture is granted.

If a match is found, capture takes place. Programme content will be captured to disk in the Moving Picture Experts Group-2 (MPEG-2) format. Those skilled in the art will appreciate that other data formats are equally applicable for data storage. Any event data is stored along with the content. The event data may later be searched for content of interest.

Event recording relies on two input channels. A first for event data sent from a classification server, and a second for programme content. The software expects event data to be broadcast using the VBI protocol and makes use of the Hauppauge PVR card for video capture and compression. Other devices may be used and both an abstract communications layer, and abstract multimedia layer are provided to increase flexibility.

The recording process can be described conceptually by three modules (although it will be appreciated that an implementation may not require three distinct modules): An event marshaller, a queue de-spooler, and a scheduler.

The scheduler is responsible for managing scheduled recordings. Received start packets will be placed into a temporary spool area by the event marshaller. Packets in this area will be sorted by start time of the event. Event data will generally never be broadcast more than a few seconds before the start time of the event, so this spool is considered transient.

Update and stop packets will be discarded immediately if a start packet with the corresponding ID does not exists either in the spool, or the Event Database. Update packets will “migrate” toward their start packet (either in the spool or the database).

Stop events are treated similarly (in which case the recording must be scheduled to stop), or the packet may be placed into the spool (sorted by actual stop time), and left for the de-spooler to process it (as described below). The marshaller may filter certain ControlEvents that are not time based.

While the current time is equal or greater than the oldest queued event the de-spooler will remove the oldest event packet from the queue.

A packet may be just a start packet, just a stop packet or could contain a full set of event data—this will depend on timing and implementation.

A start (or full) packet will be passed to the Event Matcher, and if a match is found, content from the buffer recorded at the time of the event start will be stored. If the buffer process is not active it must first be started, and content will be stored from the current time. If the matching logic indicates that capture was requested but not granted this event is not discarded. Instead the start time is updated to the near future, and the event is placed back in the queue. If this new start time equals or exceeds the end time of the event then the entire event will be discarded. This ensures that a short high priority recording will still allow the bulk of a longer low priority recording to take place.

If the event fails to match it will be discarded. A stop packet will first update the Event Database, then if there are no other open events capturing on this channel, capture will stop. The Clip Database will be updated with the new content.

The software is written so as to be as independent of the underlying platform as possible. The design takes into account the future incorporation of this product to PVRs. The receiver client will run on a high end PC. Tens of gigabytes of disc space will be required (one hour of recorded video equates to some 900 Mb of storage). A TV tuner and capture card are fitted to the PC. The Hauppauge PVR card is a suitable example.

The software is operable on any platform having a compatible video capture card and providing support for Java Standard Edition Version 2.

Software is also provided at each receiver to play back captured video. The Player software comprises two components—a Selector and a Player.

When a user chooses to view recordings, the Selector component is used to select the program/event to be viewed, whilst the Player loads the selected events. These components are described in further detail below.

In order for a user to play a video clip, the event(s) must be accessed using the Selector component. The user first selects a Recording Type from a menu comprising three options:
1. Unseen Recordings
2. Seen Recordings
3. All Recordings

Having chosen one of these three options, a further menu is displayed having two options:
1. Programmes
2. Events

If Programs is selected from the second menu, a window is displayed that presents to the user all recorded distributed programmes which comply with the criteria selected from the first menu option. If the user selects Events, then a window is displayed showing all recorded Events. Again this list is filtered in accordance with the first menu choice.

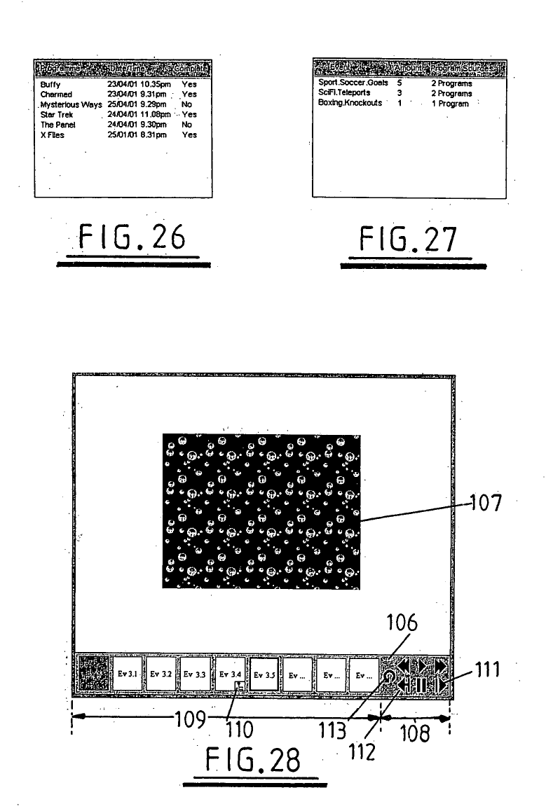

Referring now to FIG. 26, a Programme Selector Window is illustrated. This window displays the scheduled programs recorded by the Recorder. If a programme has several recordings (e.g.: a weekly series), then an entry exists in the list for each individual recording. Each entry contains a programme title, a date and time at which recording took place and a flag to provide an indication to the user of whether the whole programme was recorded or not. The user may sort the list by either Programme Title or the Date/Time at which it was recorded.

An Event Selector Window is illustrated in FIG. 27. This window displays the individual Events recorded by the Recorder. Multiple events having the same event type (e.g.: soccer goals), appear only once in the window, and an amount column is provided to indicate a number of occurrences of a particular event. A further column is provided to indicate how many different programmes have contributed to this total number of occurrences of a particular event.

When either the Program Selector window or the Event Selector Window is displayed, the user may select an entry whereupon a Player component is loaded. If a programme is selected, the sequence of events for that programme are delivered to the Player. If an Event Type is selected, the event type's related events are loaded and displayed as a sequence of events in the Player.

Once a selection has been made in the Selector window, that window is closed and the Player is loaded with the appropriate events. The Player consists of two main windows, which are illustrated in outline in FIG. 7 and have been described above. The use of two windows, one for a video clip and a second for controls allows program code relating to the controls to be isolated from the video-displaying code, thereby enabling easier code maintenance.

FIG. 28 shows the windows of FIG. 9 in greater detail. The Controller Bar window 106 is positioned below the Video Window 107. The Controller Bar may also be docked at the top of the Video Window 107 or in a floating state. When the Video Display is set to full-screen mode, the user has the option of hiding the Controller Bar so as not to obstruct the video.

The Controller Bar 106 comprises two sections, a Navigation bar 108 and an Event Bar 109. The Event Bar 109 consists of a row of events depicting the event classification for the video-display as was described with reference to FIG. 7, 8 and 9 above.

The event that is currently being played is shown with a highlighted border in the event bar 109. The user may play any event by selecting it with a single click. This highlights the border of the selected event icon, and the video clip will play that event.

Single-clicking on a highlighted event whilst its currently playing will cause the video clip to pause. A single-click will once again continue to play, creating a play/pause toggle with single-click actions.

The top-most level of events is shown by default in the Event Bar, as illustrated in FIG. 28. Events that are parents to a sequence of sub-events are recognized with a parent indicator icon to lower-right corner of the event icon. Event 3.4 contains such a parent indicator icon 110.

Double-clicking on a parent event (displaying the icon 110) will expand it to display its sub-events. When this is done, the following sequence of actions occurs
1. The current event bar 109 is cleared
2. The selected parent event is positioned to the far-left and coloured so as to indicate that it is a parent.
3. The event bar 109 is populated with the parent event's sub-events.

Moreover, any sub-events that can be further expanded are displayed with a parent indicator icon 110. Double-clicking on an expandable event drills down the event order. The user can traverse back up the order by double clicking on the coloured parent event on the far left.

Making an appropriate selection on an event (e.g. a right mouse button click) opens up the Event Context-Sensitive Window, displaying information and controls about that event. The window is presented to the user, showing the following information and options for the highlighted event:
1. View Properties
2. Ability to access the associated Action
3. Play the event
4. Expand the Event to view its sub-events
5. Delete the Event
6. Archive the Event
7. Keep the Event indefinitely
8. Perform an instant Replay

The navigation bar 108 comprises controls similar to those found on a conventional VCR that is play, fastforward, rewind and pause functionality is provided by buttons denoted by conventional icons.

The play button, in contrast to the Event-Play feature, plays through all events as a continuous stream. That is, it does not stop at the end of an event, only at the end of the video clip. The pause button acts as a conventional pause button—click once to pause, click again to resume. The fast forward button provides conventional functionality. Additionally clicking this button multiple times changes the speed at which it plays back:
1 click: plays at 2 times the speed
2 click: plays at 5 times the speed
3 click: plays at 10 times the speed

Further clicks will simply recycle the action back to that of the first click. To return the video clip speed to normal, the user must click on the play button.

The rewind button provides conventional functionality, with speed variance being provided in the same way as the fast forward button.

The navigation bar 108 comprises three further buttons. A slow advance button 111 causes the video clip to advance frame-by-frame at a slow speed, and an event restart button 112 causes the video clip to rewind to the beginning of the current event. An instant replay button 113 allows the user to replay a few seconds of the video clip. If the Event Bar is visible, then the instant-replay button 113 will not effect rewind beyond the beginning of the current event.

Making an appropriate selection in the video clip window 107 (e.g. a right mouse button click) opens up the Global Context-Sensitive Window, displaying information and controls about the video clip. The window presented to the user, contains the following options:
Ability to Show/Hide the Event Bar
Ability to Show/Hide the Navigation Control Bar
Ability to switch between windowed mode and full-screen mode
Ability to Show/Hide the Properties of the Program

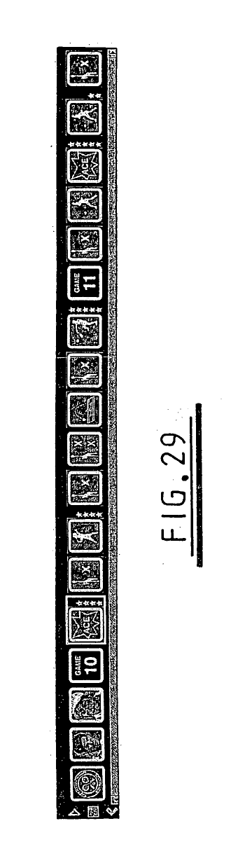

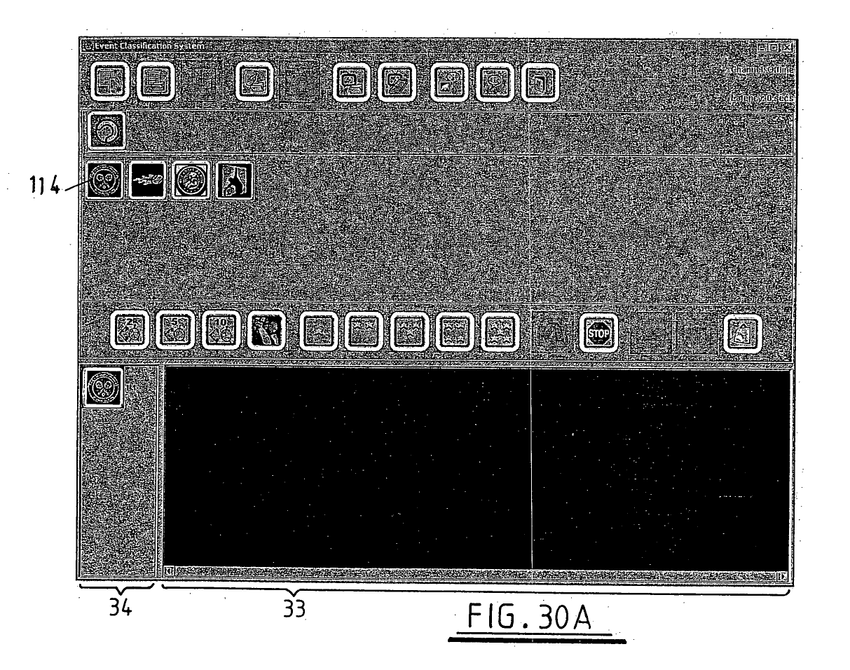

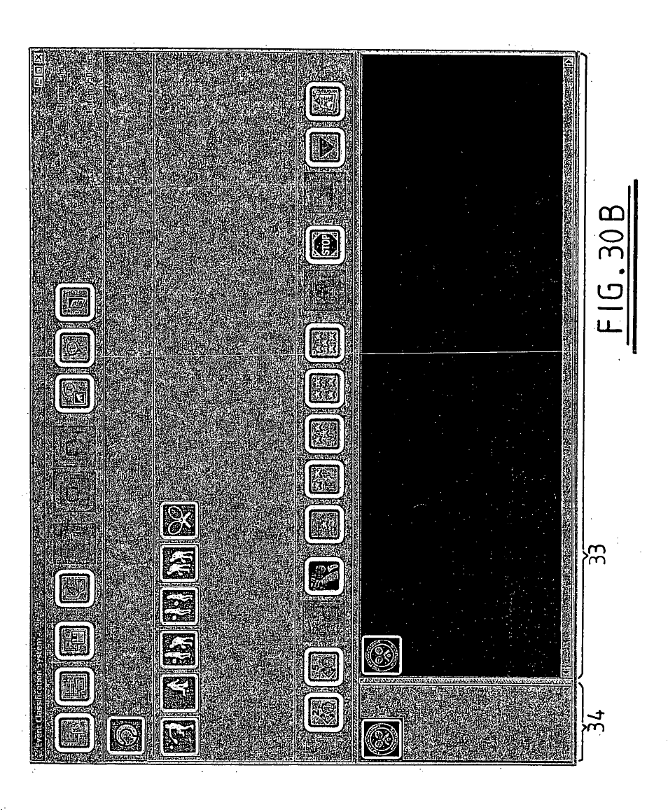

Referring back to the Wimbledon programme example described above with reference to FIGS. 14 to 17, FIG. 29 shows a series of icons which could appear in the event bar 109 of FIG. 28. In the embodiment of FIG. 29, all events are shown in a line, regardless of their hierarchical position. The event bar may be controlled in the manner described with reference to FIG. 28.

In the embodiments of the home receiver described above, it has been assumed that the hardware provided is capable of executing Java program code. If a home receiver is used which cannot execute Java, it may be necessary to provide code in a lower level language such as C or assembler to handle and process received data. It is preferable in such a case that the lower level code be configured so as to allow Java objects to be manipulated in higher level parts of the home receiver.

As an alternative to the home receiver described above, the player/recorder functionality of the invention may be implemented in a set top box for use with a conventional television and VCR

One suitable form for this set top box will be a VCRController placed in line between a terrestrial TV antenna and a VCR. The VCRController will automatically detect and process start and stop packets as described above and cause the VCR to act accordingly. The packets used by the system are carried in the vertical blanking interval (VBI) of a terrestrial television transmission. The VCRController may replace the profile creation and management features described above by requiring a user to contact a call centre to establish a profile, whereupon the established profile is downloaded to the VCRController, each VCRController having a unique address to facilitate this download. It may be desirable to add password protection to the profile set up and amendment functionality so as to prevent malicious tampering with a user's profile. A simple implementation of the VCRController may be limited to the recording to complete programmes, while more sophisticated embodiments may include functionality to record individual events as described above.

In order to keep cost to a minimum, the VCR-controller may replace the interface described above with a sequence of Light emitting diodes (LEDs) indicating the status of the system. The VCR-controller may also comprise a Liquid Crystal Display (LCD). The system comprises two LEDs (or one two colour LED) which can be used to indicate status thus:

| | |
|---|---|
| Slowly Blinking Red | I have not been set up |
| Steady Red | I have been set up but I have no profile |
| Steady Green | I have a profile and I am ready |
| Rapidly Blinking Green | I am downloading a profile |
| Slowly Blinking Green | I have recorded something |
| Rapidly Blinking Red | An error occurred receiving the profile |

The VCRController has no means of obtaining feedback from the VCR. Therefore, in order to enable recording there must be a write enabled tape with sufficient recording capacity in the VCR, and the VCR must be in a known power state.

When first installed, the VCRController must be set-up to control the user's existing VCR. As part of the process it is desirable that some test is performed to give feedback that set-up has been successful. The VCRController must learn how to initiate recordings and select channels. Three possible ways of achieving this set up are now described.

First, an approach using embedded control codes. The device contains a ‘magic library’ of VCR control codes. Basic VCR function codes are known for practically all makes and models, as all will appear in the ‘magic library’. To identify the VCR model the software tests a number of sequences and the user is asked to press OK when a predetermined operation (e.g. VCR is powered down) is successful.

This approach may require a number of cycles to complete, as it is difficult for the user to ‘hint’ at the correct codes. This approach can never be taught the user's channel selection arrangement—the assumption must always be that the user must always have the VCR's channel selection set up in a certain way. For example the VCR must be programmed such that channel 1 is local BBC1, channel 2 BBC2, etc. Most VCRs would normally be set up this way, but the user must change his VCR set-up if not so.

A second approach is a “learning” style approach. Here, the VCRController is configured by learning from the user's normal VCR handset. This requires additional hardware in the form of an IR receiver in the VCRController, causing extra cost.

The user presses a button to begin the learning process, then follows a predefined sequence of commands (button presses) on the remote control. The approach should be simple for the user and also means that channel selection can be automatically determined and accommodated.

A third approach involves a customer contacting a call centre. On purchasing the device the user contacts the call centre to register it. At this time he describes the VCR make and model and possibly also the channel configuration details, if these are non-standard. A library of VCR Control codes is available at the call centre. The VCR model information, or more likely the specific control codes, are then downloaded to the user's device from the call centre library using the VBI. While this option involves no additional hardware, cost is incurred in call-centre support time.

The selection of one of these three options will influence the user interface for the VCRController. If the second option is chosen, the user interface can consist of two buttons and a two-coloured LED. The two buttons are marked TEST and OK. Pressing both together initiates LEARN mode. Pressing TEST causes the controller to re-output a sequence to make a short recording—if this is successful the user can press OK to set the device into a ready state. The first Option has similar requirements. The user must put the device into learn mode, then indicate to it success (by pressing OK). The TEST button confirms successful set up as described above. The third option, involving a call centre only requires the Test facility.

The VCRController is equipped with two relay contact closure connections to control other devices. These are programmable to respond to certain event types received. User Profiles are broadcast and targeted to an individual VCRController through the VCRController address. A complete profile is always downloaded at a time. On starting reception of a profile the device will set an LED flashing rapidly (green) and set it back to continuous (green) on successful reception of a complete profile. The device can indicate a problem receiving the protocol by changing the LED to blinking red. Complete profiles are always sent, such that an existing profile is replaced rather than updated. Thus the user's profile must be held on the central server system having broadcast capability. Downloaded profiles (and set-up information) must be stored in non-volatile memory, e.g. flash ROM in the VCRController. Device activation/deactivation information may also be downloaded to allow control for subscription purposes.

A detailed description of packet reception as implemented by the VCRController is now presented. It is necessary to verify the integrity of the data by a checksum and/or sequence number. Ultimately, corrupted data will always be rejected but packets may be missing and may arrive out of order. This means events or event updates can be missed, although every attempt is made to reduce the possibility. Event data for use with the VCRController comprises a number of header/data sets. The header defines the field ID, type and length. Not all fields will be sent in each packet. Fields of use to this device are now described.

The ID value is unique to an event. It is present in every packet, and is used to marshal incoming data packets to the appropriate event data. The time this event started (or will start) is held in the packet and it should be noted that a start time may be in the future or in the past. The time this event will stop is also included along with a TV channel on which the event is occurring This may require a further look-up to convert a transmitted ID to an internal channel ID of the VCR.

The data packet further comprises a category or class name, defining the type and category of the event. The VCRController is only be interested in events of class “Programme”. These events have additional information which is matched against the user's profile. This information includes the unique Programme ID described above and a programme title.

The VCRController responds to Programme Start events, and matches to a user profile using transmitted Programme Title or Programme ID information. Programme names may include further ‘encoding’, For example, a soap opera entitled “Eastenders®” having several episodes each week may be encoded as follows:

| | |
|---|---|
| Eastenders 1 | (Monday's broadcast) |
| Eastenders 2 | (Tuesday's broadcast) |
| Eastenders 1R | (Repeat of Monday's broadcast) |
| Eastenders 3 | (Wednesday's broadcast) |
| Eastenders 4 | (Sunday Omnibus broadcast) |

The profile can specify which of these are to be recorded to eliminate duplication. In order to allow for slow VCR start-up times, the classification system will also send out Imminent Programme Start events for use by the VCRController. These contain all the same information as a real programme start but are marked as provisional and sent out before the actual programme start. The VCRController also responds to Time Set information for synchronisation and User Profile information.

Packet decoding as carried out by the VCRController will now be described An incoming event packet will be decoded. Any necessary checksum or other verification will be carried out. If the packet is corrupt it will be discarded. Event data will need to be stored for the duration of the event (i.e. until the event has completed) since update packets may be sent. The first task will be to extract the ID. If an event packet with this ID has already been received then the data in the incoming packet will be used to update the existing event (this may be a new start time or stop time, but will not change the class name.) If the field type is not relevant it may be discarded. These fields are used in PC based implementations as have been described above. If a packet with this ID has not yet been received then the new packet will almost certainly contain a valid classname and start time. If this is not the case, it may be that the packet has been lost, and all attempts should be made to store this data for a short period in case the missing packet is re-transmitted. The classname field is inspected and the event discarded if not relevant.

The VCRController's main function is to stop and start the VCR as appropriate. Incoming Programme events are compared against the user's list of programmes and programme titles. If a match is made the event is added to a “to do” list. The start times of events on the “to do” list are checked against the current time. When the current time reaches or passes a predefined offset before the event start time, the channel is selected and recording started. The offset will be preset in the device to, say, 30 seconds to allow time for the slowest VCRs to start up.

Profile information contains priorities associated with various profile settings. These can be specified by the user for each event type of interest. This priority can be used to help arbitrate where conflicts of recording occur. A higher priority match occurring will be allowed to interrupt and take precedence over a lower priority recording. Where an equal priority conflict occurs, the recording which started first is allowed to continue to completion, then the second event is considered for recording.

In the embodiment of the present described above, it has been explained that each event is represented by a MapEvent Object, with a category variable being used to represent an event's type. In an alternative embodiment of the present invention, each event is represented by a unique class. Referring back to FIG. 15, it can be seen that the TriggerEvent Class has sub-classes of MapEvent (described above) and TV. TV in turn has a sub-class of Sport. The class Sport in turn has sub-classes including “Tennis” and the hierarchy continues with classes for each of the nodes shown in FIGS. 12A and 12B (although these are not shown in FIG. 15). Thus each event shown in FIGS. 12A and 12B has an associated class.

The class hierarchy of FIG. 15 makes appropriate use of object-oriented inheritance such that generic properties which are common to events represented by the MapEvent class or the specific class structure, such as start time, end time and sequence number are specified in the TriggerEvent class, while more specific variables are specified in classes positioned at lower levels of the hierarchy. In the case of the MapEvent class, a generic (attribute, value) array can be used to store event specific information. In the case of the specific class hierarchy derived from the TV class, event specific attributes can be held in instance variables of appropriate type provided in the respective classes. Again, inheritance can be used such that if a particular attribute is applicable to all events represented by sub-classes of the Sport class, a suitable variable can be specified in the Sport class, and inherited by all sub-classes.

Providing a specific hierarchy where specific events are represented by specific classes can make the logic applied by home receivers simpler, as it is the class of the object that needs to be checked, not an internal category attribute. Furthermore, bandwidth requirements are minimally reduced because there is no need to transmit a category attribute. It is also advantageous that event specific attributes are stored in predetermined variables instead of being stored in a generic array. This can simplify the procedure of attribute matching. For example, if a user is interested in viewing all tennis matches featuring Tim Henman, use of a specific hierarchy in which a player array of two strings is specified in the tennis class can allow attribute matching using a specific instance of a Men's singles class M derived from the tennis class as follows:

for (i=0; i<2; i++)

if (equals (M.player[i], ”Tim Henman”))

MATCH( )

Where:
equals is the standard string equality function provided by the java.lang.String class, and
MATCH( ) is a function which is called to handle a match condition.

In contrast, where a generic array structure is used, it is necessary to traverse the entire attribute array until a pair beginning with the target player is found, whereupon a check can be made against the second element of the pair to determine whether or not a match exists. Typical code may be of the form:

for (i=0; i<n; i++)

if(equals (M.attribute[i][0], ”Player”))

if (equals (M.attribute[i][1], “Tim Henman”))

MATCH( )

where:
equals and MATCH( ) are as described above, and n is the length of the attribute array.

This can be considerably more time consuming than using the specific hierarchy described above. This is because n will typically be relatively large, and the first if statement must be evaluated for every attribute.

It will be appreciated that in an implementation of the present invention, “Tim Henman” will not be hard coded into the program code, but will instead by represented by a suitable variable.

A disadvantage of using a specific hierarchy arises in the case where new event types are defined, and it is then necessary to create Java code to define the corresponding objects. Therefore, in many embodiments of the present invention it may be appropriate to use the generic properties of the MapEvent class for events for which no class is defined together with the specific hierarchy where suitable objects are defined.

When describing the XML DTD of appendix 1, it was mentioned that palettes could be static or dynamic, and that although dynamic was the default setting in the XML DTD, the Wimbledon programme example used a static palette. The dynamic palette is now described.

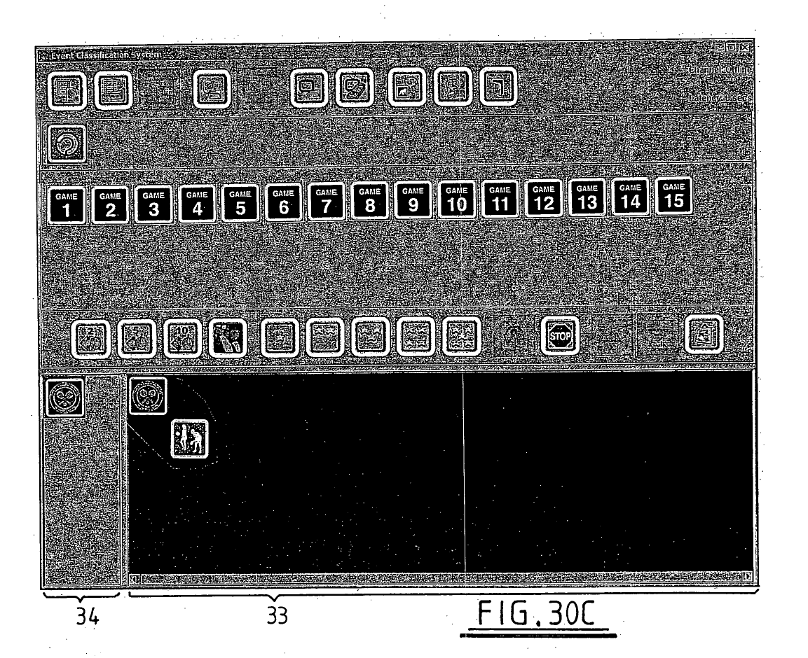

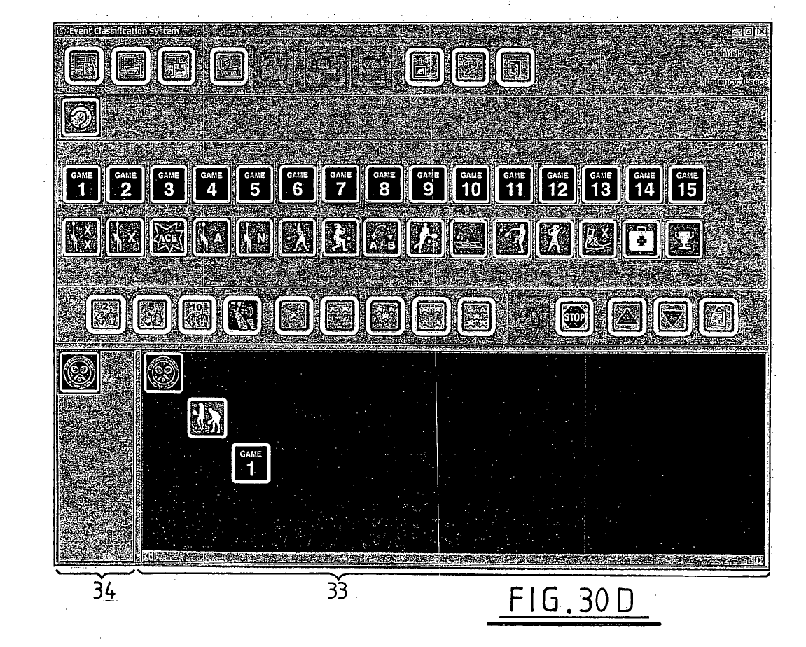

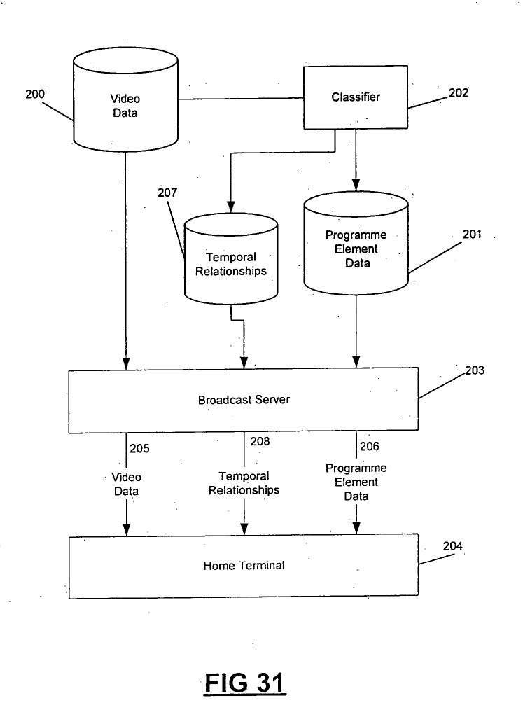

A dynamic palette is based upon the assumption that at any given time some event selections will be sensible and valid while some will be invalid. For example, in the Wimbledon programme described above, “Tennis” must be selected before selecting a particular action within a particular game. A dynamic palette displays only event buttons which can validly selected. An example of a dynamic palette suitable for use with the Wimbledon example presented above will now be described with reference to FIGS. 30A to 30D.

Having decided that a tennis match is to be classified, four event buttons are shown in FIG. 30A representing tennis championships. One of these buttons must be selected at the first stage of the classification, and no other events can be selected without first choosing a tennis championship event.

The Wimbledon event represented by an icon 114 is selected and is displayed in the history panel 33 as shown in FIG. 30B. The palette panel then changes to shown six icons representing different types of match event, as shown in FIG. 30B. One of these six icons must be selected at this stage of the classification. Selection of one of these events will result in a suitable icon being copied to the history panel 33 as shown in FIG. 30C. Additionally the palette panel changes to display a series of Game buttons numbered 1 to 15 as displayed in FIG. 30C. One of these game buttons must be selected at this stage. Selection of the “Game 1” icon results in a suitable icon being copied to the history panel 33 and a series of action buttons appearing in the palette panel. This is shown in FIG. 30D. It should be noted that the game buttons are still displayed, as after an undetermined number of actions have been selected, game events can again be validly selected.

The dynamic palette panel illustrated in FIGS. 30A to 30D can be generated automatically from the category information attached to each event. The dynamic panel ensures that events are classified in a sensible defined order, and minimises potential errors during classification, by only allowing a subset of events to be selected at any time.

In the system described above with reference to FIG. 10, it was described that the broadcast server 24 transmitted event data 23 in synchronisation with programme data 21 to the home terminal 25. However, in some embodiments of the present invention event data and programme data (also referred to as video data) are not transmitted in a synchronised manner. Instead means are provided to allow non-synchornised event data to be applied to video data. FIG. 31 illustrates a high level view of such an embodiment of the present invention.

It can be seen that the embodiment of the invention illustrated in FIG. 31 comprises video data 200 (equivalent to the programme data file 21 of FIG. 10), programme element data 201 (equivalent to the event data file 23 of FIG. 10) and a classifier 202 (equivalent to the classifier 22 of FIG. 10).

Video data 200 is classified using the classifier 202 to generate programme element data 201 in the manner described above. A broadcast server 203 transmits video data 200 to a home terminal 204 (denoted by an arrow 205), and also transmits programme element data 201 to the home terminal 204 (denoted by an arrow 206). In this embodiment of the present invention the broadcast server 203 does not ensure that the programme element data 201 and video data 200 are in synchronisation with one another. Instead, the two sets of data 200, 201 are transmitted independently of one another. Temporal relationship data 207 is generated by the classifier 202 and represents temporal relationships between the video data 200 and the programme element data 203. The temporal relationship data 207 is transmitted from the broadcast server 203 to the home terminal 204 (denoted by an arrow 208). Having received the data transmissions represented by the arrows 205, 206, 208 the home terminal can take the necessary action to correctly apply the transmitted programme element data 201 to the video data 200.

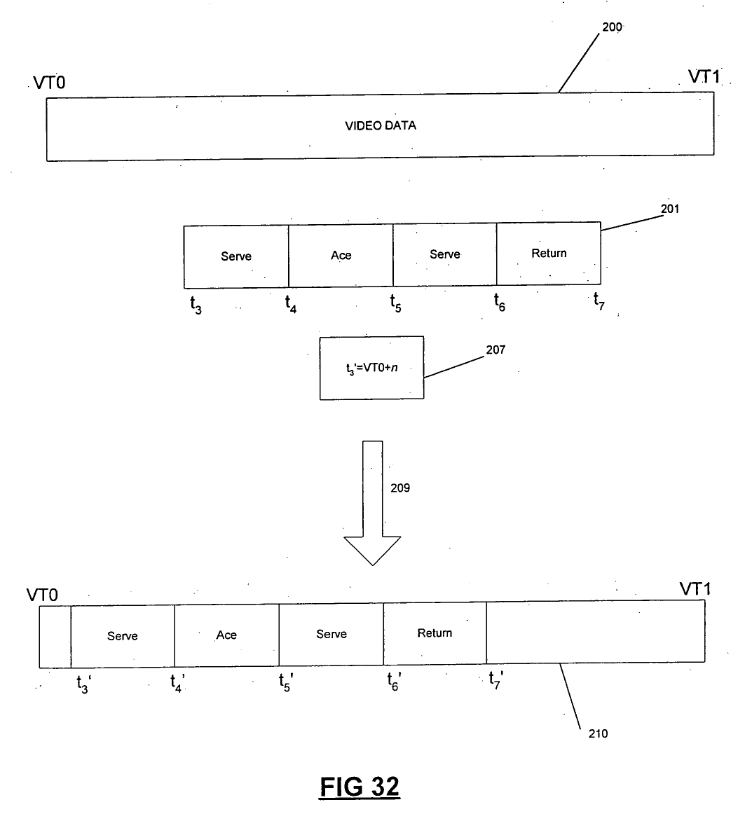

FIG. 32 schematically illustrates data received at the home terminal 204, following the data transmissions represented by the arrows 205, 206, 208 of FIG. 31. This data comprises video data 200 extending from a time VT0 to a time VT1, and programme element data 201. In the example illustrated in FIG. 32, the programme element data 201 comprises data defining four programme elements, which correspond to four of the programme elements illustrated in FIG. 18, relating to classification of a tennis broadcast. It can be seen that the programme element data 201 defines a first programme element representing a serve event extending from a time t₃ to a time t₄, a second programme element representing an ace event extending from the time t₄ to a time t₅, a third programme element representing another serve event extending from the time t₅ to a time t₆, and a fourth programme element representing a return event extending from the time t₆ to a time t₇. The programme element data 201 indicates an order for the four programme elements (the order illustrated in FIG. 32), and also a duration for each programme element (thus defining relative positions of the times t₃ to t₇). It should be noted that the programme element data 201 may comprise first programme element data temporally deferring programme elements, and second programme element data classifying the programme elements. The first and second programme element data may be separately transmitted.

Using only the video data 200 and the programme element data 201, the home terminal is unable to determine where the first programme element begins within the video data 200 given that the times t₃ to t₇ are relative timings of programme elements and do not directly relate to the stream of video data 200. This required information is provided by temporal relationship data 207. This data indicates a temporal position within the video data 200 (expressed relative to the start time VT0) at which the first programme element begins. For example, this data may be of the form:
t₃′=VT0+n
where:
VT0 is the time described above;
t₃′ is a time between VT0 and VT1 corresponding to the time t₃ at which the first programme element begins;
n is an offset expressed in the time units used to measure the difference between VT0 and VT1.

Thus, the data 207 allows the temporal position (t₃′) of the first programme element in the video data to be determined. Having determined the position t₃′, the positions of the boundaries between programme elements (t₄′, t₅′, t₆′, and t₇′) can then be computed from t₃′ and data contained within the programme element data 201 indicating the duration of each programme element. This results in the generation of a classified stream of video data 210, and is represented by an arrow 209 in FIG. 32.

The embodiment of the invention described with reference to FIGS. 31 and 32 is of particular value given that unclassified data can be transmitted to a user, and classification data can be subsequently transmitted for application to the previously transmitted video data. For example, classification data for popular television programmes could be transmitted to home terminals overnight, while bandwidth is readily available, and users could then use features of the present invention described above to enhance viewing of these programmes. In such embodiments of the present invention all video data could be stored until classification data is received, at which time a user profile (of the type described above) could then be used to selectively delete received video data so as to leave only data in which a user is interested.

When a live broadcast is classified, a classification operator may not know in advance all information needed for a full classification. For example, when classifying a football game, it may be desirable that a “Goal” event begins some time before the football enters the net, but until the ball has entered the net the operator cannot know that a goal has occurred. In some embodiments of the present invention, such classification is enabled by allowing a slight delay in live broadcasts such that appropriate classification codes can be added, and then transmitted in synchronisation with the video data. However in circumstances where it is undesirable to have such a delay, or indeed in circumstances where such a delay is impossible (e.g. where video data, and classification data are transmitted from separate transmitters as described below) the embodiment of the present invention described above allows classification data to be transmitted a short time after occurrence of the event to be classified, and be applied to the video data at a home terminal as described above.

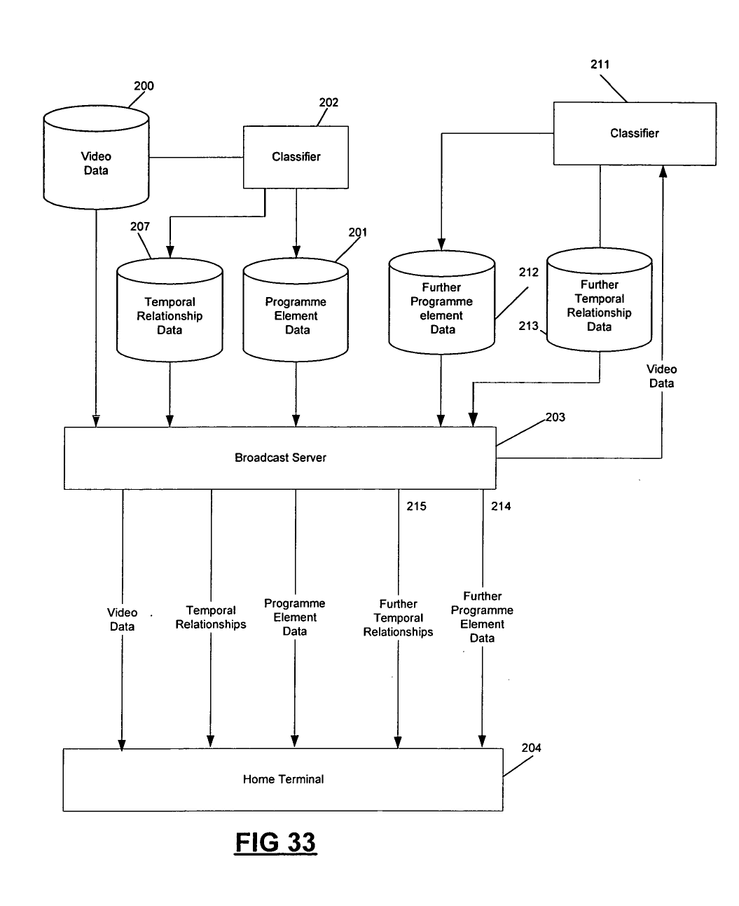

It was mentioned above that classification data can be broadcast from a transmitter different from that used for transmission of the video data. Embodiments of the present invention using such independent transmission are now described with reference to FIGS. 33 to 35. Referring first to FIG. 33, the video data 200 and programme element data 201 are transmitted using the broadcast server 203 in the manner described above, together with temporal relationship data 207. However, in the system of FIG. 33, the video data 200 is additionally broadcast by the broadcast server 203 to a further classifier 211. The further classifier 211 further classifies received video data to generate further programme element data 212, and further temporal relationship data 213. This further programme element data 212 and the further temporal relationship data 213 are then forwarded to the broadcast server 203 for onward transmission to the home terminal 204, as denoted by an arrow 214 representing transmission of the further programme element data, and an arrow 215 representing transmission of the further temporal relationships.

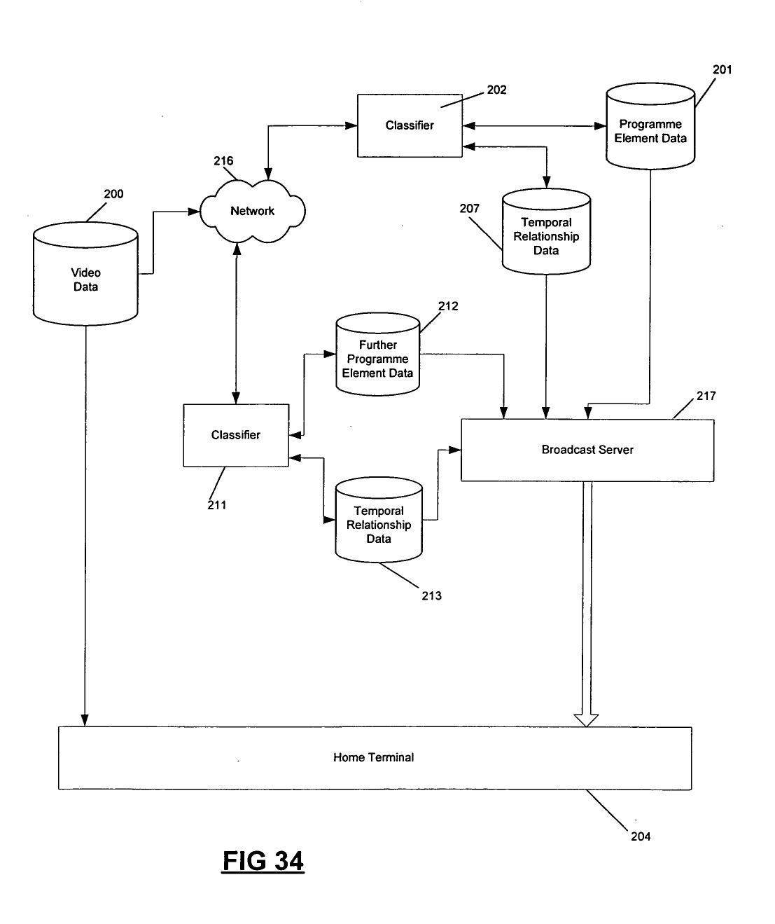

An alternative embodiment of the present invention is illustrated in FIG. 34. Here, the video data 200 is transmitted to the home terminal 204 in any convenient manner. This may involve a broadcast server of the type described above. Additionally, the video data 200 is made available via a computer network 216, for example the Internet. The classifiers 202, 211 described with reference to FIG. 33 are in this embodiment connected to the computer network 216. Again, the classifier 202 generates programme element data 201, and temporal relationship data 207. The classifier 211 generates further programme element data 212 and further temporal relationship data 213. The programme element data and the temporal relationship data generated by each of the classifiers is passed to a broadcast server 217, for onward transmission to the home terminal 204.

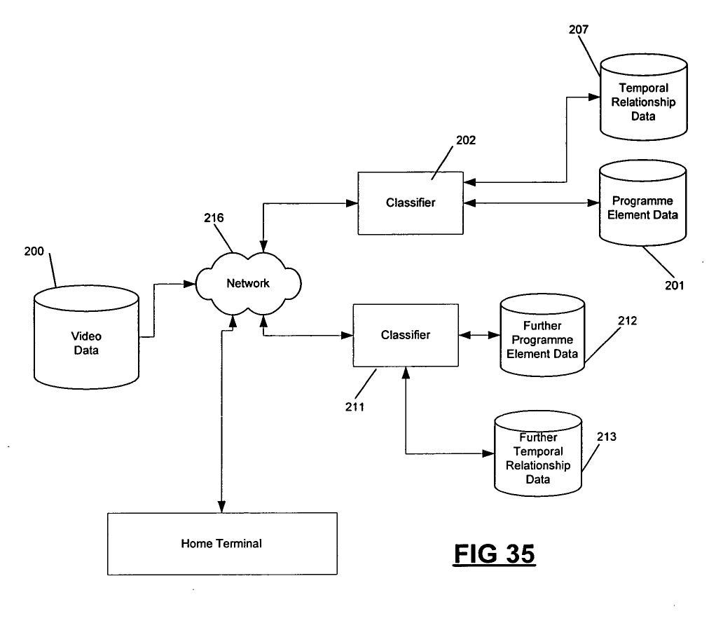

FIG. 35 illustrates an alternative embodiment of the invention. Here, all data transfer is carried out via the computer network 216, and data can therefore be broadcast directly to the home terminal 204 from each of the classifiers 202, 211, without an intervening broadcast server.

The embodiments of the present invention described with reference to FIGS. 33 to 37 can be implemented in a variety of ways. For example, the programme element data 201 may represent a temporal segmentation of the video data into events and also comprise classification data associated with the programme elements. The further programme element data can then comprise supplementary classification data. In yet alternative embodiments, the further classification data can refer to programme elements defined differently from the programme elements used in the programme element data.

The further programme element data can be generated with or without knowledge of the first programme element data. In the embodiments described with reference to FIGS. 33 to 35, it is described that both the programme element data 201 and the further programme element data 212 is transmitted such that it need not be synchronised with the video data 200, by using temporal relationship data 207, and further temporal relationship data 213. It will be appreciated that embodiments of the present invention using classification by a plurality of classifiers can operate using synchronisation in the manner described above for one or both classifiers. For example, the programme element data 201 may be transmitted in synchronisation with the video data 200 (thereby obviating the need for the temporal relationship data 207), while the further programme element data 212 can be transmitted together with the further temporal relationship data 213.

Classification using a plurality of classifiers has a number of valuable applications. For example, content based classification of the type described above can be applied by a broadcaster, and this classification can be represented using the programme element data 201. A party representing a particular celebrity or group of celebrities can then operate the classifier 211 to add classification data to the video data indicating appearances of the celebrity or celebrities who they represent. A home user can then indicate an interest in a particular celebrity, and all video data associated with that celebrity can therefore be presented to the user. Such a system is beneficial to a user as it allows them to obtain all video content associated with their favoured celebrity.

The system is also of considerable value to the celebrities, as is now described. It is acknowledged that television exposure of a celebrity to a target audience has an impact upon that celebrity's value in terms of advertising and promotional work. By allowing all video content associated with a particular celebrity to be easily identified fans can view all content of interest, therefore increasing the celebrity's exposure, and hence value.

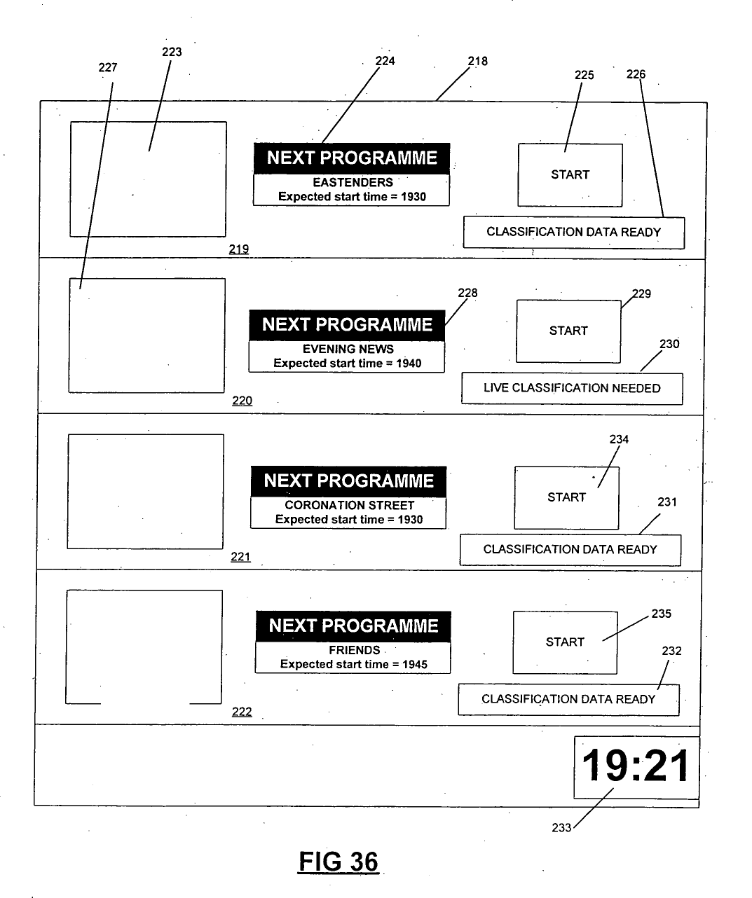

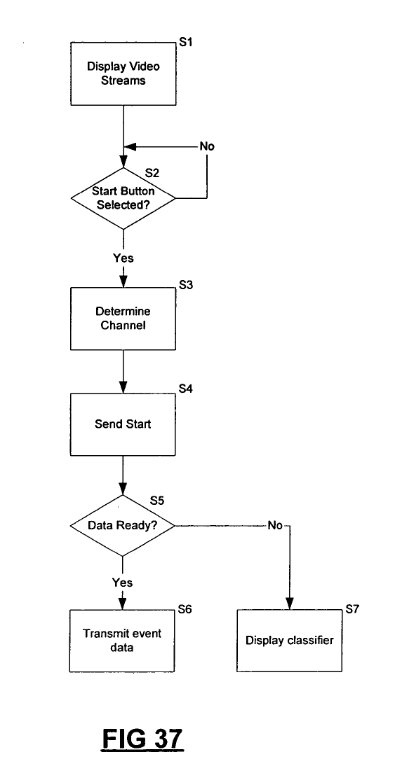

The present invention additionally provides a method for accurately transmitting start times of television programmes, as is now described with reference to FIGS. 36 and 37.

FIG. 36 shows a graphical user interface (GUI) 218 used for generating data which is transmitted to accurately indicate programme start times. The GUI 218 comprises four panels 219, 220, 221, 222, each panel relating to a particular television channel. Referring to the first panel 219, it can be seen to comprise an area 223 displaying video data being transmitted on a first channel. The first panel 219 additionally comprises an area 224 indicating a name and expected start time for the next programme to be broadcast on the first channel. The expected start time displayed in the area 224 is taken from schedule data which is provided to the system by any convenient means. In preferred embodiments of the invention this schedule data is read automatically from an electronic programme guide, but the schedule data could be input manually using a suitable input device. The first panel 219 additionally comprises a start button 225 which is selectable by a user using a suitable input device such as a mouse. Alternatively, where the GUI 218 is displayed via a touch screen, the button 225 may be selectable by touching an appropriate area of the screen either using a finger or a touch pen. The first panel 219 also comprises a status area 226 indicating whether classification data is stored and available for the next programme identified in the area 224. The next programme illustrated in the first panel 219, is the soap opera EastEnders. Given that this programme is pre-recorded, off-line classification has already been carried out, and stored in an appropriate data file as described above. This is reflected in the status area 226.

The second panel 220 again comprises an area 227 in which video data is displayed, an area 228 providing details of the next programme, a start button 229 and a status area 230. In the case of the second panel 220, the next programme is a news programme which is broadcast live, accordingly, the status area 230 shows that live classification of the video data is required in this case.

The third panel 221 and the fourth panel 222 comprise elements corresponding to those of the first panel 219. In the case of each of these panels the next programme is pre-recorded, and accordingly a status area 231 of the second panel and a status area 232 of the third panel both show that classification data is ready for transmission. The GUI 218 also includes a clock 233 displaying current time to a user for ease of reference.

FIG. 37 is a flow chart processing carried out via the GUI 218. At step S1 video data for each channel is displayed using the GUI 218 as described above. At step S2 a loop is established until one of the start buttons 225, 229, 234, 235 is selected. When a button is selected, the loop ends, and at step S3 it is determined which start button has been selected. A start event is then transmitted to home terminals at step S4 using techniques as described above. Thus, the described processing allows a home user to know accurately when a programme is actually being transmitted, not an estimate of such a time as presented by a traditional television schedule. A received start event can either simply alert a user that a programme in which interest has been expressed is about to begin, or alternatively can trigger recording. In some embodiments of the invention processing can end at this point, and such embodiments do not involve transmitting classification data, but simply involve transmission of start event data.

In embodiments in which classification data is to be transmitted, at step S5, the process determines whether classification is ready for transmission. If data is ready, (as in the case of the next programmes shown in the first panel 219, the third panel 221 and the fourth panel 222 of the GUI 218), then a broadcast server can attend to transmission of classification data at step S6. This can either be done by synchronising classification data with the programme data, or alternatively by sending the classification data independently and additionally providing temporal relationship data as described above.

If however classification data is not ready (as in the case of the news programme shown in the second panel 220), a classifier GUI is displayed to allow classification to be effected at step S7.

It will be appreciated that the GUI 218 conveniently allows a single operator to transmit start events on a plurality of channels, and classify only where required. When all classification is carried out in an offline manner, a single user can accurately transmit start data (which can be used to apply classification data) for a plurality of channels concurrently.

Use of the GUI 218 is now described. At 1921 hrs an operator is presented with the GUI 218 as illustrated in FIG. 36. On reviewing the next programme areas of the panels 219, 220, 221, 222 of the GUI, the user can determine that activity is next expected on programmes displayed in the first panel 219 and the third panel 221 both of which start at 1930 hrs. At the appropriate start time the operator selects the start buttons 225, 234 to transmit a start event and any classification data. After depressing the start buttons, the next programme expected to begin is the news programme referred to in the second panel 220. When this programme begins, the start button 229 is selected, and an appropriate classifier (as described above) is displayed to the operator, and the news programme is classified in real time.

However, it can be noted that the programme referred to in the fourth panel 222 begins at 1945 hrs, and therefore the fourth panel is displayed to the user concurrently with the classifier. The operator can therefore concurrently classify the news programme, while waiting for start of the programme of the fourth panel 222. When The programme of the fourth panel 222 does begin the operator need make only a single selection of the start button 235, and classification of the news programme is accordingly not substantially interrupted.

As described above, an advertisement or other message programme element may be linked to a particular event represented by one or more programme elements, such that presentation of the one or more programme elements results in presentation of the message programme element.

The link between a programme element and a message programme element can be determined by the generator of the message programme element. For example, where the message programme element is an advertisement an advertiser can select a programme element classification code or codes with which their advertising matter is to be associated.

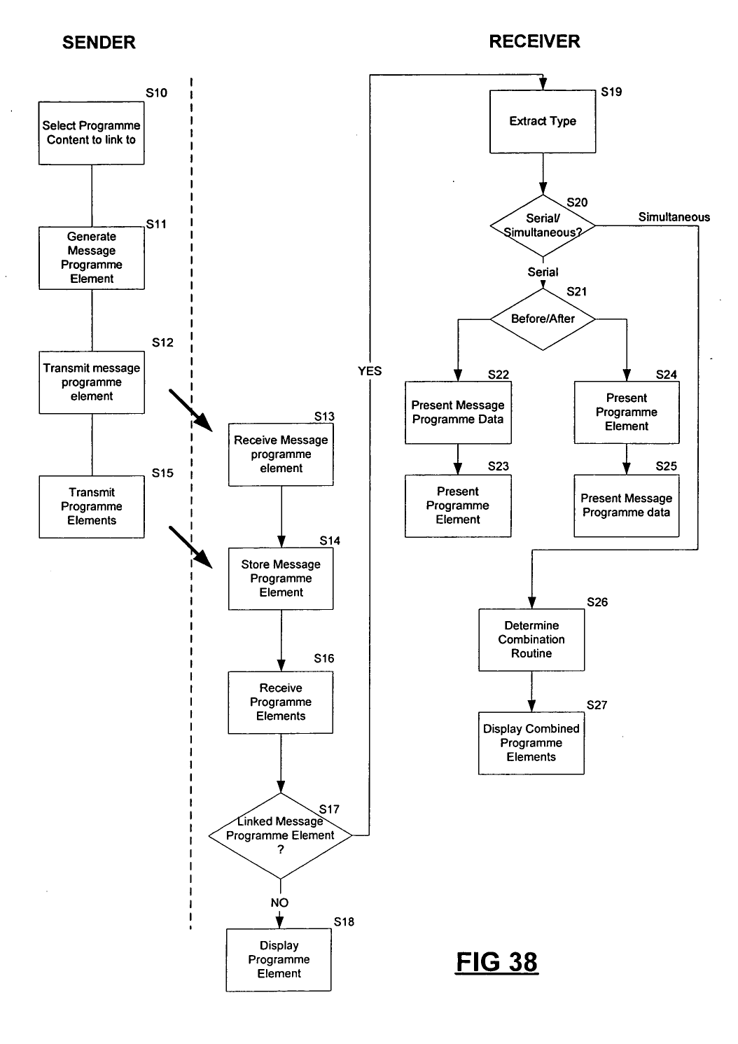

FIG. 38 is a flowchart of a process for linking advertisement messages to particular programme elements. At step S10 an advertiser selects one or more programme element classification codes which are used to classify programme content with which it desires to associate its advertising material. This selection made can be in different ways such as by using a menu structure or using a GUI which presents appropriate icons. If a hierarchy of classification codes is used, as illustrated for example in FIG. 21, an advertiser may wish to associate its advertisement with a particular class, and its sub-classes. For example, an advertiser may wish to specify all News programme elements (including programme elements classified using sub-classes of the news class). Alternatively, it may be desirable to specify only a particular class (not its sub-classes).

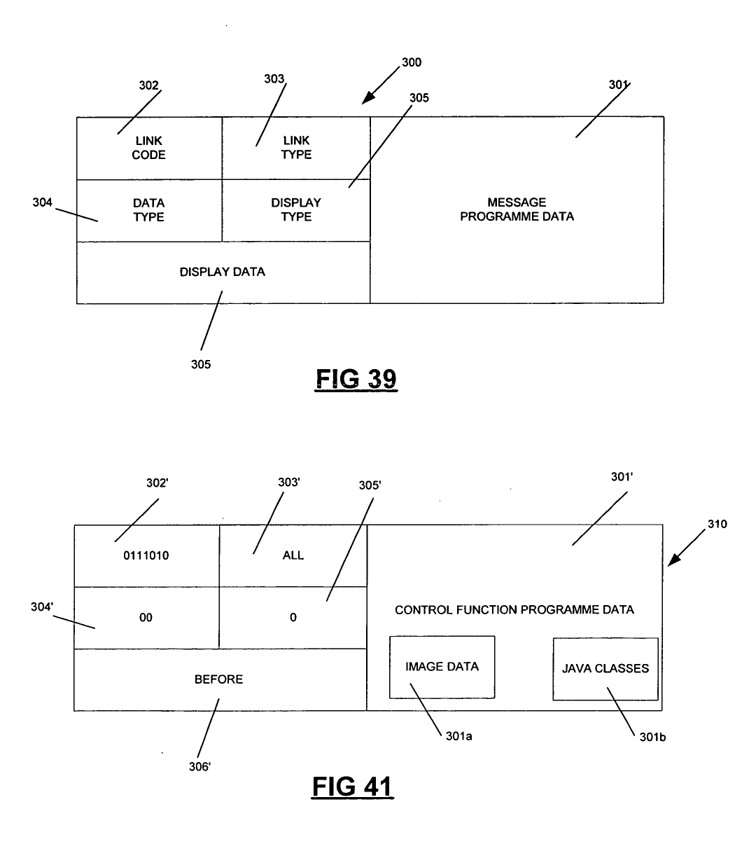

Having determined the programme element classification code or codes with which the message programme element is to be linked, at step S11 a message programme element is generated. An example of a message programme element 300 is illustrated in FIG. 39. It can be seen that the message programme element 300 comprises message programme data 301. This message programme data represents that which is to be presented to a user. Typically, the message programme data 301 is video data, however it will be appreciated that the message programme data can be audio data or a still image. In order to generate the message programme element, the message programme data 301 is read from an appropriate data source in a conventional manner.

The message programme element 300 also comprises a link code field 302 indicating one or more programme classification code which are used to classify programme elements to which the message programme element is to be linked. As discussed above, in the case of a hierarchical classification scheme, a message programme element may be displayed for all occurrences of a particular class, including occurrences of sub-classes. A link type data field 303 is used to indicate whether the message programme element should be presented only in response to programme elements associated with one of the classification codes specified in the link data 302, or whether sub-classes of the specified classification codes should also trigger presentation of the message programme data 301.

The message programme element 300 further comprises a data type field 304 which indicates a data type of the message programme data 301. For example, in a system in which message programme data can be video data, audio data or a still image, the data type may be a two-bit binary number set as follows:
01 Video
10 Audio
11 Still Image

A display type field 305 indicates how the message programme data 301 is to be presented. For example, as discussed above, the message programme data 301 can in general either be presented simultaneously with its linked programme element or serially with the linked programme element. In an embodiment of the invention in which the message data is presented either serially or simultaneously, the display type field can contain a single bit of data, set as follows:
1 Simultaneous
0 Serial

Where serial presentation is used, a display data field 306 simply indicates whether the message programme data 301 should be presented before or after its linked programme element. Where simultaneous presentation is used, the display data field 306 indicates how simultaneous presentation should be effected, possibly by means of computer program code which can be executed by a receiver receiving the message programme element. This is discussed in further detail below.

Referring back to FIG. 38, having generated a message programme element as illustrated in FIG. 39 at step S11, the message programme element is transmitted to a user at step S12. When message programme elements represent advertising material, they can be transmitted in batches during times at which network traffic is low (e.g overnight). A message programme element is received by a receiver at step S13 and stored on an appropriate storage device at step S14. In preferred embodiments of the invention message programme elements are stored at a receiver on a hard disk drive or similar non-volatile digital storage device, however it will be appreciated that other storage devices can be used. Thus, one or more message programme elements are stored at the receiver, ready for display when triggered by presentation of a programme element having a classification code matching a code included in the link data field 306, as described below.

At step S15 a transmitter transmits a programme element together with its associated classification code to the receiver. The classification code can be transmitted in any of the ways described above, or in any other suitable way. On receiving a programme element at step S16, the receiver then searches for any stored message programme elements having data in their link code field 302 (FIG. 39) which matches the classification code associated with the received programme element at step S17. Data in the link type field 303 is also used to ensure that programme elements classified using sub-classes of a specified class are included if desired. If no matching message programme element is found, the received programme element is displayed at step S18. If a matching message programme element is found, processing continues at step S19, where data from the data type field 304 and display type field 305 is extracted from the located message programme element.

At step S20, the display type field is analysed to determine whether the message programme data is to be presented serially or simultaneously with regard to its linked programme element. If it is determined that the message programme data is to be presented serially with respect to its linked programme element, processing passes to step S21, where the display data field is interrogated to determine whether the message programme data should be presented before or after its linked programme element. If the message programme data is to be presented before its linked programme element, the message programme data is presented at step S22 and the linked programme element is displayed at step S23. Alternatively, if the message programme data is to be presented after its linked programme element the linked programme element is presented at step S24 and the message programme data is presented at step S25. If however step S20 determines that the message programme data is to be presented simultaneously with the linked programme element, execution passes to step S26 where a combination routine is determined (described in further detail below) and the combined programme elements are displayed at step S27.

Methods for simultaneous display of message programme data and associated programme elements are now described. If the message programme data is a still image the still image may simply be superimposed upon an appropriate part of the display screen. For example, if the message programme data comprises an advertiser's banner, the display data 306 may instruct the set top box to superimpose the still image across a small part of the display screen for a period of time. Alternatively, the display data 306 may instruct the set top box to display the still image on a first part of the display screen, while displaying the programme element on a second different part of the display screen. In the case of a still image, a relatively small number of different display routines may be pre-stored at a receiver, and one of these routines selected using an identifier specified in the display data field 306.

Where the message programme data is video data, and it is desired to display the message programme data simultaneously with its linked programme element, this can again be achieved by segmenting the display screen and displaying message programme data in a first area and the programme element in a second area. However, in order to enhance the impact of the message programme element, the two streams of video data may be combined. For example, in the case of a football match, a particular message programme element may be associated with goal events. In such circumstances the message programme element may be combined with the programme element representing the goal event to generate video data which is used during an action replay. This may result, for example, in the ball being replaced by a product, logo or name associated with an advertiser, thereby providing high exposure to the advertiser during the action replay, and enhancing the impact of the advertising material. Where combination of two streams of video data is required, the display data 306 within the message programme element can comprise computer programme code specific to the particular message programme data, indicating how the combination should be effected. The generation of such code will draw upon conventional computer graphics and image processing techniques, which are not described in further detail here, such techniques will however be readily apparent to one of ordinary skill in the art.

Linking advertisements to particular programme element classification codes in the manner described above provides a powerful method of targeted advertising. For example, a broadcaster can sell an advertising opportunity related to all five-star events within a soccer game, such that these programme elements appear together with an advertiser's message. Such advertising is attractive to advertisers, as it not only allows them to target a particular audience (people who enjoy soccer) but also to associate themselves only with interesting or high quality events within a soccer match.

In some embodiments of the invention a classification hierarchy may be used which includes events such as “victory” events within sporting programmes, such that an advertisers message appears alongside all victory events, regardless of the particular sport. Purchasing an advertising opportunity related to all victory events is attractive to an advertiser, given that their advertising material will be presented together with events indicative of success, thereby creating a mental link between the advertiser and success in the mind of a user.

Where advertising material is to be presented serially with respect to a linked programme element, this can be achieved by incorporating the advertising material into an assembled programme of the type described above. Alternatively, when the invention is used in a conventional broadcast system comprising distributed programmes arranged in a schedule and separated and interrupted by commercial breaks, the inclusion of an appropriate programme element within a distributed programme may result in display of the advertising material in an adjacent commercial break. For example, a distributed programme may comprise a plurality of programme elements each classified using a classification code, and commercial breaks can be populated with material selected by advertisers who link their advertising material to these classification codes.

It has been described above that a plurality of different parties may apply classification codes to programme elements. In the context of advertising this allows a broadcaster to apply content-based classification codes in the manner described above, and an advertiser to apply codes relating to the appearance of a particular theme or product within a programme element, the advertiser's code triggering display of an appropriate message programme element. Where classification is carried out as an off-line process, both sets of classification data can be transmitted in synchronisation with the programme data as described above. However, even where a programme is classified substantially in real-time and classification codes are distributed later (as described above), an advertiser may still benefit, as the appropriate message programme element can be included within temporarily close a commercial break in programming, as described above.

Although embodiments of the invention have been described above in the context of associating advertisements with programme content, it will be appreciated that the present invention can similarly be used to enable the display of other message programme elements. For example, some programme element content may need to be preceded by a warning indicating that it is suitable only for viewers over a particular age due to content of a violent or sexual nature. In such circumstances appropriate warning messages can be stored at a receiver for display either before or simultaneously with programme elements which require the display of the warning to the user.

The use of message programme elements can also be used to enhance the effect of programme element content. For example, all programme elements associated with a particular geographic location may be automatically combined with one or more message programme elements for display to the user, the message programme element providing additional information. This is advantageous in systems in which programme data is provided via a relatively low-bandwidth channel, given that stored information is combined with received information, thereby reducing the quantity of data which needs to be transmitted across the relatively low-bandwidth channel.

It has been described above with reference to FIG. 22 that programme elements can have an associated Java Applet, the Java Applet comprising one or more Java classes. The Java Applet adds functionality to the programme element with which it is associated. The use of Java Applets has particularly powerful implications for message programme elements. For example, a message programme element (also, in this context, referred to as a control function programme element) may be associated with content to which it is desired to control access. When a programme element including such content is to be displayed, the control function programme element is presented to the user, and the content is presented only when an appropriate user input has been received. Embodiments of the present invention which use such control function programme elements are now described.

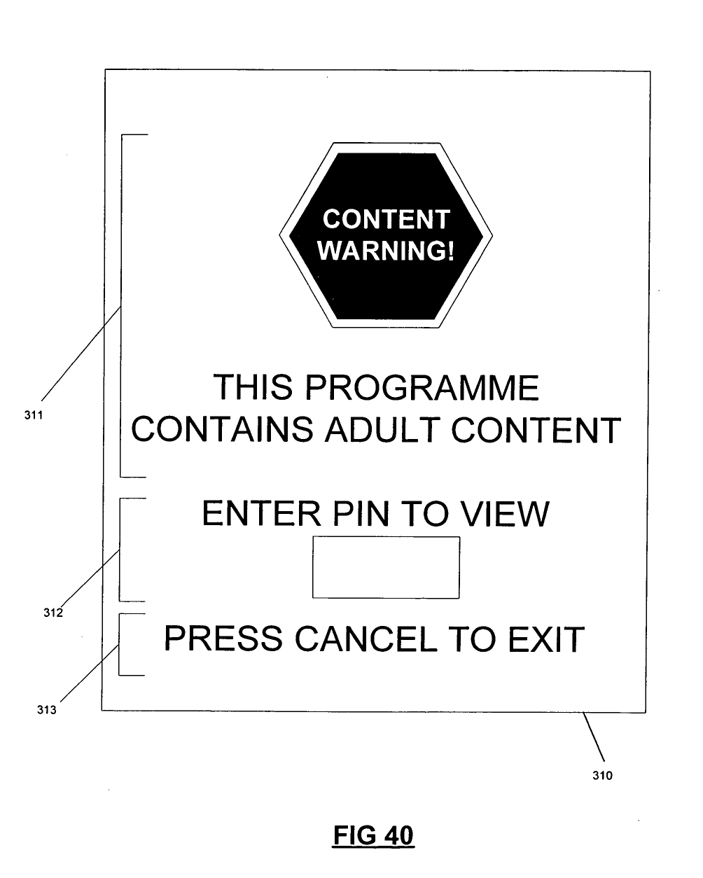

FIG. 40 illustrates a control function programme element 310 displayed to a user in embodiments of the invention in which access to adult content is to be controlled. The control programme element 310 comprises a warning message 311, and text 312 indicating that a user may press cancel to exit, and return to that which was displayed previously. If the user is to gain access to the controlled programme content a personal identification number (PIN) must be entered in an area 313.

FIG. 41 is a schematic illustration of the control function programme element 310. It can be seen that this conforms to the general message programme element format illustrated in FIG. 39. It can be seem that the control function programme element 310 comprises a link code field 302′ which indicates a classification code which triggers display of the control function programme element. In this case, the code 0111010 is a parent class for all classes used to classify adult content. The value “ALL” in the link type field 303′ indicates that both the specified class and its subclasses should trigger display of the control function programme element. The data type field 304′ is set to 00 which is a value not included in the list presented above. In this embodiment of the invention, the data type value 00 is used to indicate a control function programme element. The display type field 305‘is set to ’0′ to indicate serial display relative to the linked programme element, and the display data field 306′ is set to “BEFORE” as the control function programme element 310 needs to be displayed before its associated programme element.

The field 301′ contains the control function programme data. This is made up of image data 301a which defines the text and images which are displayed, and Java classes 301b which define functionality of the control function programme element.

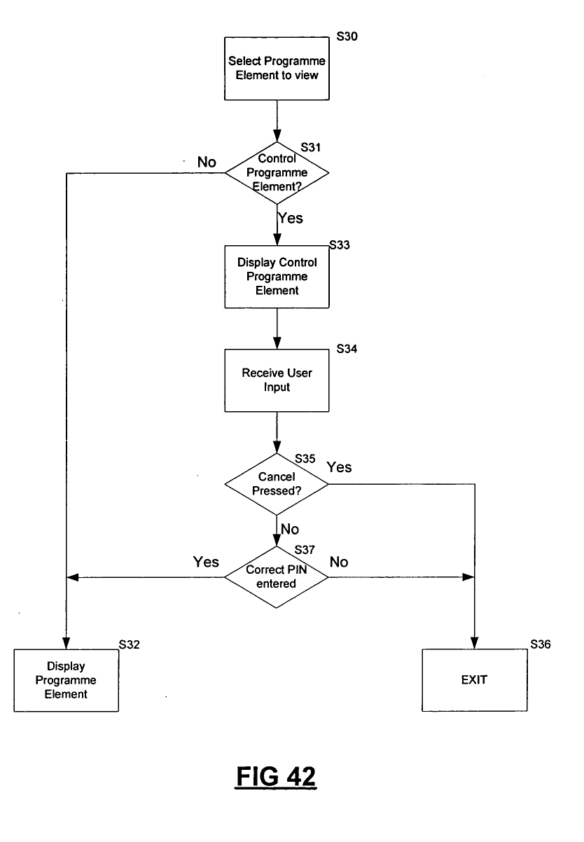

FIG. 42 is a flow chart showing display of the control function programme element 310 and its use in controlling access to programme content. At step S30 a programme element is selected for viewing. This programme element can be selected automatically, or in response to a user selection using for example icons, or on the basis of a user profile. Having selected a programme element, at step S31 a check is made to determine whether the control function programme element 310 is associated with the selected programme element. This check is carried out in the manner described above with reference to FIG. 39, by comparing the programme element classification code of the programme element to be displayed with that specified in the link code field 302′. In the example of FIG. 41, given that the link type field 303′ is set to “ALL” sub classes of the classification code specified in the link code field 302′ also trigger display of the classification code.

If a control function programme element is not located at step S31, the selected programme element is simply displayed at step S32. If the control function programme element 301 matches the classification code of the programme element, the control function programme element is displayed at step S33. As illustrated in FIG. 40 the control function programme element 310 prompts the user either to press cancel or to enter a PIN as shown in FIG. 40. User input is received at step S34, and step S35 determines whether or not this input consisted of a user pressing cancel on a suitable input device, such as a remote control handset. If cancel was pressed, the process exits at step S36, and the system returns to that which was pbeing presented previously. If the user input received at step S35 comprised a PIN, step S37 determines whether the entered PIN correctly matches that stored. If the PIN is correct the programme element is displayed at step S32, while if the PIN is incorrect, the process exits at step S36. The PIN is typically input using an appropriate input device such as a remote control handset or keyboard.

In preferred embodiments of the present invention if an incorrect PIN is entered, a user is provided with a predetermined number of opportunities to re-enter the PIN before the system exits. It will be appreciated that user input processing and PIN verification is carried out by methods within the Java classes 301b, using computer programming techniques well known in the art.

The use of control function programme elements as described above with reference to FIGS. 40 to 42 is useful in ensuring that only adult users are able to view programme elements which contain particular types of content. For example, it may be desired to ensure that children are prevented from viewing programme elements which are of a violent or sexual nature.

In some cases a user may wish to amend which programme elements trigger display of a particular control function programme element. This can be achieved by providing appropriate data within the events profile 80 of the home viewer suite section 76 (FIG. 23). Generally the control function programme element 310 is provided to the user, with default programme element classification codes specified in the field 302. The user can then use home viewer suite section to specify additional or alternative programme element classification codes with which the control function programme element is to be associated. FIG. 43 illustrates parts of a GUI suitable for specifying such associations.

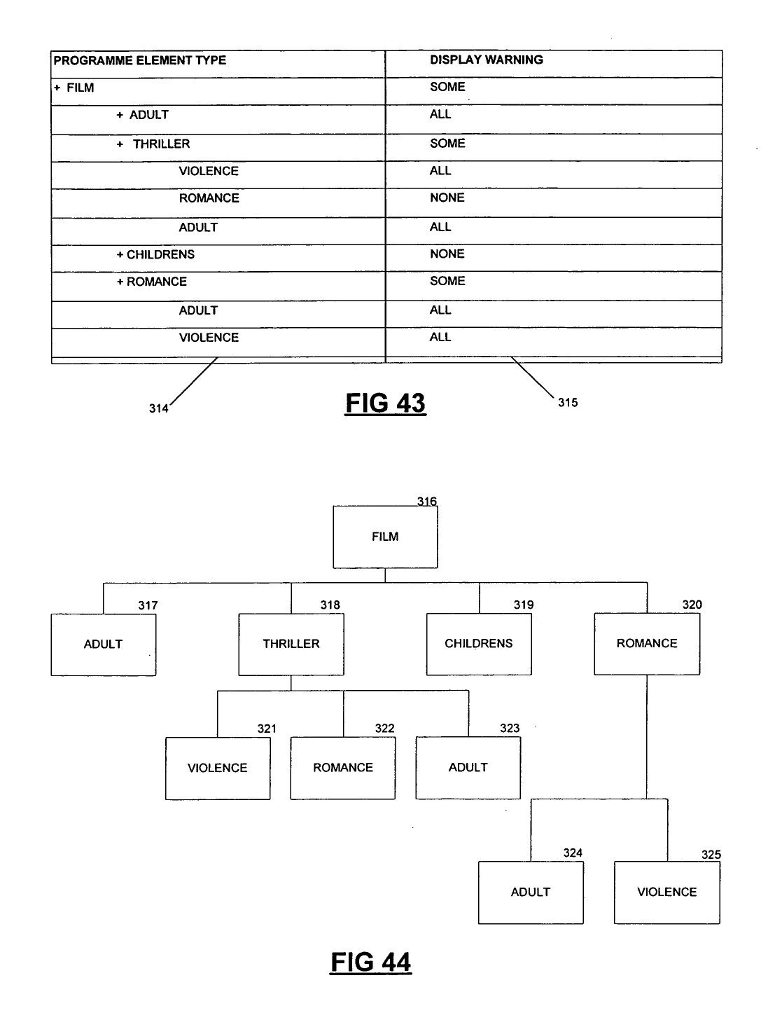

The GUI of FIG. 43 comprises two columns 314, 315. A first column 314 defines part of a classification hierarchy used to classify films. The illustrated hierarchy is graphically depicted in FIG. 44. It can be seen that a film class 316 has subclasses of adult 317, thriller 318, childrens 319, and romance 320. The thriller class 318 in turn has sub-classes of violence 321, romance 322 and adult 323. The romance class 320 has sub-classes of adult 324 and violence 325.

A second column 315 indicates whether or not the programme elements classified using each class should trigger display of the control function programme element 310. Thus, it can be seen that all adult content and violent content does trigger display of the control function programme element, while display of relatively benign cotent such as childrens content does not trigger display of the control function programme element. By modifying data using the GUI of FIG. 43 a user can conveniently configure when the warning message should be displayed. For example, a user having young children is likely to want to use the control function programme element 310 more frequently than a user living in a household of adults where the control function programme element 310 may never need to be displayed. It will be appreciated that the GUI of FIG. 43 allows triggers to be specified at all hierarchical levels. That is a user may specify a trigger class, and all sub-classes will then trigger display of the control function programme element, unless these sub-classes are configured differently.

In some embodiments of the invention a plurality of different control function programme elements may be provided, and a user may use a GUI such as that of FIG. 43 to determine which control function programme element is displayed. For example, some programme elements may merely present a warning and require user confirmation to continue (by, for example selecting an “OK” button), instead of enforcing an access control policy through use of a PIN. Furthermore, it will be appreciated that it is desirable that the warning message is particularly tailored to the type of content to which the warning relates. When a plurality of content programme elements are provided, each may be stored on a non-volatile storage medium such as a hard disk drive in the manner described above. Each control function programme element is provided with a unique identifier which identifies a particular stored control function programme element.

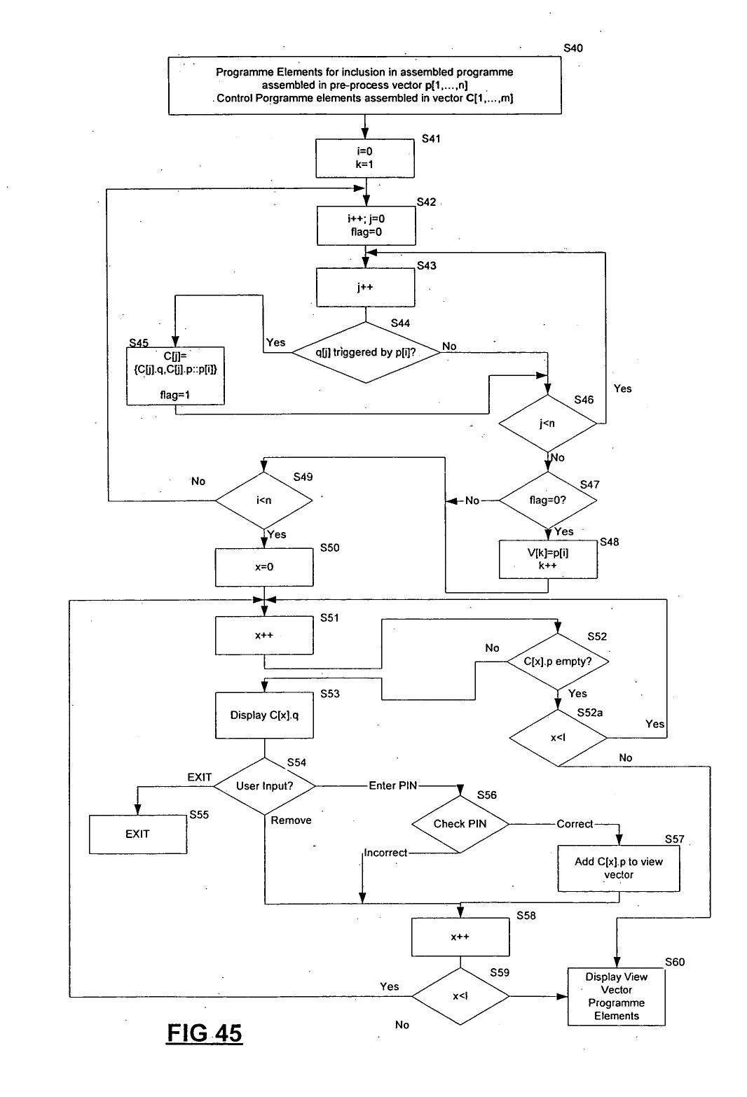

As described above, some embodiments of the invention are concerned with generating an assembled programme for presentation to a user by selecting a plurality of programme elements. The plurality of programme elements may be selected for example, on the basis of a specified programme classification code, by icon selection as described above. Having selected such an icon, a plurality of programme elements will be ready for use in assembly of an assembled programme. The control function programme element features of the present invention can be used prior to presentation of an assembled programme, as illustrated in FIG. 45.

A control vector C comprises m pairs. The first item of each pair is an identifier of a control function programme element, and the second element of each pair is a list of programme elements (taken from p described below) which trigger that control function programme element. The process of FIG. 40 is concerned with gernating a list of programme elements for each control function programme element, and applying the control function programme elements effectively.

Each element j of the control vector C is initialised as:
C[j]=(q[j], { })
where
q contains m control function programme elements; and
{ } denotes the empty list.

Initialisation of C is carried out at step S40. Also at Step S40, the plurality of programme elements for inclusion in an assembled programme are selected. Identifiers of these programme elements are stored in a pre-process vector p which contains n elements.

At Step S41 a counter variables i, is initialised to zero, and a counter variable k, is initialised to one. i is incremented at step S42, and a further counter variable j is initialised to 0. A variable flag (described below) is set to ‘0’.j is incremented at step S43. It should be noted that the counter i counts through elements of the vector p, while the counter j counts through elements of the vector C. The described process works by populating the second element of each pair of the control vector C, as described above. A view vector V comprising programme elements from p which have no associated control function programme element is also created. Creation of the vectors C and V is now described.

At step S44 a check is made to determine whether the control function programme element identified at index j of C is triggered by the classification code associated with the programme element identified at index i of p. If this condition is true, processing moves to step S47 where the programme element p[i] is added to the second list element of the pair at element j of the control vector C. That is:
C[j]=(C[j].q, C[j].p::p[i])
Where:
C[j].q represents the control function programme element component of the pair stored at index j of vector C;
C[j].p represents the list of programme elements triggered by the control function programme element component of the pair stored at index j of vector C; and
“::” is a list append operator, taking a first list operand, a second element operand and adding the element to the list.

A variable flag is set to ‘1’ to indicate that the programme element p[i] has been added to an element of the control vector C.

Processing then passes to step S46, where j is compared to m to determine whether or not all elements of the vector C have been processed. It should be noted that it the condition of step S44 is false, control passes directly to step S46. If some elements of the vector C have not been processed, processing returns to step S43, otherwise processing continues at step S47. At step S47 a check is made to determine whether flag is set to 0. If this condition is true, it can be determined that no control function programme elements have been triggered, such that programme element p[i] is not included in the vector C. In this case, the programme element p[i] is written to element k of the view vector V and k is incremented. Processing then continues at step S49. If the condition of step S47 is not true (i.e. flag is not equal to 0, processing passes directly to step S49.

At step S49 a check is made to determine whether i is less than n, that is, a check is made to determine whether all programme elements of the pre-process vector p have been considered. If this condition is false, processing returns to step S42, where i is incremented, and j is reset to zero, in attempt to locate any control function programme elements associated with the next programme element in the pre-process vector p. If however the condition of step S49 is satisfied, processing moves to step S50, where a further counter variable x is initialised to zero. x is incremented at step S51. The counter variable x will count through elements of the vector C applying the control function programme elements to their associated programme elements.

At step S52 a check is made to determine whether or not any programme elements are associated with the control function programme element stored at index x. If no programme elements are found, a check is made to ensure that the end of the vector C has not been reached (step S52a). Assuming that the end of the vector C has not been reached, processing returns to step S51 where x is incremented. If the end of the vector has been reached, it can be concluded that the programme elements to be displayed are contained in the view vector V, and these programme elements are displayed at step S60.

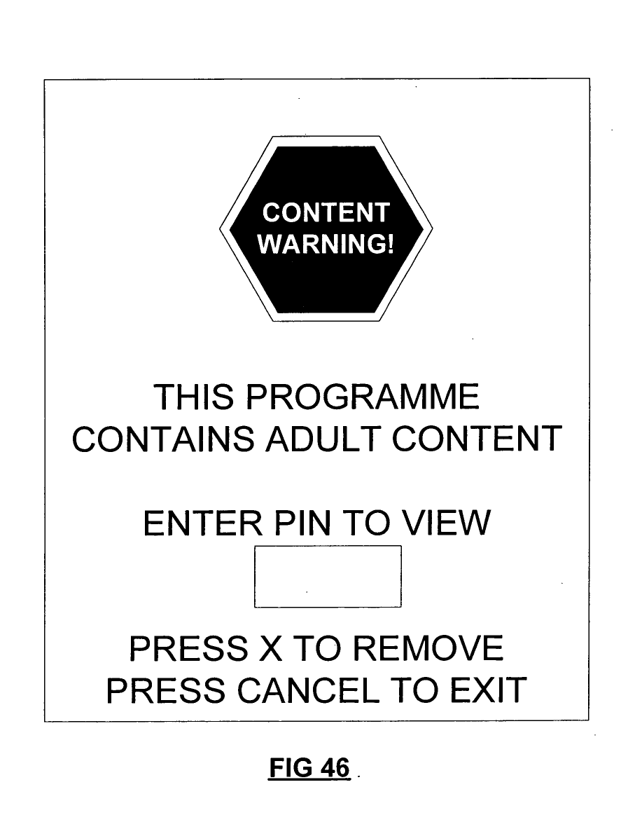

If any programme elements are found at step S52 (i.e. C[x].p is not empty), the control function programme element at index x of the control vector C is displayed at step S53. One embodiment of such a control function programme element is illustrated in FIG. 46. It can be seen from FIG. 46 that a user is informed that at least one programme element contains adult content, and is presented with three options, either to enter a PIN to view that content, or to remove the adult content from the assembled programme, or to exit altogether.

Referring back to FIG. 45, at step S54 user input is processed. If the user chooses to exit, processing terminates at step S55. If a user enters a correct PIN (which is checked in the manner described above) the programme element or elements which triggered display of the control function programme element are added to the view vector V at step S57. Processing then continues at step S58. If however a user enters an incorrect PIN, this is taken to be an instruction to remove the programme elements associated with the control function programme element from the assembled programme, and accordingly has the same effect as choosing remove at step S54. Processing then continues at step S58. At step S58 x is incremented. Step S59 ensures that x remains less than 1, that is that x refers to a valid index of the vector C. When this is no longer true (i.e. all elements of C have been processed, it can be deduced that the view vector V contains all programme elements which are to be included in the assembled programme. Accordingly, these programme elements are displayed to the user at step S60.

As described above, the present invention therefore provides a convenient configurable access control system which, for example, allows parents to very precisely control what their children watch. Furthermore, it allows assembled programmes to be created which contain only acceptable content.

The present invention provides valuable benefits for so called “shopping channels” which comprise solely of material attempting to sell various products through programmes known as infomercials. Using embodiments of the invention a user can specify preferences in terms of product types, such that a channel is created providing infomercials relating solely to products of interest to a user.

For example, a user may navigate a menu structure to input data indicating that they are currently considering buying a new motor car. This data can then be used to generate a user profile (as described above) such that appropriate programme element content is gathered from that received at a receiver.

Some embodiments of the present invention described above assume an object oriented implementation using the Java programming language. It should be appreciated that although Java is currently the preferred implementation language, an object oriented implementation of the invention could be realised in any one of the number of widely available object oriented programming languages including C++. Furthermore, a conventional imperative programming language such as C could be used to implement a system in accordance with the present invention.

For example, it has been described that Java Applets can be associated with a programme element to provide enhanced functionality. It will be appreciated that use of a machine independent language such as Java has advantages, however such functionality need not necessarily be provided using such applets but can instead be presented using computer program code written in any language which can be executed by a receiver.

Although preferred embodiments of the present invention have been described in detail, it will be appreciated that other implementations are possible without departing from the spirit and scope of the present invention, as set out in the appended claims. Although preferred embodiments of the present invention have been described in detail, it will be appreciated that other implementations are possible without departing from the spirit and scope of the present invention, as set out in the appended claims.

APPENDIX 1
CLASSIFIER PALETTE FILE
XML DTD

| | |
|---|---|
| 1 | <!ELEMENT palette (panel+)> |
| 2 | <!ELEMENT panel (button*)> |
| 3 | <!ATTLIST panel |

| | | | |
|---|---|---|---|
| 4 | name | CDATA | “Unknown” |
| 5 | iconfile | CDATA | #IMPLIED |
| 6 | mnemonic | CDATA | #IMPLIED |

| | |
|---|---|
| 7 | type (dynamic\|static) “dynamic” |

| | |
|---|---|
| 8 | > |
| 9 | <!ELEMENT tab EMPTY> |
| 10 | <!ATTLIST tab |

| | |
|---|---|
| 11 | url CDATA #REQUIRED |

| | |
|---|---|
| 12 | > |
| 13 | <!ELEMENT button (attribute*, tab*, button*)> |
| 14 | <!ATTLIST button |

| | | | |
|---|---|---|---|
| 15 | name | CDATA | “Unknown event” |
| 16 | classname | CDATA | #IMPLIED |
| 17 | category | CDATA | #IMPLIED |
| 18 | iconfile | CDATA | #REQUIRED |
| 19 | mnemonic | CDATA | #IMPLIED |
| 20 | defaultlevel | CDATA | “1” |

| | |
|---|---|
| 21 | > |
| 22 | <!ELEMENT attribute EMPTY> |
| 23 | <!ATTLIST attribute |

| | | | |
|---|---|---|---|
| 24 | name | CDATA | #REQUIRED |

| | |
|---|---|
| 25 | > |

APPENDIX 2
CLASSIFIER XML FILE

<?xml version=“1.0” encoding=“UTF-8”?>
<palette>
<panel name=“tennis”
iconfile=“res/colour_tennis/tennis.gif”
type=“static”>

| | |
|---|---|
| <button | name=“general 1” |
| | iconfile=“res/colour_tennis/tennis.gif” |
| | classname=“tv.edit.events.MapEvent” |
| | category=“tv.sport.tennis”/> |
| <button | name=“general 2” |
| | iconfile=“res/colour_tennis/tennis2.gif” |
| | classname=“tv.edit.events.MapEvent” |
| | category=“tv.sport.tennis”/> |
| <button | name=“Volley” |
| | iconfile=“res/colour_tennis/volley.gif” |
| | classname=“tv.edit.events.MapEvent” |
| | category=“tv.sport.tennis”/> |
| <button | name=“Half Volley” |
| | iconfile=“res/colour_tennis/halfvolley.gif” |
| | classname=“tv.edit.events.MapEvent” |
| | category=“tv.sport.tennis”/> |
| <button | name=“Mixed Doubles” |
| | iconfile=“res/colour_tennis/mixeddoubles.gif” |
| | classname=“tv.edit.events.MapEvent” |
| | category=“tv.sport.tennis”/> |
| <button | name=“Women's Doubles” |
| | iconfile=“res/colour_tennis/womensdoubles.gif” |
| | classname=“tv.edit.events.MapEvent” |
| | category=“tv.sport.tennis.womensdoubles”/> |
| <button | name=“Men's Doubles” |
| | iconfile=“res/colour_tennis/mensdoubles.gif” |
| | classname=“tv.edit.events.MapEvent” |
| | category=“tv.sport.tennis”/> |
| <button | name=“doubles” |
| | iconfile=“res/colour_tennis/doubles.gif” |
| | classname=“tv.edit.events.MapEvent” |
| | category=“tv.sport.tennis”/> |
| <button | name=“double fault 1” |
| | iconfile=“res/colour_tennis/doublefault.gif” |
| | classname=“tv.edit.events.MapEvent” |
| | category=“tv.sport.tennis”/> |
| <button | name=“fault_1” |
| | iconfile=“res/colour_tennis/fault.gif” |
| | classname=“tv.edit.events.MapEvent” |
| | category=“tv.sport.tennis”/> |
| <button | name=“ace” |
| | iconfile=“res/colour_tennis/ace.gif” |
| | classname=“tv.edit.events.MapEvent” |
| | category=“tv.sport.tennis.ace”/> |
| <button | name=“return” |
| | iconfile=“res/colour_tennis/return.gif” |
| | classname=“tv.edit.events.MapEvent” |
| | category=“tv.sport.return”/> |
| <button | name=“net 1” |
| | iconfile=“res/colour_tennis/net.gif” |
| | classname=“tv.edit.events.MapEvent” |
| | category=“tv.sport.tennis”/> |
| <button | name=“forehand” |
| | iconfile=“res/colour_tennis/forehand.gif” |
| | classname=“tv.edit.events.MapEvent” |
| | category=“tv.sport.tennis”/> |
| <button | name=“backhand” |
| | iconfile=“res/colour_tennis/backhand.gif” |
| | classname=“tv.edit.events.MapEvent” |
| | category=“tv.sport.tennis”/> |
| <button | name=“rally” |
| | iconfile=“res/colour_tennis/rally.gif” |
| | classname=“tv.edit.events.MapEvent” |
| | category=“tv.sport.tennis”/> |
| <button | name=“pass” |
| | iconfile=“res/colour_tennis/pass.gif” |
| | classname=“tv.edit.events.MapEvent” |
| | category=“tv.sport.tennis”/> |
| <button | name=“lob” |
| | iconfile=“res/colour_tennis/lob.gif” |
| | classname=“tv.edit.events.MapEvent” |
| | category=“tv.sport.tennis”/> |
| <button | name=“drop” |
| | iconfile=“res/colour_tennis/drop.gif” |
| | classname=“tv.edit.events.MapEvent” |
| | category=“tv.sport.tennis”/> |
| <button | name=“smash_1” |
| | iconfile=“res/colour_tennis/smash.gif” |
| | classname=“tv.edit.events.MapEvent” |
| | category=“tv.sport.tennis”/> |
| <button | name=“foot fault” |
| | iconfile=“res/colour_tennis/footfault.gif” |
| | classname=“tv.edit.events.MapEvent” |
| | category=“tv.sport.tennis”/> |
| <button | name=“injury” |
| | iconfile=“res/colour_tennis/injury.gif” |
| | classname=“tv.edit.events.MapEvent” |
| | category=“tv.sport.tennis”/> |
| <button | name=“Serve” |
| | iconfile=“res/colour_tennis/serve.gif” |
| | classname=“tv.edit.events.MapEvent” |
| | category=“tv.sport.tennis.serve”/> |
| <button | name=“winner_2” |
| | iconfile=“res/colour_tennis/winner2.gif” |
| | classname=“tv.edit.events.MapEvent” |
| | category=“tv.sport.tennis”/> |
| <button | name=“smash_2” |
| | iconfile=“res/colour_tennis/smash2.gif” |
| | classname=“tv.edit.events.MapEvent” |
| | category=“tv.sport.tennis”/> |
| <button | name=“Wimbledon” |
| | iconfile=“res/colour_tennis/wimbledon.gif” |
| | classname=“tv.edit.events.MapEvent” |
| | category=“tv.sport.tennis.wimbledon”/> |
| <button | name=“US Open” |
| | iconfile=“res/colour_tennis/usopen.gif” |
| | classname=“tv.edit.events.MapEvent” |
| | category=“tv.sport.tennis”/> |
| <button | name=“French Open” |
| | iconfile=“res/colour_tennis/frenchopen.gif” |
| | classname=“tv.edit.events.MapEvent” |
| | category=“tv.sport.tennis”/> |
| <button | name=“Australian” |
| | iconfile=“res/colour_tennis/ozopen.gif” |
| | classname=“tv.edit.events.MapEvent” |
| | category=“tv.sport.tennis”/> |

</panel>
</palette>

APPENDIX 3
HOME RECEIVER
BEGINNERS' PROFILE XML FILE

<item>

Arsenal Soccer Matches
<profile category=”sports.soccer.*”>

<param name=”team” value=”Arsenal”/>

</profile>

</item>
<item>

Other Soccer
<item>

Chelsea Soccer Matches
<profile category=”sports.soccer.*”>

<param name=”team” value=”Chelsea”/>

</profile>

</item>
<item>

All premier league Soccer Matches
<profile category=”sports.soccer.*”>

<param name=”league” value=”1”/>

</profile>

</item>
<item>

Best goals and saves
<profile category=”sports.soccer.GoalEvent”

rating=”5”/>

<profile category=”sports.soccer.Save”

rating=”5”/>

</item>

</item>

CLASSIFIER XML FILE

<?xml version=“1.0” encoding=“UTF-8”?>
<palette>
<panel name=“tennis”
iconfile=“res/colour_tennis/tennis.gif”
type=“static”>

| | |
|---|---|
| <button | name=“general 1” |
| | iconfile=“res/colour_tennis/tennis.gif” |
| | classname=“tv.edit.events.MapEvent” |
| | category=“tv.sport.tennis”/> |
| <button | name=“general 2” |
| | iconfile=“res/colour_tennis/tennis2.gif” |
| | classname=“tv.edit.events.MapEvent” |
| | category=“tv.sport.tennis”/> |
| <button | name=“Volley” |
| | iconfile=“res/colour_tennis/volley.gif” |
| | classname=“tv.edit.events.MapEvent” |
| | category=“tv.sport.tennis”/> |
| <button | name=“Half Volley” |
| | iconfile=“res/colour_tennis/halfvolley.gif” |
| | classname=“tv.edit.events.MapEvent” |
| | category=“tv.sport.tennis”/> |
| <button | name=“Mixed Doubles” |
| | iconfile=“res/colour_tennis/mixeddoubles.gif” |
| | classname=“tv.edit.events.MapEvent” |
| | category=“tv.sport.tennis”/> |
| <button | name=“Women's Doubles” |
| | iconfile=“res/colour_tennis/womensdoubles.gif” |
| | classname=“tv.edit.events.MapEvent” |
| | category=“tv.sport.tennis.womensdoubles”/> |
| <button | name=“Men's Doubles” |
| | iconfile=“res/colour_tennis/mensdoubles.gif” |
| | classname=“tv.edit.events.MapEvent” |
| | category=“tv.sport.tennis”/> |
| <button | name=“doubles” |
| | iconfile=“res/colour_tennis/doubles.gif” |
| | classname=“tv.edit.events.MapEvent” |
| | category=“tv.sport.tennis”/> |
| <button | name=“double fault 1” |
| | iconfile=“res/colour_tennis/doublefault.gif” |
| | classname=“tv.edit.events.MapEvent” |
| | category=“tv.sport.tennis”/> |
| <button | name=“fault_1” |
| | iconfile=“res/colour_tennis/fault.gif” |
| | classname=“tv.edit.events.MapEvent” |
| | category=“tv.sport.tennis”/> |
| <button | name=“ace” |
| | iconfile=“res/colour_tennis/ace.gif” |
| | classname=“tv.edit.events.MapEvent” |
| | category=“tv.sport.tennis.ace”/> |
| <button | name=“return” |
| | iconfile=“res/colour_tennis/return.gif” |
| | classname=“tv.edit.events.MapEvent” |
| | category=“tv.sport.return”/> |
| <button | name=“net 1” |
| | iconfile=“res/colour_tennis/net.gif” |
| | classname=“tv.edit.events.MapEvent” |
| | category=“tv.sport.tennis”/> |
| <button | name=“forehand” |
| | iconfile=“res/colour_tennis/forehand.gif” |
| | classname=“tv.edit.events.MapEvent” |
| | category=“tv.sport.tennis”/> |
| <button | name=“backhand” |
| | iconfile=“res/colour_tennis/backhand.gif” |
| | classname=“tv.edit.events.MapEvent” |
| | category=“tv.sport.tennis”/> |
| <button | name=“rally” |
| | iconfile=“res/colour_tennis/rally.gif” |
| | classname=“tv.edit.events.MapEvent” |
| | category=“tv.sport.tennis”/> |
| <button | name=“pass” |
| | iconfile=“res/colour_tennis/pass.gif” |
| | classname=“tv.edit.events.MapEvent” |
| | category=“tv.sport.tennis”/> |
| <button | name=“lob” |
| | iconfile=“res/colour_tennis/lob.gif” |
| | classname=“tv.edit.events.MapEvent” |
| | category=“tv.sport.tennis”/> |
| <button | name=“drop” |
| | iconfile=“res/colour_tennis/drop.gif” |
| | classname=“tv.edit.events.MapEvent” |
| | category=“tv.sport.tennis”> |
| <button | name=“smash_1” |
| | iconfile=“res/colour_tennis/smash.gif” |
| | classname=“tv.edit.events.MapEvent” |
| | category=“tv.sport.tennis”/> |
| <button | name=“foot fault” |
| | iconfile=“res/colour_tennis/footfault.gif” |
| | classname=“tv.edit.events.MapEvent” |
| | category=“tv.sport.tennis”/> |
| <button | name=“injury” |
| | iconfile=“res/colour_tennis/injury.gif” |
| | classname=“tv.edit.events MapEvent” |
| | category=“tv.sport.tennis”/> |
| <button | name=“Serve” |
| | iconfile=“res/colour_tennis/serve.gif” |
| | classname=“tv.edit.events.MapEvent” |
| | category=“tv.sport.tennis.serve”/> |
| <button | name=“winner_2” |
| | iconfile=“res/colour_tennis/winner2.gif” |
| | classname=“tv.edit.events.MapEvent” |
| | category=“tv.sport.tennis”/> |
| <button | name=“smash_2” |
| | iconfile=“res/colour_tennis/smash2.gif” |
| | classname=“tv.edit.events.MapEvent” |
| | category=“tv.sport.tennis”/> |
| <button | name=“Wimbledon” |
| | iconfile=“res/colour_tennis/wimbledon.gif” |
| | classname=“tv.edit.events.MapEvent” |
| | category=“tv.sport.tennis.wimbledon”/> |
| <button | name=“US Open” |
| | iconfi1e=“res/colour_tennis/usopen.gif” |
| | classname=“tv.edit.events.MapEvent” |
| | category=“tv.sport.tennis”/> |
| <button | name=“French Open” |
| | iconfile=“res/colour_tennis/frenchopen.gif” |
| | classname=“tv.edit.events.MapEvent” |
| | category=“tv.sport.tennis”/> |
| <button | name=“Australian” |
| | iconfile=“res/colour_tennis/ozopen.gif” |
| | classname=“tv.edit.events.MapEvent” |
| | category=“tv.sport.tennis”/> |

</panel>
</palette>

HOME RECEIVER BEGINNERS' PROFILE XML FILE

```
<item>
  Arsenal Soccer Matches
  <profile category=“sports.soccer.*”>
    <param name=“team” value=“Arsenal”/>
  </profile>
</item>
<item>
  Other Soccer
  <item>
    Chelsea Soccer Matches
    <profile category=“sports.soccer.*”>
      <param name=“team” value=“Chelsea”/>
    </profile>
  </item>
  <item>
    All premier league Soccer Matches
    <profile category=“sports.soccer.*”>
      <param name=“league” value=“1”/>
    </profile>
  </item>
  <item>
    Best goals and saves
    <profile category=“sports.soccer.GoalEvent”
rating=“5”/>
    <profile category=“sports.soccer.Save”
rating=“5”/>
  </item>
</item>
```

1. A method of presenting at least one programme element to a user the method comprising:
(a) receiving user specification of at least one classification code representing programme element content of interest;
(b) receiving from a transmitter a plurality of programme elements, each programme element having a respective classification code;
(c) screening received classification codes to identify programme elements associated with the specified at least one classification code;
(d) storing identified programme elements together with their respective classification codes;
(e) receiving user selection of at least one classification code; and
(f) presenting at least one stored programme element associated with the user selected at least one classification code.

2. A method according to claim 1, wherein each programme element is classified by reference to a type of event to which the element relates.

3. A method according to claim 2, wherein said user specification comprises specification of at least one classification code associated with a predetermined type of programme element.

4. A method according to claim 1, wherein each programme element is classified by reference to a subjective assessment of the value of the element.

5. A method according to claim 4, wherein said user specification comprises specification of classification codes representing subjective value at or above a predetermined threshold level.

6. A method according to claim 5, wherein programme elements are distributed to the user, and the threshold level is applied to the distributed programme elements.

7. A method according to claim 5, wherein the threshold level is transmitted to a programme source, and only programme elements with classification codes representing subjective values at or above the predetermined threshold level are distributed to the user.

8. A method according to claim 1, further comprising alerting a user to receipt of a programme element identified as being associated with the at least one selected classification code.

9. A method according to any preceding claim, comprising receiving user input controlling programme element selection.

10. A method according to claim 9, comprising displaying symbols representing the class of each stored programme element, and receiving user selection of programme elements by receiving selection of associated symbols.

11. A method according to claim 1, wherein said at least one stored programme element associated with the selected classification code is a plurality of programme elements, and the method further comprises generating a programme comprising said plurality of programme elements.

12. A method according to claim 1, wherein:
step (b) comprises storing each received programme element in a buffer; and
step (d) comprises transferring identified programme elements from said buffer to a storage device.

13. A method according to claim 1, wherein step (b) comprises receiving a plurality of streams of programme elements.

14. A method according to claim 13, wherein step (d) comprises storing identified programme elements from one of said plurality of streams of programme elements.

15. A method according to claim 1, wherein step (a) comprises receiving user specification of a plurality of classification codes representing programme element content of interest.

16. A method according to claim 15, wherein said plurality of classification codes are specified in order of preference.

17. A method according to claim 16, wherein:
step (b) comprises receiving a plurality of programme elements; and
step (c) comprises screening programme elements to select a programme element of interest, said screening selecting a more preferred programme element in preference to a less preferred programme element.

18. A method according to claim 16, wherein step (d) further comprises:
receiving further programme elements, each further programme element having a respective classification code;
screening said classification codes associated with said further programme elements to identify further programme elements associated with said specified plurality of classification codes;
if identified further programme elements have classification codes specified as more preferred than classification codes associated with said programme elements being stored, storing said identified further programme elements; and
if said identified further programme elements have classification codes specified as being less preferred than classification codes said programme elements being stored continuing to store said programme elements.

19. A method according to claim 3, wherein at least some programme elements are classified by reference to a subjective assessment of the value of the element, and said user specification comprises a specification of classification codes representing subjective value at or above a predetermined threshold level.

20. A method according to claim 1, wherein each programme element is classified by reference to a type of event to which the element relates and a subjective assessment of the value of the element, and programme elements having a relatively high subjective value are stored in preference to programme elements having a relatively low subjective value.

21. A method according to claim 1, wherein step (a) comprises:
presenting a graphical user interface to a user; and
receiving user input in response to presentation of said interface.

22. A method according to claim 21, wherein said graphical user interface presents a plurality of classes to a user, and said user input comprises a selection of some of said plurality of classes.

23. A method according to claim 1, wherein step (e) comprises:
presenting a list of classification codes associated with stored programme elements to a user; and
receiving selection of a classification code included in said list.

24. A method according to claim 23, wherein said classification codes are arranged hierarchically.

25. A data carrier carrying computer program code to cause a computer to carry out the method of claim 1.

26. An apparatus for presenting at least one programme element to a user, the apparatus comprising:
a program memory containing processor readable instructions; and
a processor configured to read and execute instructions from said program memory;
wherein said processor readable instructions comprise instructions controlling the processor to carry out the method of claim 1.

27. An apparatus for presenting at least one programme element to a user, the apparatus comprising:
an input device configured to receive user specification of at least one classification code representing programme element content of interest;
a receiver configured to receive a plurality of programme elements, each programme element being received with a respective classification code;
a processor configured to screen received classification codes to identify programme elements associated with the specified at least one classification code;
a storage device configured to store identified programme elements together with their respective classification codes;
an input device configured to receive user selection of at least one classification code; and
a display device for presenting at least one stored programme element associated with the user selected at least one classification code.

28. A method for generating a programme for presentation as a sequence of programme elements from a set of pre-recorded programme elements, the programme elements being classified on the basis of programme element content such that each programme element is allocated to at least one of a predetermined set of classes, each programme element is stored with at least one associated programme classification code, each classification code identifying a class to which the associated programme element has been allocated, and a programme is generated by selecting at least one programme classification code and presenting programme elements associated with the said at least one programme classification code, wherein a user specifies a predetermined value selection representing programme element content of interest, a plurality of programme elements are received from a transmitter, each programme element being received together with a respective classification code, the classification codes are screened to identify programme elements associated with the predetermined value selection and identified programme elements are stored together with their respective classification codes to form the set of precorded programme elements.

29. An apparatus for generating a programme for presentation as a sequence of programme elements from a set of pre-recorded programme element, comprising means for storing programme elements with associated programme classification codes, each classification code identifying a class selected from a predetermined set of classes to which class an associated programme element has been allocated on the basis of programme element content, means for selecting at least one programme classification code, and means for generating a programme by presenting programme elements associated with the selected said at least one programme classification code, wherein the apparatus further comprises means for specifying a predetermined value selection representing programme element content of interest, means for receiving a plurality of programme elements from a transmitter, each programme element being received together with a respective classification code, means for screening received classification codes to identify programme elements associated with the predetermined value selection, and means for storing identified programme elements together with their respective classification codes to form the set of prerecorded programme elements.

30. A method of presenting at least one programme element to a user, the method comprising:
receiving from a transmitter user specification of at least one classification code representing programme element content of interest;
screening a plurality of classification codes, each classification code being associated with a respective programme element, and the screening identifying programme elements associated with said at least one specified classification code;
storing identified programme elements together with their respective classification codes;
receiving user selection of at least one classification code; and
presenting at least one stored programme element associated with the user selected at least one classification code.

31. A method of presenting at least one programme element to a user, the method comprising:
receiving from a transmitter user specification of at least one classification code representing programme element content of interest;
screening a plurality of classification codes, each classification code being associated with a respective programme element, the screening identifying programme elements associated with said at least one specified classification code; and
transmitting identified programme elements together with their respective classification codes to a receiver, said receiver being configured to store programme elements, receive user selection of at least one classification code, and present at least one stored programme element associated with the user selected at least one classification code.

32. A method according to claim 31, wherein each programme element is classified by reference to a type of event to which the programme element relates.

33. A method according to claim 32, wherein said user specification comprises specification of at least one classification code associated with a predetermined type of programme element.

34. A method according to claim 31, wherein each programme element is classified by reference to a subjective assessment of the value of the element.

35. A method according to claim 34, wherein said user specification comprises specification of classification codes representing subjective value at or above a predetermined threshold level.

36. A method according to claim 31, further comprising alerting a user to the distribution of a programme element identified as being associated with the at least one selected classification code.

37. A method of presenting at least one programme element to a user, the method comprising:
transmitting a plurality of programme elements to a receiver, each programme element having an associated classification code, and the receiver being configured to:
receive user specification of at least one classification code representing programme element content of interest;
screen a plurality of classification codes, each classification code being associated with a respective programme element, and the screening identifying programme elements associated with said at least one specified classification code;
store identified programme elements together with their respective classification codes;
receive user selection of at least one classification code; and
present at least one stored programme element associated with the user selected at least one classification code.

38. A data carrier carrying computer program code to cause a computer to carry out the method of claim 31.

39. An apparatus for presenting at least one programme element to a user, the apparatus comprising:
a program memory containing processor readable instructions; and
a processor configured to read and execute instructions from said program memory;
wherein said processor readable instructions comprise instructions controlling the processor to carry out the method of claim 31.

40. Apparatus for presenting at least one programme element to a user, the apparatus comprising:
a receiver configured to receive user specification of at least one classification code representing programme element content of interest from a transmitter;
screening means configured to screen a plurality of classification codes, each classification code being associated with a respective programme element, and the screening identifying programme elements associated with said at least one specified classification code; and
a transmitting configured to transmit identified programme elements together with their respective classification codes to a receiver, said receiver being configured to store programme elements, receive user selection of at least one classification code, and present at least one stored programme element associated with the user selected at least one classification code.

41. A method for presenting a programme to a user, comprising:
receiving user specification of at least one classification code representing programme element content of interest;
presenting first programme data to a user;
receiving second programme data comprising a plurality of second programme elements, each second programme element having an associated classification code;
screening received classification codes to identify second programme elements associated with the specified at least one classification code; and
alerting the user to receipt of the or each identified second programme element.

42. A method according to claim 41, wherein said alerting comprises presenting the or each identified second programme element.

43. A method according to claim 41, wherein said alerting comprises displaying a message indicating receipt of said identified second programme element.

44. A method according to claim 43, further comprising:
receiving user input in response to said message, said user input comprising a request to present at least one identified second programme element; and
presenting the at least one identified second programme element.

45. A method according claim 43, further comprising:
receiving user input in response to said message, said user input comprising a request to store at least one identified programme element;
storing the at least one identified programme element programme element; and
continuing to present said first programme data to the user.

46. A method according to claim 41, wherein each second programme element is classified by reference to a type of event which it represents.

47. A method according to claim 41, wherein each second programme element is classified by reference to a subjective assessment of the value of the element.

48. A method according to claim 41, wherein said first programme data comprises a plurality of first programme elements, each of said first programme elements having an associated classification code.

49. A method according to claim 48, wherein each classification code associated with a first programme element represents a subjective assessment of the value of the associated first programme element.

50. A method according to claim 49, wherein each second programme element is classified by reference to a subjective assessment of the value of the element.

51. A method according to claim 50, wherein:
said user is alerted if but only if the value of the identified second programme element is higher than the value of the currently presented first programme element.

52. A method according to claim 51, wherein if the value of the identified second programme element is not higher than the value of the presented first programme element, the identified second programme element is stored.

53. A method according to claim 50, further comprising:
receiving user input indicating a threshold value level; and
alerting a user to receipt of an identified programme element if but only if the value of that programme element exceeds said threshold value level.

54. A method according to claim 48, wherein said user input comprises an ordered list of classification codes, and a user is alerted to receipt of an identified second programme element, indicated as being preferred to the presented first programme element.

55. A method for generating a programme for presentation as a sequence of programme elements from a set of pre-recorded programme elements, the programme elements being classified on the basis of programme element content such that each programme element is allocated to at least one of a predetermined set of classes, each programme element is stored with at least one associated programme classification code, each classification code identifying a class to which the associated programme element has been allocated, wherein a programme is generated by selecting at least one programme classification code and presenting programme elements associated with the said at least one programme classification code, a plurality of programme elements having associated classification codes are received during presentation of said programme, said classification codes are compared with classification codes representing programme element content of interest, and a user is alerted if a received classification code matches a classification code representing programme element content of interest.

56. A data carrier carrying computer readable instructions for controlling a computer to carry out the method of claim 41.

57. An apparatus for presenting at least one programme element to a user, the apparatus comprising:
a program memory containing processor readable instructions; and
a processor configured to read and execute instructions from said program memory;
wherein said processor readable instructions comprise instructions controlling the processor to carry out the method of claim 41.

58. A method for alerting a user to receipt of programme element content of interest, the method comprising:
receiving user specification of at least one classification code representing programme element content of interest;
receiving programme data comprising a plurality of programme elements, each programme element having an associated classification code;
screening received classification codes to identify programme elements associated with the specified at least one classification code; and
alerting the user to receipt of the or each identified programme element.

59. A method according to claim 58, wherein said alerting comprises initialising a display device from a standby mode.

60. A method according to claim 58, wherein said alerting comprises producing a audio signal.

61. A method according to claim 58, wherein said alerting comprises displaying an identified programme element.

62. A data carrier carrying computer readable instructions for controlling a computer to carry out the method of claim 58.

63. An apparatus for presenting at least one programme element to a user, the apparatus comprising:
a program memory containing processor readable instructions; and
a processor configured to read and execute instructions from said program memory;
wherein said processor readable instructions comprise instructions controlling the processor to carry out the method of claim 58.

64. A method of presenting emergency information to a user comprising:
receiving a plurality of programme elements, each programme element being received together with an associated classification code;
screening each received classification code to determine whether the associated programme element represents emergency information; and
if the associated programme element represents emergency information, presenting said programme element to the user.

65. A method according to claim 64, wherein presenting said emergency information comprises interrupting other programme element content.

66. A method according to claim 64, wherein presenting said emergency information comprises initialising a display device from a stand-by mode.

67. A method according to claim 64, further comprising storing said emergency information.

68. A data carrier carrying computer readable instructions for controlling a computer to carry out the method of claim 64.

69. An apparatus for presenting at least one programme element to a user, the apparatus comprising:
a program memory containing processor readable instructions; and
a processor configured to read and execute instructions from said program memory;
wherein said processor readable instructions comprise instructions controlling the processor to carry out the method of claim 64.

70. A method of presenting emergency information to a user comprising transmitting said emergency information and an associated classification code to a receiver, wherein the receiver is configured to screen received classification codes to determine whether the associated programme element represents emergency information and if the associated programme element represents emergency information, present said programme element to the user.

71. A method of presenting emergency information to a user, comprising:
transmitting a programme element representing said emergency information to a receiver,
transmitting a classification code to the receiver, said classification code being arranged to initialise said receiver, and to cause said receiver to display said emergency information.

72. Apparatus for presenting a programme to a user, comprising:
user input means for receiving user specification of at least one classification code representing programme element content of interest;
a display device configured to present first programme data to a user;
a receiver configured to receive second programme data comprising a plurality of second programme elements, each second programme element having an associated classification code;
screening means configured to screen received classification codes to identify second programme elements associated with the specified at least one classification code; and
alerting means configured to the user of receipt of the or each identified second programme element.

73. A data carrier carrying computer program code to cause a computer to carry out the method of claim 37.

74. An apparatus for presenting at least one programme element to a user, the apparatus comprising:
a program memory containing processor readable instructions; and
a processor configured to read and execute instructions from said program memory;
wherein said processor readable instructions comprise instructions controlling the processor to carry out the method of claim 37.

75. A data carrier carrying computer readable instructions for controlling a computer to carry out the method of claim 55.

76. An apparatus for presenting at least one programme element to a user, the apparatus comprising:
a program memory containing processor readable instructions; and
a processor configured to read and execute instructions from said program memory;
wherein said processor readable instructions comprise instructions controlling the processor to carry out the method of claim 55.
